(19) United States
(12) Patent Application Publication
(10) Pub. No.: US 2013/0054486 A1
(43) Pub. Date: Feb. 28, 2013

(54) Extended management system

(71) Applicant: Jeffrey Scott Eder, Mill Creek, WA (US)

(72) Inventor: Jeffrey Scott Eder, Mill Creek, WA (US)

(21) Appl. No.: 13/517,631

(22) Filed: Jun. 14, 2012

Related U.S. Application Data
(63) Continuation of application No. 12/684,954, filed on Jan. 10, 2010.
Application No. 12/684,954 is a continuation-in-part of application No. 11/142,875, filed on Jun. 1, 2005, now abandoned.
(60) Provisional application No. 60/576,063, filed on Jun. 1, 2004.

(51) Int. Cl. G06Q 40/06

(52) U.S. Cl. 705/36 R

(57) ABSTRACT

A method of, computer program product and system for transforming data representative of an enterprise and its employees into a plurality of models that identify the tangible contribution of one or more elements of value and external factors to both a pension plan for enterprise employees and the enterprise. The models which are developed using automated learning support the management and/or optimization of both the pension plan and the enterprise.

### CONTINUATION AND CROSS REFERENCE TO RELATED APPLICATIONS

This application is a continuation of U.S. patent application Ser. No. 12/684,954 filed Jan. 10, 2010 the disclosure of which is incorporated herein by reference. U.S. patent application Ser. No. 12/684,954 is a continuation in part of U.S. patent application Ser. No. 11/142,785 filed May 31, 2005, the disclosure of which is incorporated herein by reference. U.S. patent application Ser. No. 11/142,785 claimed priority from provisional application No. 60/576,063 filed on Jun. 1, 2004, the disclosure of which is also incorporated herein by reference. U.S. Pat. No. 5,615,109 issued Mar. 25, 1997 and U.S. patent application Ser. No. 11/094,171 filed Mar. 31, 2005 which matured into U.S. Pat. No. 7,730,063 issued Jun. 1, 2012 are all also incorporated herein by reference.

### BACKGROUND OF THE INVENTION

This invention relates to a method, media and system for the management and optimization of one or more aspects of risk and value for one or more organizations that physically exist, the development and optimized delivery of customized risk transfer products for said one or more organizations, and the development, valuation and sale of securities for the one or more organizations.

### SUMMARY OF THE INVENTION

It is a general object of the present invention to provide a novel and useful system for creating the matrices of value and risk for one or more organizations and using said matrices to support: the management and optimization one or more aspects of organization risk and value, the development and delivery of customized risk transfer products for one or more organizations and the valuation and sale of securities for one or more organizations. Completion of these tasks is enabled by:
1) Systematically analyzing up to five segments of value—current operation, real options/contingent liabilities, derivatives, excess financial assets and market sentiment for each enterprise in each organization;
2) Systematically analyzing and valuing all the elements of value, tangible and intangible, that have an effect the segments of value for each enterprise in each organization;
3) Systematically analyzing and valuing all the external factors that have an effect on the segments of value for each enterprise in each organization;
4) Developing an understanding of the risk associated with external factors, elements of value and risks by segment of value under both normal and extreme conditions for each enterprise in each organization;
5) Integrating information and insights from asset management systems (i.e. Customer Relationship Management, Supply Chain Management, Brand Management, etc.), asset risk management systems (credit risk, currency risk, etc.) and business intelligence systems for each enterprise in each organization; and
6) Summarizing the enterprise analyses in order to complete the matrices of value and risk and define the efficient frontier for organization financial performance.

While one embodiment of the novel system for defining and measuring the matrices of organizational value and risk analyzes all five segments of value, the system can operate when one or more of the segments of value are missing for one or more enterprises and/or for each organization as a whole. For example, each organization may be a value chain that does not have a market value in which case there will be no market sentiment to evaluate. Another common situation would be a multi-company corporation that has no derivatives and/or excess financial assets in most of the enterprises (or companies) within it.

As detailed later, the segments of value that will be analyzed are defined in the system settings table (140). Most public companies will have at least three segments of value, current operation, real options and market sentiment. Because most corporations have only one traded stock, multi-company corporations will generally define an enterprise for the “corporate shell” to account for all market sentiment. This “corporate shell” enterprise can also be used to account for any joint options the different companies within the corporation may collectively possess. The system of the present invention has the added benefit of eliminating a great deal of time-consuming and expensive effort by automating the extraction of data from the databases, tables, and files of existing computer-based corporate finance, operations, human resource, supply chain, web-site and asset management system databases. In accordance with the invention, the automated extraction, aggregation and analysis of data from a variety of existing computer-based systems significantly increases the scale and scope of the analysis that can be completed. The system of the present invention further enhances the efficiency and effectiveness of the analysis by automating the retrieval, storage and analysis of information useful for valuing elements of value and segments of value from external databases, external publications and the Internet.

Uncertainty over which method is being used for completing the valuation and the resulting inability to compare different valuations is eliminated by the present invention by consistently utilizing the same set of valuation methodologies for valuing the different segments of value as shown in Table 2.

TABLE 2

| Segment of organization value by enterprise | Valuation methodology |
|---|---|
| Current-operation value (COPTOT)—value of | Income valuation |
| operation that is developing, making, | |
| supplying and selling products and/or services | |
| Excess net financial assets (aka Investments) | Total Net Financial Assets valued using |
| | GAAP or IFRS—(amount required to support |
| | current operation) |
| Real Options | Real option algorithms and optional |
| | allocation of industry options |
| Derivatives—includes all hedges, swaps, | Risk Neutral Valuation |
| swaptions, options and warrants | |
| Market Sentiment | Market Value*—(COPTOT + Σ Real |
| | Option Values + Σ Derivative values + |
| | Σ Excess Financial Assets) |

*The user also has the option of specifying the total value

The market value of each organization is calculated by combining the market value of all debt and equity as shown in Table 3. Element of value and external factor values are calculated based on the sum of their relative contributions to each segment of value for each enterprise.

TABLE 3
Organization Market Value =
$\begin{matrix}\sum Market value of equity for all enterprises - \\ {\sum }_{ } Market value of debt for all enterprises\end{matrix}$

The utility of the valuations produced by the system of the present invention are further enhanced by explicitly calculating the expected longevity of the different elements of value.

As shown in Table 2, real options are valued using real option algorithms. Because real option algorithms explicitly recognize whether or not an investment is reversible and/or if it can be delayed, the values calculated using these algorithms are more realistic than valuations created using more traditional approaches like Net Present Value. The use of real option analysis for valuing growth opportunities and contingent liabilities (hereinafter, real options) gives the present invention a distinct advantage over traditional approaches to enterprise financial management.

The innovative system has the added benefit of providing a large amount of detailed information to each organization users concerning both tangible and intangible elements of value by enterprise. Because intangible elements of value are by definition not tangible, they can not be measured directly. They must instead be measured by the impact they have on their surrounding environment. There are analogies in the physical world. For example, electricity is an “intangible” that is measured by the impact it has on the surrounding environment. Specifically, the strength of the magnetic field generated by the flow of electricity through a conductor turns a motor and the motion of this motor is used to determine the amount of electricity that is being consumed.

The system of the present invention measures intangible elements of value by identifying the attributes that, like the magnetic field, reflect the strength of the element of value in contributing to increases in the segments of value (current operation, excess financial assets, real options, derivatives, market sentiment) and/or components of value within the current operation (revenue, expense and change in capital) and are relatively easy to measure. Once the attributes related to the strength of each element of value are identified, they can be summarized into a single expression (a composite variable or vector) if the attributes don't interact with attributes from other elements. If attributes from one element of value drive those from another, then the elements of value can be combined for analysis and/or the impact of the individual attributes can be summed together to calculate a value for the element. In one embodiment, vectors are used to summarize the impact of the element of value attributes. The vectors for all elements of value are then evaluated to determine their relative contribution to driving each of the components of value and/or each of the segments of value. The system of the present invention calculates the product of the relative contribution and the forecast longevity of each element of value to determine the relative contribution to each of the components of value to an overall value. The contribution of each element of value to each component of value are then added together to determine the value of the current operation contribution of each element of value (see Table 5). The contribution of each element of value to the enterprise is then determined by summing the element of value contribution to each segment of value. Each organization value is then calculated by summing the value all the enterprises within each organization.

The method for tracking all the elements of value and external factors for a commercial business enterprise provided by the present invention eliminates many of the limitations associated with current systems for financial management and risk management. In addition to supporting the identification and display of the efficient frontier, the system of the present invention will also facilitate: analysis of potential mergers and acquisitions, evaluation of asset purchases/disposals, rating the ability of each organization to re-pay debt and monitoring the performance of outside vendors who have been hired boost the value of one or more elements of value (i.e. advertising to increase brand value).

To facilitate its use as a tool for financial management, the system of the present invention produces reports in formats that are similar to the reports provided by traditional accounting systems. Incorporating information regarding all the elements of value is just one of the ways the system of the present invention overcomes the limitations of existing systems. Other advances include:

1. The integrated analysis of all the sources of value and risk,
2. The automated analysis of risk under both normal and extreme conditions, and
3. The automated identification and display of the efficient frontier for organization financial performance.
By providing real-time financial insight to personnel in each organization, the system of the present invention enables the continuous optimization of management decision making across the entire organization.

### BRIEF DESCRIPTION OF DRAWINGS

These and other objects, features and advantages of the present invention will be more readily apparent from the following description of one embodiment of the invention in which:

FIG. 1 is a block diagram showing the major processing steps of the present invention;

FIG. 2 is a diagram showing the files or tables in the application database (50) of the present invention that are utilized for data storage and retrieval during the processing in the innovative system for multi-enterprise organization analysis and optimization;

FIG. 3 is a block diagram of an implementation of the present invention;

FIG. 4 is a diagram showing the data windows that are used for receiving information from and transmitting information to the user (20) during system processing;

FIG. 5A, FIG. 5B, FIG. 5C, FIG. 5D, FIG. 5E, FIG. 5F and FIG. 5G are block diagrams showing the sequence of steps in the present invention used for specifying system settings and for initializing and operating the data bots that extract, aggregate, store and manipulate information utilized in system processing by enterprise;

FIG. 6A, FIG. 6B and FIG. 6C are block diagrams showing the sequence of steps in the present invention used for analyzing the value associated with each organization by enterprise;

FIG. 7 is a block diagram showing the sequence of steps in the present invention used for analyzing the risk associated with each organization by enterprise;

FIG. 8 is a block diagram showing the sequence in steps in the present invention used in analysis and reporting;

FIG. 9A and FIG. 9B are block diagrams showing the sequence of steps in the present invention used in producing and selling risk transfer products and securities;

FIG. 10 is a diagram showing how the enterprise matrices of value can be combined to calculate each organizational matrix of value;

FIG. 11 is a diagram showing how the enterprise matrices of risk can be combined to calculate each organizational matrix of risk; and

FIG. 12 is a sample report showing the efficient frontier for Organization XYZ, the current position of XYZ relative to the efficient frontier and the forecast of the new position of XYZ relative to the efficient frontier after user specified changes are implemented.

### DETAILED DESCRIPTION OF ONE PREFERRED EMBODIMENT

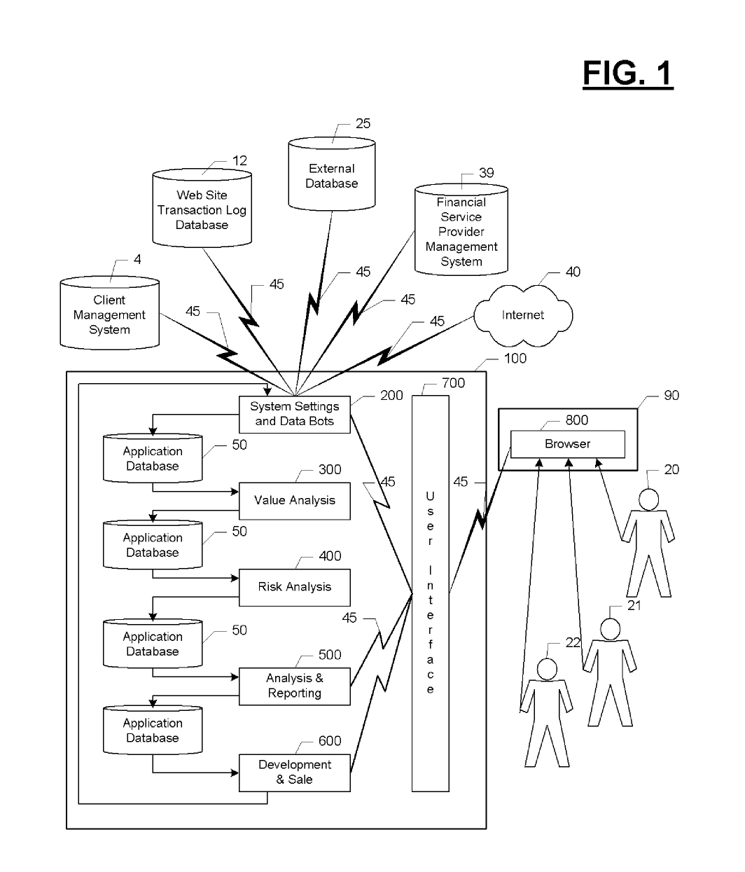

FIG. 1 provides an overview of the processing completed by the innovative system for extended value and risk management. In accordance with the present invention, an automated method of and system (100) for producing and using the matrices of value and risk for one or more commercial organizations is provided. Processing starts in this system (100) with the specification of system settings for each organization and the initialization and activation of software data “bots” (200) that extract, aggregate, manipulate and store the data and user (20) input used in completing system processing. This information is extracted via a network (45) from: a client management system database (4), a web site transaction log database (12), an external database (25), a financial service provider management system database (39) and the Internet (40).

In one embodiment the system of the present invention obtains client management system data from a plurality of individual client management system databases selected from the group consisting of a basic financial system database (5), an operation management system database (10), a human resource information system database (15), a risk management system database (17), an advanced financial system database (30), an asset management system database (35), a project management system database (37) for each enterprise in each organization. In an alternate mode the required information could be extracted from a client value and risk management system database such as the one described in application Ser. No. 10/747,471 for each client organization. In one embodiment the system of the present invention obtains data from a from a value and risk management system database such as the one described in application Ser. No. 10/747,471 for each financial service provider. In an alternate mode the required information could be extracted plurality of financial service provider management system databases selected from the group consisting of a basic financial system database (5), an operation management system database (10), a human resource information system database (15), a risk management system database (17), an advanced financial system database (30), an asset management system database (35) and a project management system database (37) for each financial service provider. The narrative will describe the extraction of data from each of the different management systems for clients while relying on a single database for obtaining information regarding the one or more financial service providers.

These information extractions and aggregations may be influenced by a user (20) through interaction with a user-interface portion of the application software (700) that mediates the display, transmission and receipt of all information to and from browser software (800) such as the Microsoft Internet Explorer or Firefox in an access device (90) such as a phone, pda or personal computer that the user (20) interacts with. While only one database of each type (4, 12, and 25) is shown in FIG. 1, it is to be understood that the system (100) will extract data from at least one database for each organization being analyzed. While the data from multiple asset management systems can be utilized in the analysis of each element of value completed by the system of the present invention, one embodiment of the present invention contains one asset management system for each element of value being analyzed for each enterprise within each organization. Asset management systems can include: customer relationship management systems, partner relationship management systems, channel management systems, knowledge management systems, visitor relationship management systems, intellectual property management systems, alliance management systems, process management systems, brand management systems, workforce management systems, human resource management systems, email management systems, IT management systems and/or quality management systems. As definite for this application, asset management system data includes all unclassified text and multi-media data within an enterprise or organization. Automating the extraction and analysis of data from each asset management system ensures that every asset—tangible or intangible—is considered within the overall financial framework for each organization. It should also be understood that it is possible to complete a bulk extraction of data from each database (5, 10, 12, 15, 17, 25, 30, 35 and 37) and the Internet 40 via the network (45) using peer to peer networking and data extraction applications before initializing the data bots. The data extracted in bulk could be stored in a single datamart, a data warehouse or a storage area network where the data bots could operate on the aggregated data.

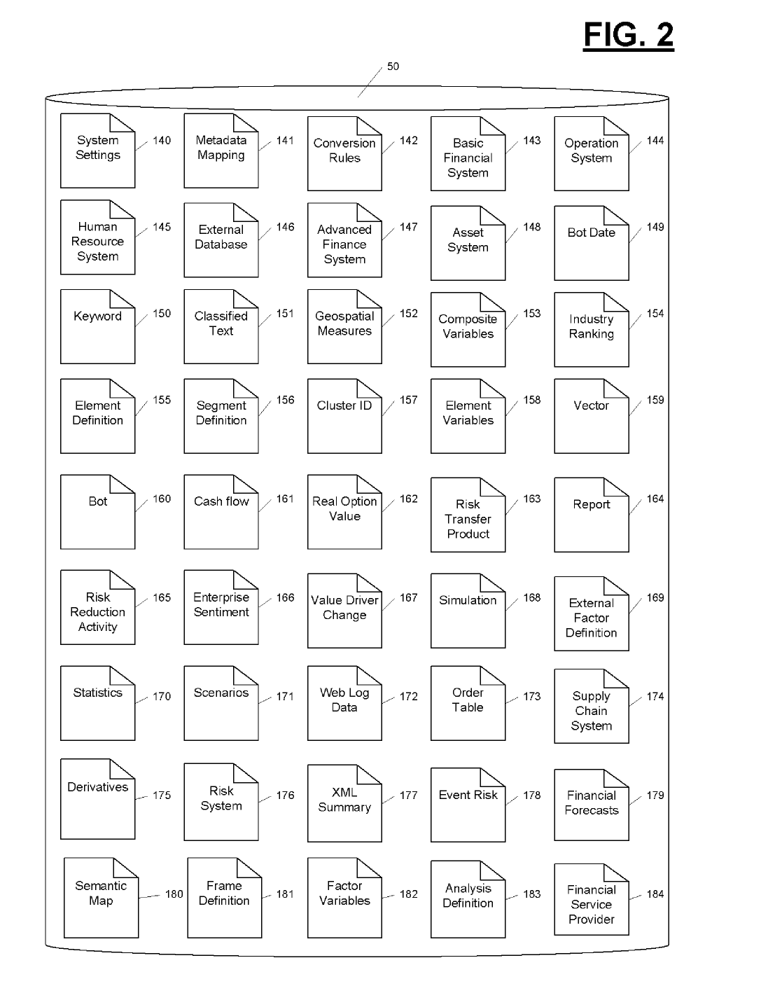

All extracted information is stored in a file or table (hereinafter, table) within an application database (50) as shown in FIG. 2. The application database (50) contains tables for storing user input, extracted information and system calculations including a system settings table (140), a metadata mapping table (141), a conversion rules table (142), a basic financial system table (143), an operation system table (144), a human resource system table (145), an external database table (146), an advanced finance system table (147), a asset system table (148), a bot date table (149), a keyword table (150), a classified text table (151), a geospatial measures table (152), a composite variables table (153), an industry ranking table (154), an element definition table (155), a segment definition table (156), a cluster ID table (157), an element variables table (158), a vector table (159), a bot table (160), a cash flow table (161), a real option value table (162), a risk transfer product table (163), a report table (164), an risk reduction activity table (165), an enterprise sentiment table (166), a value driver change table (167), a simulation table (168), an external factor definition table (169), a statistics table (170), a scenarios table (171), a web log data table (172), an order table (173), a supply chain system table (174), an optimal mix table (175), a risk system table (176), an xml summary table (177), a generic risk table (178), a financial forecasts table (179), a semantic map table (180), a frame definition table (181) a factor variables table (182), an analysis definition table (183) and a financial service provider table (184). The application database (50) can optionally exist as a datamart, data warehouse or storage area network. The system of the present invention has the ability to accept and store supplemental or primary data directly from user input, a data warehouse or other electronic files in addition to receiving data from the databases described previously. The system of the present invention also has the ability to complete the necessary calculations without receiving data from one or more of the specified databases. However, in one embodiment all information is obtained from the specified data sources (5, 10, 12, 15, 17, 25, 30, 35, 37 and 40) for each enterprise in each organization.

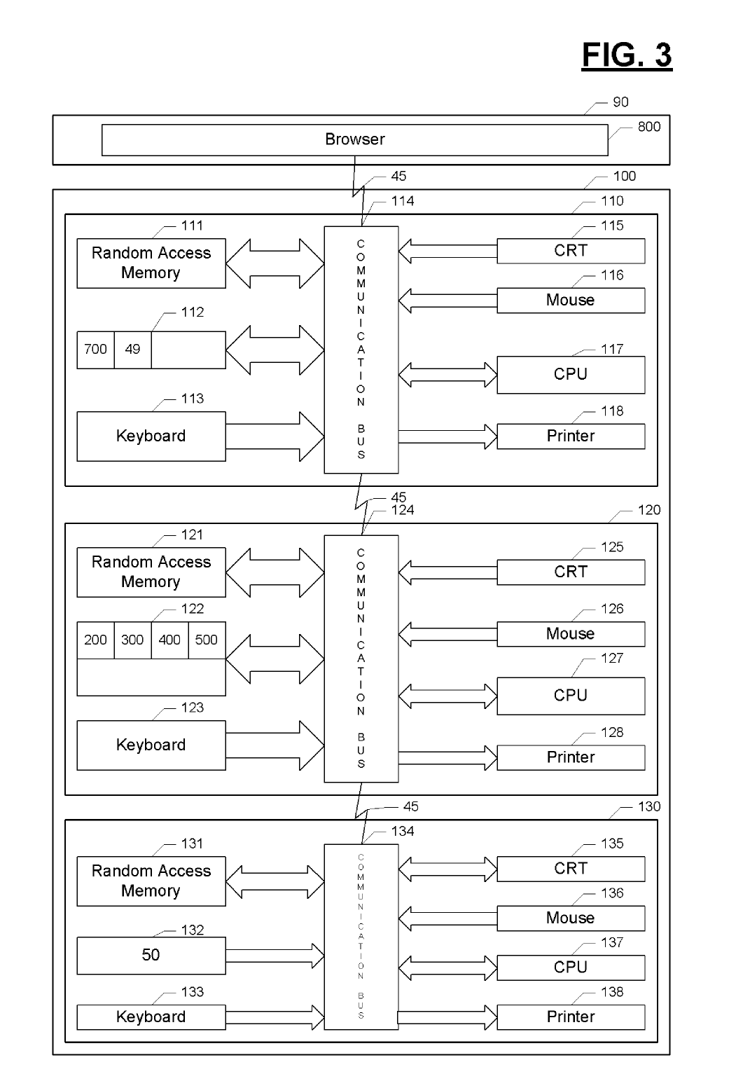

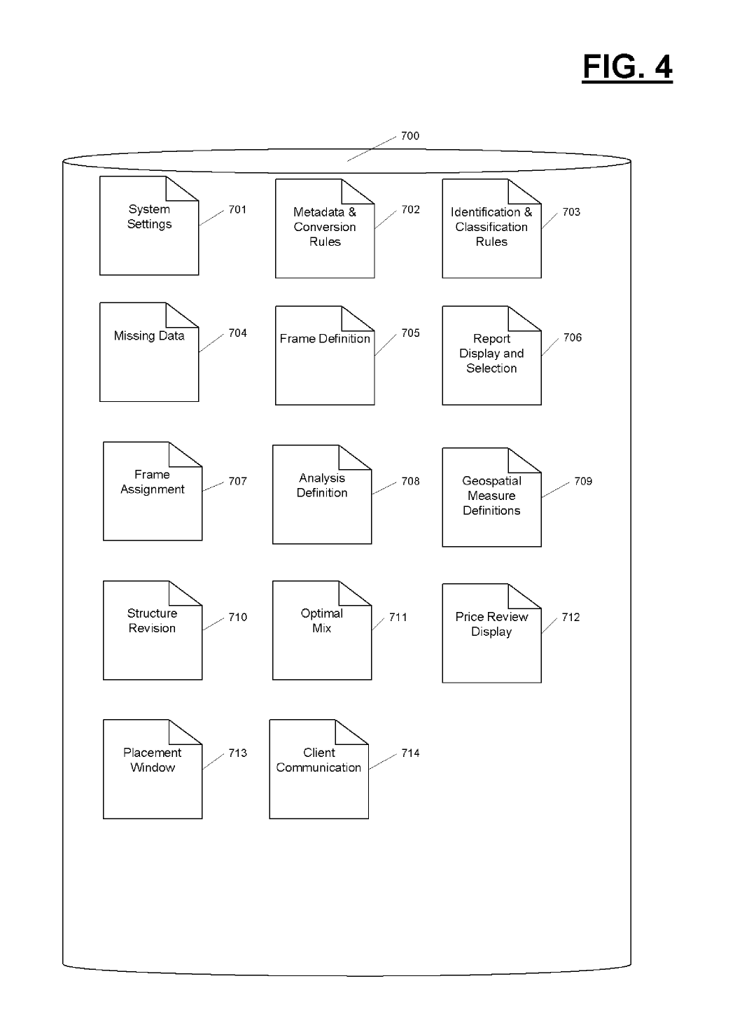

As shown in FIG. 3, one embodiment of the present invention is a computer system (100) illustratively comprised of a user-interface personal computer (110) connected to an application-server personal computer (120) via a network (45). The application server personal computer (120) is in turn connected via the network (45) to a database-server personal computer (130). The user interface personal computer (110) is also connected via the network (45) to an Internet browser appliance (90) that contains browser software (800) such as Opera or Netscape Navigator.

The database-server personal computer (130) has a read/write random access memory (131), a hard drive (132) for storage of the application database (50), a keyboard (133), a communications bus (134), a display (135), a mouse (136), a CPU (137) and a printer (138).

The application-server personal computer (120) has a read/write random access memory (121), a hard drive (122) for storage of the non-user-interface portion of the enterprise section of the application software (200, 300, 400, 500 and 600) of the present invention, a keyboard (123), a communications bus (124), a display (125), a mouse (126), a CPU (127) and a printer (128). While only one client personal computer is shown in FIG. 3, it is to be understood that the application-server personal computer (120) can be networked to fifty or more client, user-interface personal computers (110) via the network (45). The application-server personal computer (120) can also be networked to fifty or more server, personal computers (130) via the network (45). It is to be understood that the diagram of FIG. 3 is merely illustrative of one embodiment of the present invention.

The user-interface personal computer (110) has a read/write random access memory (111), a hard drive (112) for storage of a client data-base (49) and the user-interface portion of the application software (700), a keyboard (113), a communications bus (114), a display (115), a mouse (116), a CPU (117) and a printer (118).

The application software (200, 300, 400, 500 and 600) controls the performance of the central processing unit (127) as it completes the calculations that support the production of the matrices of value and risk for a commercial enterprise. In the embodiment illustrated herein, the application software program (200, 300, 400, 500 and 600) is written in a combination of C++ and Java. The application software (200, 300, 400, 500 and 600) can use Structured Query Language (SQL) for extracting data from the databases and the Internet (5, 10, 12, 15, 17, 25, 30, 35, 37 and 40). The user (20) can optionally interact with the user-interface portion of the application software (700) using the browser software (800) in the browser appliance (90) to provide information to the application software (200, 300, 400, 500 and 600) for use in determining which data will be extracted and transferred to the application database (50) by the data bots.

User input is initially saved to the client database (49) before being transmitted to the communication bus (124) and on to the hard drive (122) of the application-server computer via the network (45). Following the program instructions of the application software, the central processing unit (127) accesses the extracted data and user input by retrieving it from the hard drive (122) using the random access memory (121) as computation workspace in a manner that is well known.

The computers (110, 120, 130 and 139) shown in FIG. 3 illustratively are IBM PCs or clones or any of the more powerful computers or workstations that are widely available. Typical memory configurations for client personal computers (110) used with the present invention should include at least 512 megabytes of semiconductor random access memory (111) and at least a 100 gigabyte hard drive (112). Typical memory configurations for the application-server personal computer (120) used with the present invention should include at least 2056 megabytes of semiconductor random access memory (121) and at least a 250 gigabyte hard drive (122). Typical memory configurations for the database-server personal computer (130) used with the present invention should include at least 4112 megabytes of semiconductor random access memory (131) and at least a 500 gigabyte hard drive (132).

Using the system described above the matrices of value and risk for a multi-enterprise organization are produced after the elements of value and external factors are analyzed by segment of value for each enterprise in each organization using the approach outlined in Table 2.

As shown in Table 2, the value of the current-operation for each enterprise will be calculated using an income valuation. An integral part of most income valuation models is the calculation of the present value of the expected cash flows, income or profits associated with the current-operation. The present value of a stream of cash flows is calculated by discounting the cash flows at a rate that reflects the risk associated with realizing the cash flow. For example, the present value (PV) of a cash flow of ten dollars ($10) per year for five (5) years would vary depending on the rate used for discounting future cash flows as shown below.

Discount rate = 25%
$PV = \frac{10}{1.25} + \frac{10}{{( 1.25 )}^{2}} + \frac{10}{{( 1.25 )}^{3}} + \frac{10}{{( 1.25 )}^{4}} + \frac{10}{{( 1.25 )}^{5}} = 26.89$

Discount rate = 35%
$PV = \frac{10}{1.35} + \frac{10}{{( 1.35 )}^{2}} + \frac{10}{{( 1.35 )}^{3}} + \frac{10}{{( 1.35 )}^{4}} + \frac{10}{{( 1.35 )}^{5}} = 22.20$

One of the first steps in evaluating the elements of current-operation value is extracting the data for completing calculations in accordance with the formula that defines the value of the current-operation as shown in Table 4.

TABLE 4
Value of current-operation =
$\begin{matrix}( R ) Value of forecast revenue from current \text{-} operation ( positive ) + \\ ( E ) Value of forecast expense for current \text{-} operation ( negative ) + \\ {( C )}^{*} Value of current operation capital change forecast\end{matrix}$
*Note:
(C) can have a positive or negative value

The three components of current-operation value will be referred to as the revenue value (R), the expense value (E) and the capital value (C). Examination of the equation in Table 4 shows that there are four ways to increase the value of the current-operation—increase the revenue, decrease the expense, decrease the capital requirements or decrease the interest rate used for discounting future cash flows. As a simplification, the value of the current operation could be calculated from the cash flow which is revenue (a positive number) plus expense (a negative number) and the change in capital (a positive or negative number). A slight adjustment to this basic equation would be required to remove the non-cash depreciation and amortization. The detailed analysis by component of value is utilized in one embodiment.

In one embodiment, the revenue, expense and capital requirement forecasts for the current operation, the real options and the contingent liabilities are obtained from an advanced financial planning system database (30) derived from an advanced financial planning system similar to the one disclosed in U.S. Pat. No. 5,615,109. The extracted revenue, expense and capital requirement forecasts are used to calculate a cash flow for each period covered by the forecast for the enterprise by subtracting the expense and change in capital for each period from the revenue for each period. A steady state forecast for future periods is calculated after determining the steady state growth rate that best fits the calculated cash flow for the forecast time period. The steady state growth rate is used to calculate an extended cash flow forecast. The extended cash flow forecast is used to determine the Competitive Advantage Period (CAP) implicit in the enterprise market value.

While it is possible to use analysis bots to sub-divide each of the components of current operation value into a number of sub-components for analysis, one embodiment has a pre-determined number of sub-components for each component of value for the enterprise. The revenue value is not subdivided. In one embodiment, the expense value is subdivided into five sub-components: the cost of raw materials, the cost of manufacture or delivery of service, the cost of selling, the cost of support and the cost of administration. The capital value is subdivided into six sub-components: cash, non-cash financial assets, production equipment, other assets (non financial, non production assets), financial liabilities and equity. The components and sub-components of current-operation value will be used in valuing the current operation portion of the elements and sub-elements of value for each enterprise.

For the calculations completed by the present invention, a transaction will be defined as any event that is logged or recorded. Transaction data is any data related to a transaction. Descriptive data is any data related to any item, segment of value, element of value, component of value or external factor that is logged or recorded. Descriptive data includes forecast data and other data calculated by the system of the present invention. An element of value will be defined as “a group that as a result of past transactions, forecasts or other data has provided and/or is expected to provide economic benefit to the enterprise.” An item will be defined as a single member of the group that defines an element of value. For example, an individual salesman would be an “item” in the “element of value” sales employees. It is possible to have only one item in an element of value. The elements of value are selected from the group consisting of alliances, brands, customers, customer relationships, employees, employee relationships, infrastructure, intellectual property, information technology, investors, knowledge, partnerships, processes, production equipment, technology, vendors, vendor relationships, visitors and combinations thereof.

The transaction data and descriptive data associated with an item or related group of items will be referred to as “item variables”. Data derived from transaction data and/or descriptive data are referred to as an item performance indicators. Composite variables for an element of value are mathematical or logical combinations of item variables and/or item performance indicators. The item variables, item performance indicators and composite variables for a specific element or sub-element of value can be referred to as element variables or element data. External factors are numerical indicators of: conditions or prices external to the enterprise and conditions or performance of the enterprise compared to external expectations of conditions or performance. The transaction data and descriptive data associated with external factors will be referred to as “factor variables”. Data derived from factor transaction data and/or descriptive data are referred to as factor performance indicators. Composite factors for a factor are mathematical or logical combinations of factor variables and/or factor performance indicators. The factor variables, factor performance indicators and composite factors for external factors can be referred to as factor data.

A value chain is defined to be the enterprises that have joined together to deliver a product and/or a service to a customer. Consistent with the practice outlined in the cross-referenced patents and applications, an enterprise is a commercial enterprise with one revenue component of value (note: as detailed in the related patents and applications a commercial enterprise can have more than one revenue component of value). A multi company corporation is a corporation that participates in more than one distinct line of business. As discussed previously, value chains and multi company corporations are both multi-enterprise organizations. Partnerships between government agencies and private companies and/or other government agencies can also be analyzed as multi-enterprise organizations using the system of the present invention.

Analysis bots are used to determine element of value lives and the percentage of: the revenue value, the expense value, and the capital value that are attributable to each element of value by enterprise. The resulting values are then added together to determine the valuation for different elements of value as shown by the example in Table 5.

TABLE 5

| | Percen- | Element | |
|---|---|---|---|
| Gross Value | tage | Life/CAP* | Net Value |
| Revenue value = $120M | 20% | 80% | Value = $19.2M |
| Expense value = ($80M) | 10% | 80% | Value = ($6.4)M |
| Capital value = ($5M) | 5% | 80% | Value = ($0.2)M |
| Total value = $35M | | | |
| Net value for this element: | | | Value = $12.6M |

*CAP = Competitive Advantage Period

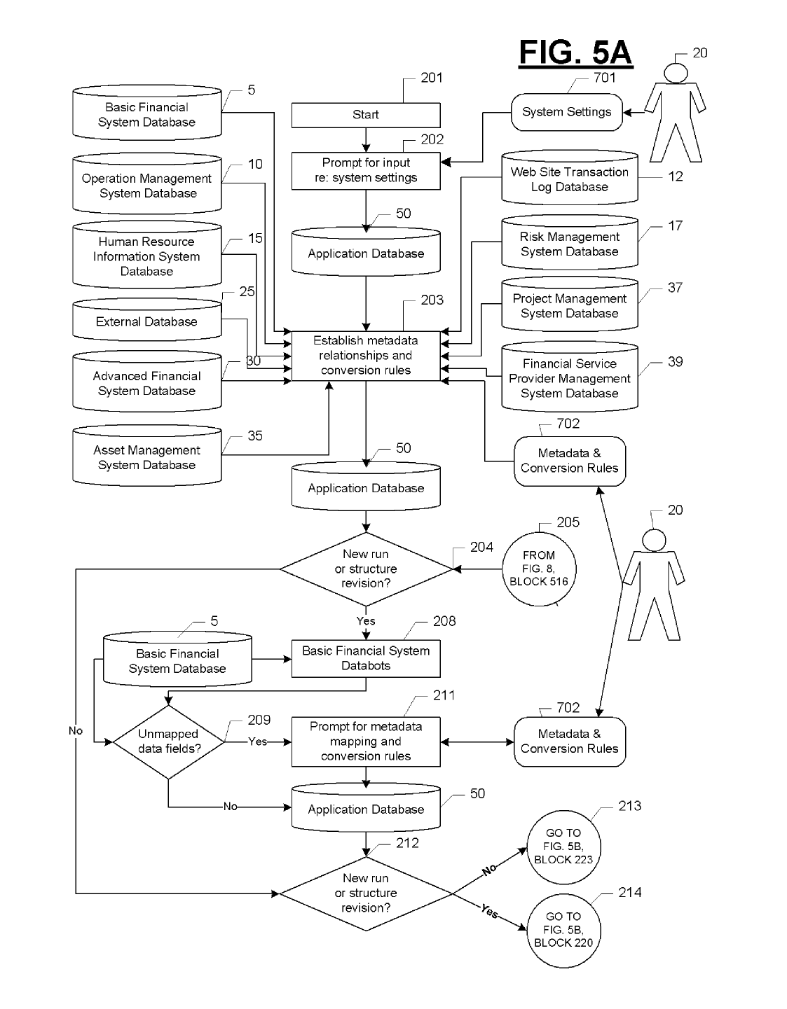

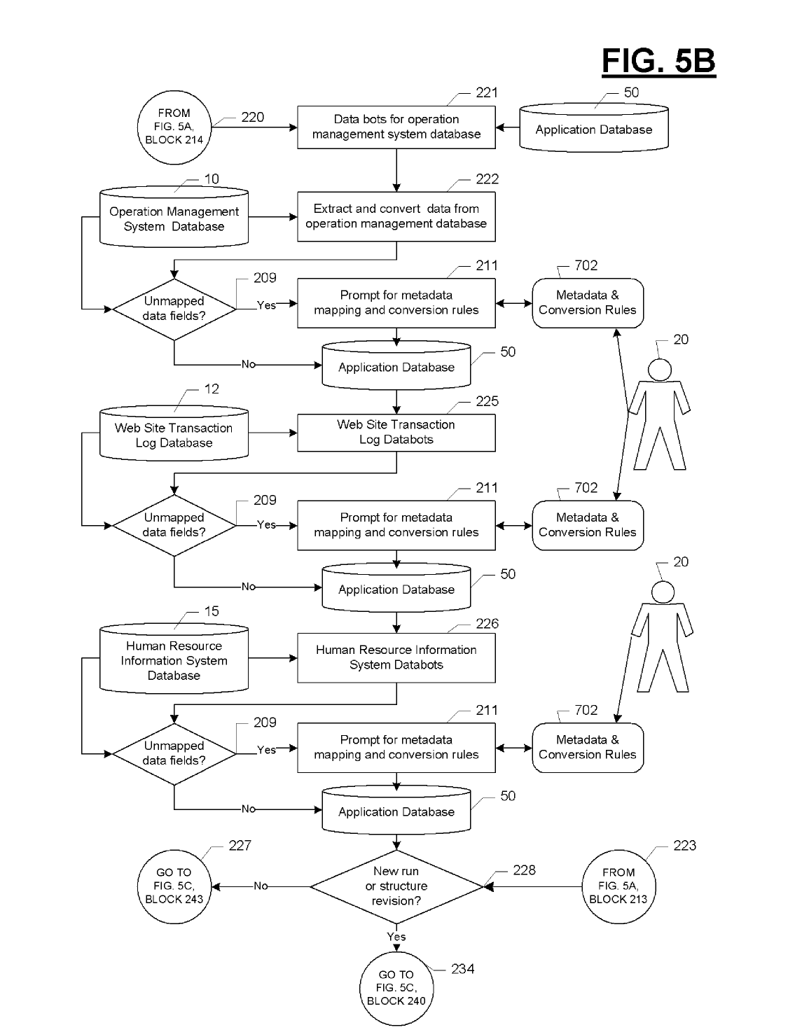

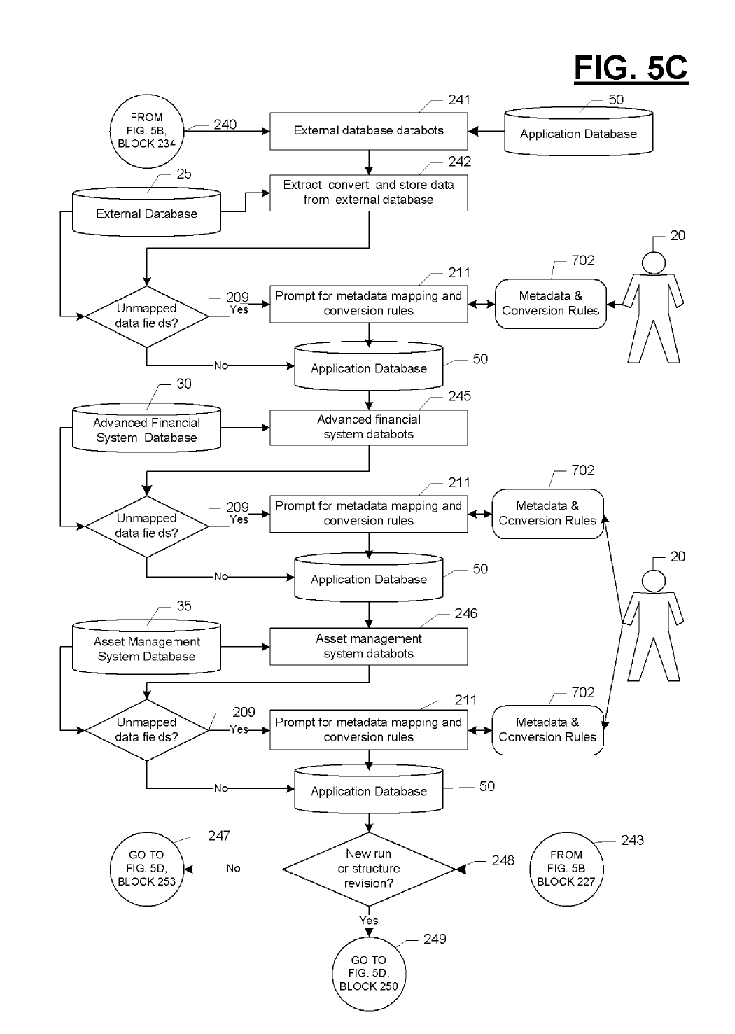

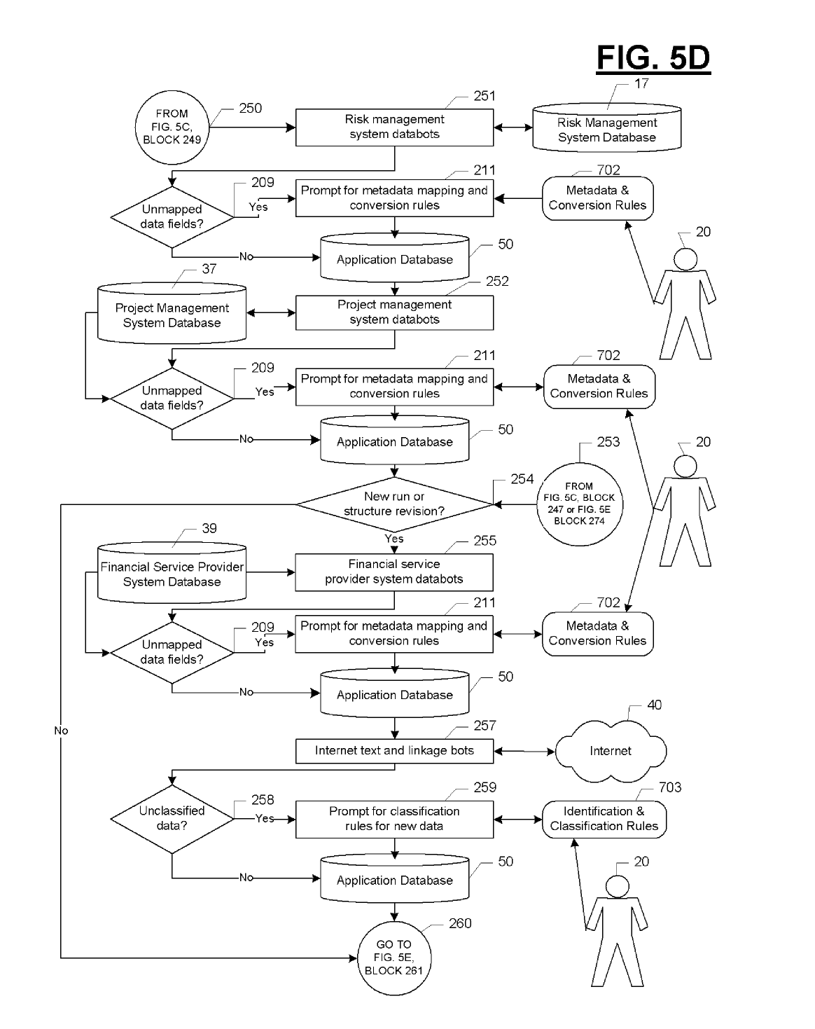

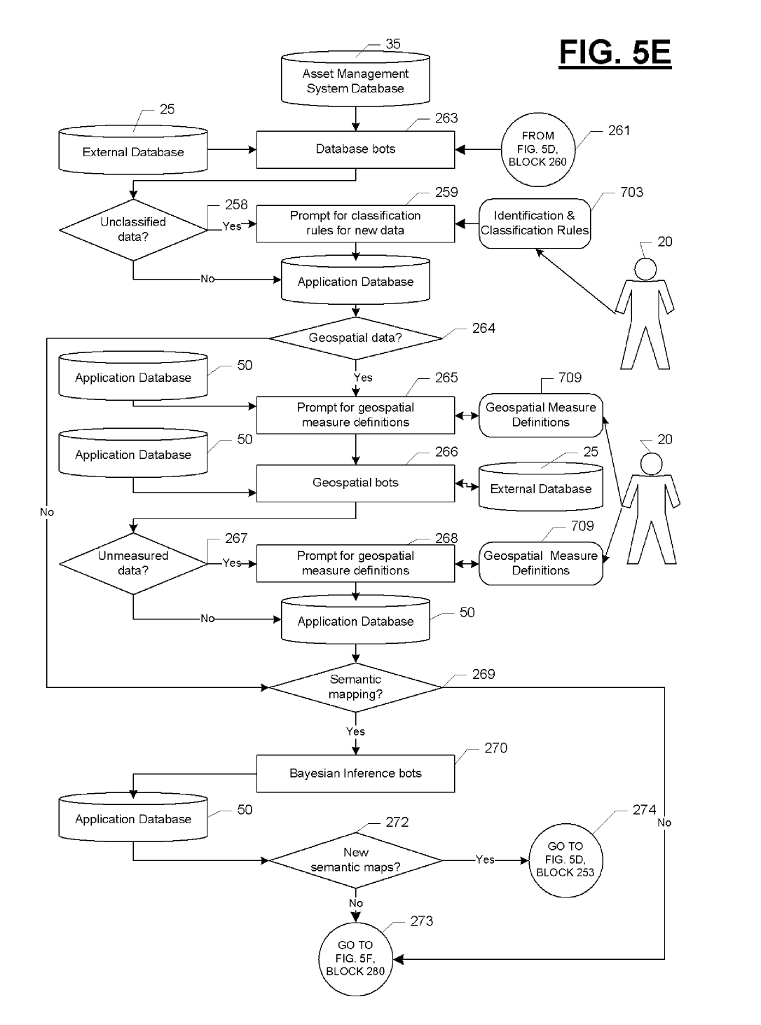

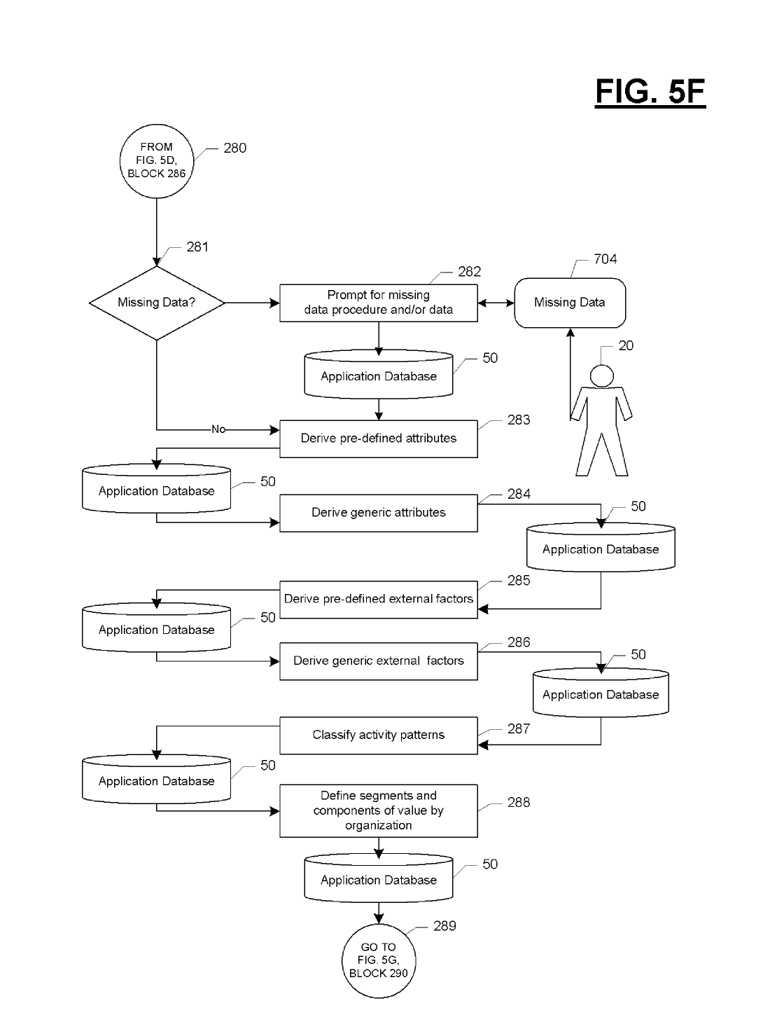

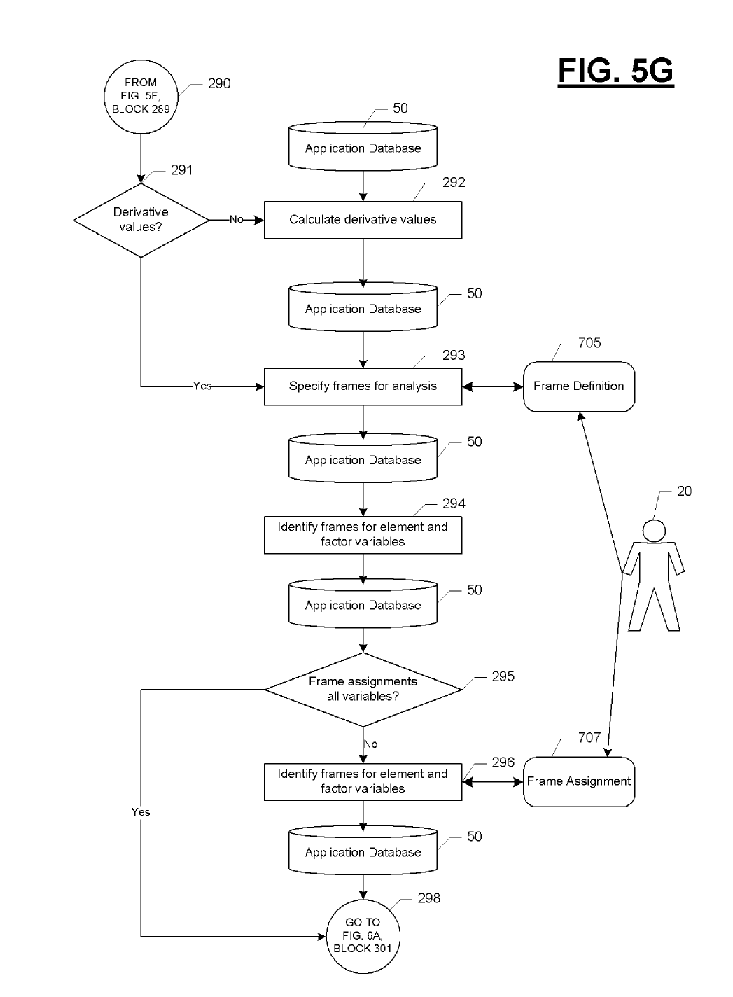

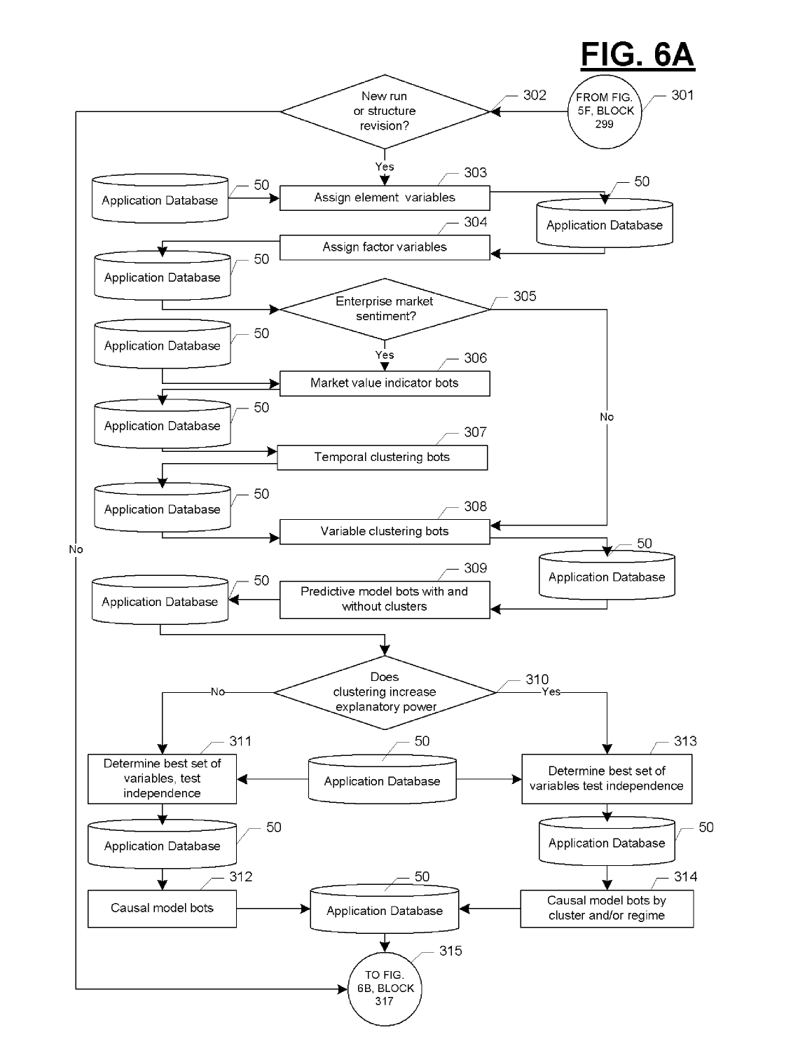

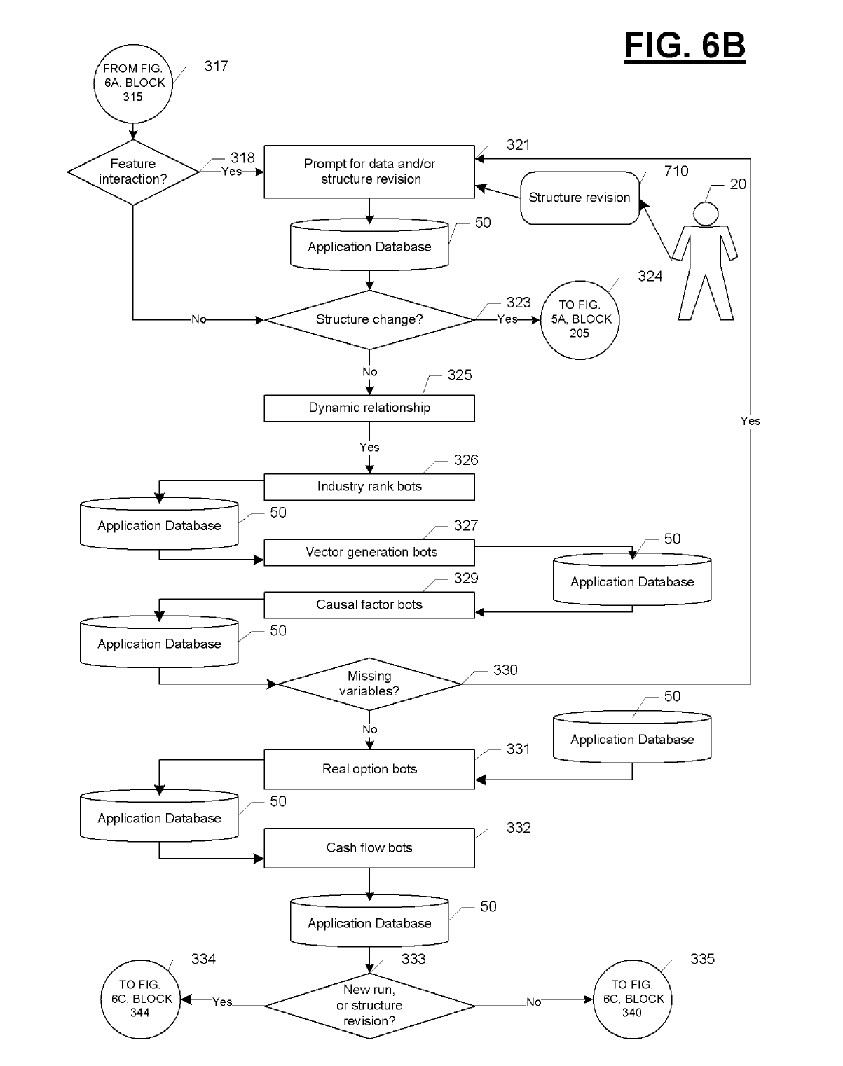

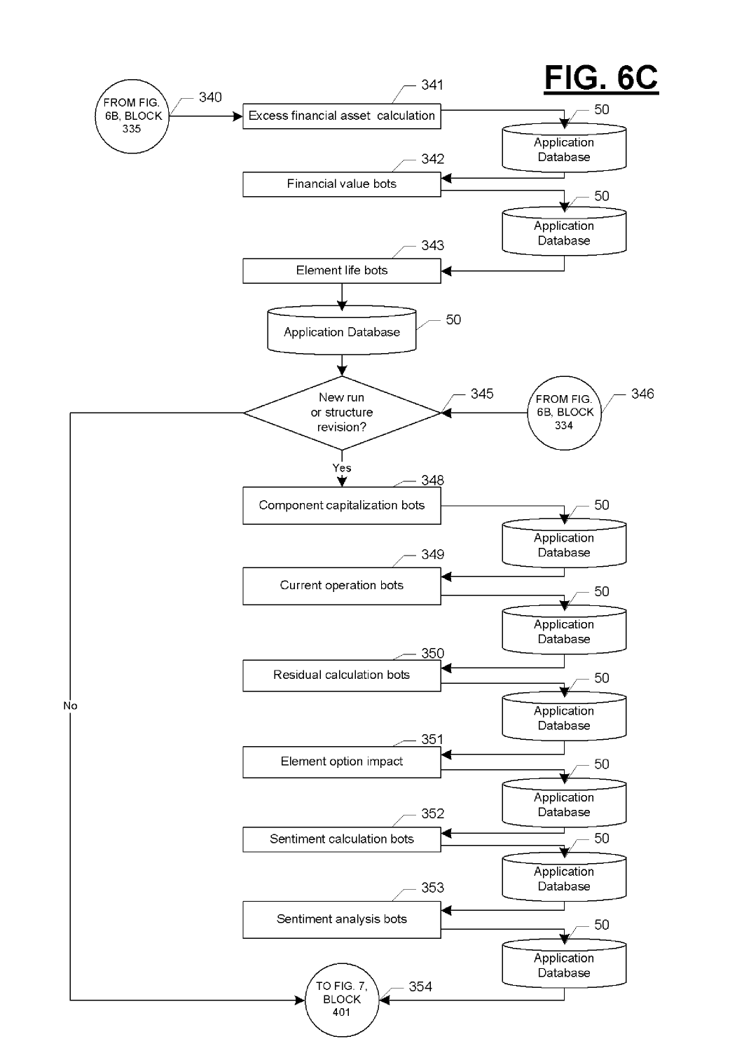

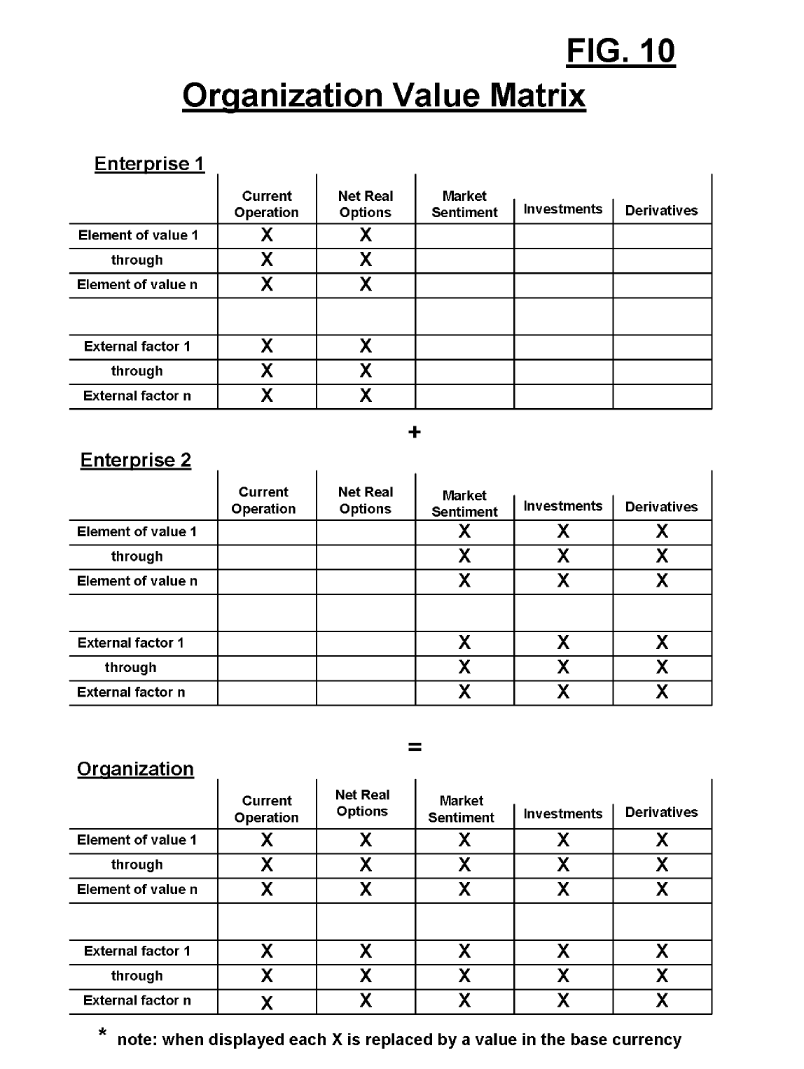

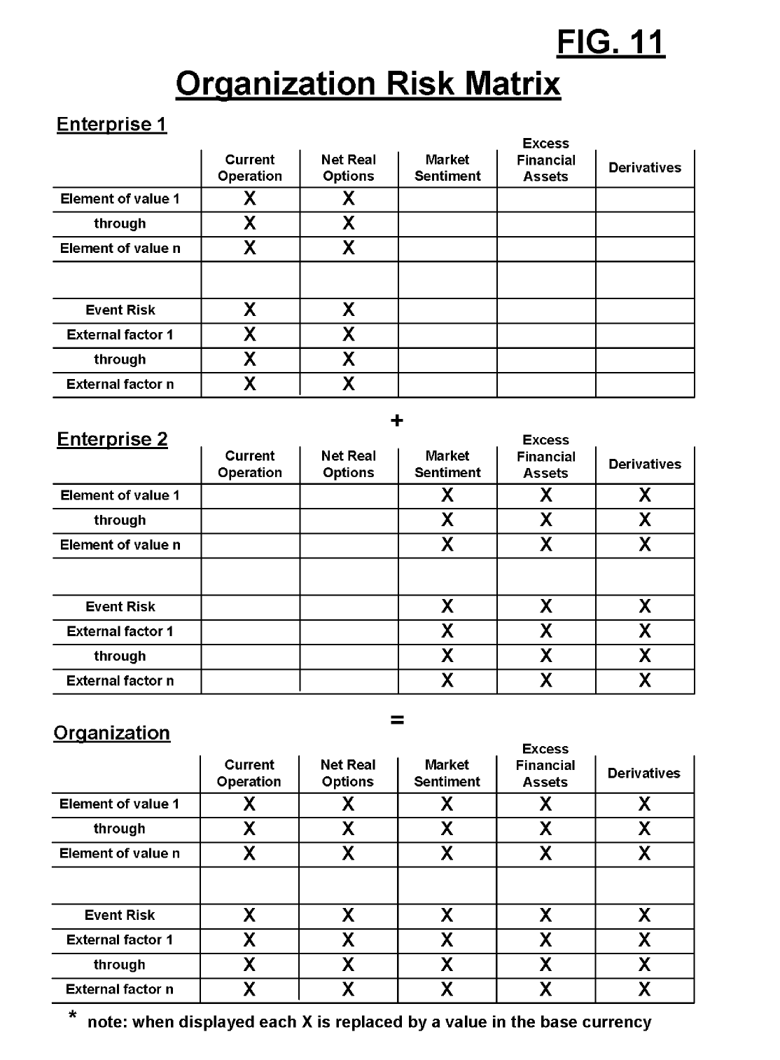

The development of the matrices of value and risk for each organization is completed in four distinct stages. As shown in FIG. 5A, FIG. 5B, FIG. 5C, FIG. 5D, FIG. 5E, FIG. 5F and FIG. 5G the first stage of processing (block 200 from FIG. 1) programs bots to continually extract, aggregate, manipulate and store the data from user input, databases and the Internet (5, 10, 12, 15, 17, 25, 30, 35, 37 and 40) to support the analysis of business value and risk by enterprise. Bots are independent components of application software that have specific tasks to perform. As shown in FIG. 6A, FIG. 6B and FIG. 6C the second stage of processing (block 300 from FIG. 1) continually values the segments of value and generates a matrix quantifying the impact of elements of value and external factors on the segments of value by enterprise (see FIG. 10) by creating and activating analysis bots to:
1. Identify the factor variables, factor performance indicators and composite variables that characterize the impact of each external factor on: the current operation, derivative and excess financial asset segments of value by enterprise,
2. Identify the item variables, item performance indicators, composite variables and vectors for each element and sub-element of value that characterize the element of values performance in driving: the current operation, derivative and excess financial asset segments of value by enterprise,
3. Create vectors that summarize the item variables, item performance indicators and composite variables that define the impact of each element of value and sub-element of value on one or more segments of value,
4. Create vectors that summarize the factor variables, factor performance indicators and composite variables that define the impact of each external factor one or more segments of value,
5. Determine the expected life of each element of value and sub-element of value;
6. Determine the value of the current operation, excess financial assets and derivatives;
7. Determine the appropriate discount rate on the basis of relative causal element strength, value the enterprise real options and determine the contribution of each element of value to real option valuation;
8. Determine the best indicator for stock price movement, calculate market sentiment and analyze the causes of market sentiment;
9. Combine the results of the prior stages of processing to determine the value of each external factor, element of value and sub-element of value by segment for each enterprise; and
10. Sum the results from all the enterprises to calculate the overall organization value and create the organization value matrix.
   The third stage of processing (block 400 from FIG. 1) analyzes the risks faced by each enterprise under normal and extreme conditions as part of the process of developing the matrix of risk (see FIG. 11) for each organization before defining the efficient frontier for financial performance. The fourth stage of processing (block 500 from FIG. 1) displays the matrix of value, the matrix of risk and the efficient frontier for each organization before analyzing and optimizing the impact of changes in structure, features and/or operation on all or part of the financial performance of one or more organizations. The fifth and final stage of processing (block 600 from FIG. 1) can be used to complete the development and optimized delivery of customized risk transfer products for one or more organizations and/or the valuation and sale of securities for one or more organizations.

### System Settings and Data Bots

The flow diagrams in FIG. 5A, FIG. 5B, FIG. 5C, FIG. 5D, FIG. 5E, FIG. 5F and FIG. 5G detail the processing that is completed by the portion of the application software (200) that extracts, aggregates, transforms and stores the information used in system operation from the: basic financial system database (5), operation management system database (10), the web site transaction log database (12), human resource information system database (15), risk management system database (17), external database (25), advanced financial system database (30), asset management system database (35), the project management system database (37), the Internet (40) and the user (20) by enterprise. A brief overview of the different databases will be presented before reviewing each step of processing completed by this portion (200) of the application software.

Corporate financial software systems are generally divided into two categories, basic and advanced. Advanced financial systems utilize information from the basic financial systems to perform financial analysis, financial planning and financial reporting functions. Virtually every commercial enterprise uses some type of basic financial system, as they are required to use these systems to maintain books and records for income tax purposes. An increasingly large percentage of these basic financial systems are resident in microcomputer and workstation systems. Basic financial systems include general-ledger accounting systems with associated accounts receivable, accounts payable, capital asset, inventory, invoicing, payroll and purchasing subsystems. These systems incorporate worksheets, files, tables and databases. These databases, tables and files contain information about the enterprise operations and its related accounting transactions. As will be detailed below, these databases, tables and files are accessed by the application software of the present invention in order to extract the information used for completing system calculations. The system is also capable of extracting information from a data warehouse (or datamart) when data and information has been pre-loaded into the warehouse.

General ledger accounting systems generally store only valid accounting transactions. As is well known, valid accounting transactions consist of a debit component and a credit component where the absolute value of the debit component is equal to the absolute value of the credit component. The debits and the credits are posted to the separate accounts maintained within the accounting system. Every basic accounting system has several different types of accounts. The effect that the posted debits and credits have on the different accounts depends on the account type as shown in Table 6.

TABLE 6

| Account Type: | Debit Impact: | Credit Impact: |
|---|---|---|
| Asset | Increase | Decrease |
| Revenue | Decrease | Increase |
| Expense | Increase | Decrease |
| Liability | Decrease | Increase |
| Equity | Decrease | Increase |

General ledger accounting systems also require that the asset account balances equal the sum of the liability account balances and equity account balances at all times.

The general ledger system generally maintains summary, dollar only transaction histories and balances for all accounts while the associated subsystems, accounts payable, accounts receivable, inventory, invoicing, payroll and purchasing, maintain more detailed historical transaction data and balances for their respective accounts. It is common practice for each subsystem to maintain the detailed information shown in Table 7 for each transaction.

TABLE 7

| Subsystem | Detailed Information |
|---|---|
| Accounts | Vendor, Item(s), Transaction Date, Amount Owed, |
| Payable | Due Date, Account Number |
| Accounts | Customer, Transaction Date, Product Sold, Quantity, |
| Receivable | Price, Amount Due, Terms, |
| | Due Date, Account Number |
| Capital | Asset ID, Asset Type, Date of Purchase, Purchase |
| Assets | Price, Useful Life, Depreciation Schedule, Salvage Value |
| Inventory | Item Number, Transaction Date, Transaction |
| | Type, Transaction Qty, Location, Account Number |
| Invoicing | Customer Name, Transaction Date, Product(s) Sold, |
| | Amount Due, Due Date, Account Number |
| Payroll | Employee Name, Employee Title, Pay Frequency, |
| | Pay Rate, Account Number |
| Purchasing | Vendor, Item(s), Purchase Quantity, Purchase |
| | Price(s), Due Date, Account Number |

As is well known, the output from a general ledger system includes income statements, balance sheets and cash flow statements in well defined formats which assist management in measuring the financial performance of the firm during the prior periods when data input and system processing have been completed.

While basic financial systems are similar between firms, operation management systems vary widely depending on the type of company they are supporting. These systems typically have the ability to not only track historical transactions but to forecast future performance. For manufacturing firms, operation management systems such as Enterprise Resource Planning Systems (ERP), Material Requirement Planning Systems (MRP), Purchasing Systems, Scheduling Systems and Quality Control Systems are used to monitor, coordinate, track and plan the transformation of materials and labor into products. Systems similar to the one described above may also be useful for distributors to use in monitoring the flow of products from a manufacturer.

Operation Management Systems in manufacturing firms may also monitor information relating to the production rates and the performance of individual production workers, production lines, work centers, production teams and pieces of production equipment including the information shown in Table 8.

TABLE 8
Operation Management System-
Production Information

```
  1. ID number (employee id/machine id)
  2. Actual hours - last batch
  3. Standard hours - last batch
  4. Actual hours - year to date
  5. Actual/Standard hours - year to date %
  6. Actual setup time - last batch
  7. Standard setup time - last batch
  8. Actual setup hours - year to date
  9. Actual/Standard setup hrs - yr to date %
10. Cumulative training time
11. Job(s) certifications
12. Actual scrap - last batch
13. Scrap allowance - last batch
14. Actual scrap/allowance - year to date
15. Rework time/unit last batch
16. Rework time/unit year to date
17. QC rejection rate - batch
18. QC rejection rate - year to date
```

Operation management systems are also useful for tracking requests for service to repair equipment in the field or in a centralized repair facility. Such systems generally store information similar to that shown below in Table 9.

TABLE 9
Operation Management System-
Service Call Information

```
  1. Customer name
  2. Customer number
  3. Contract number
  4. Service call number
  5. Time call received
  6. Product(s) being fixed
  7. Serial number of equipment
  8. Name of person placing call
  9. Name of person accepting call
10. Promised response time
11. Promised type of response
12. Time person dispatched to call
13. Name of person handling call
14. Time of arrival on site
15. Time of repair completion
16. Actual response type
17. Part(s) replaced
18. Part(s) repaired
19. 2nd call required
20. 2nd call number
```

Web site transaction log databases keep a detailed record of every visit to a web site, they can be used to trace the path of each visitor to the web site and upon further analysis can be used to identify patterns that are most likely to result in purchases and those that are most likely to result in abandonment. This information can also be used to identify which promotion would generate the most value for the enterprise using the system. Web site transaction logs generally contain the information shown in Table 10.

TABLE 10
Web Site Transaction
Log Database

```
  1. Customer's URL
  2. Date and time of visit
  3. Pages visited
  4. Length of page visit (time)
  5. Type of browser used
  6. Referring site
  7. URL of site visited next
  8. Downloaded file volume and type
  9. Cookies
10. Transactions
```

Computer based human resource systems may some times be packaged or bundled within enterprise resource planning systems such as those available from SAP, Oracle and Peoplesoft. Human resource systems are increasingly used for storing and maintaining corporate records concerning active employees in sales, operations and the other functional specialties that exist within a modern corporation. Storing records in a centralized system facilitates timely, accurate reporting of overall manpower statistics to the corporate management groups and the various government agencies that require periodic updates. In some cases, human resource systems include the enterprise payroll system as a subsystem. In one embodiment of the present invention, the payroll system is part of the basic financial system. These systems can also be used for detailed planning regarding future manpower requirements. Human resource systems typically incorporate worksheets, files, tables and databases that contain information about the current and future employees. As will be detailed below, these databases, tables and files are accessed by the application software of the present invention in order to extract the information used in completing a business optimization analysis. It is common practice for human resource systems to store the information shown in Table 11 for each employee.

TABLE 11
Human Resource System Information

```
  1. Employee name
  2. Job title
  3. Job code
  4. Rating
  5. Division
  6. Department
  7. Employee No./(Social Security Number)
  8. Year to date - hours paid
  9. Year to date - hours worked
10. Employee start date - enterprise
11. Employee start date - department
12. Employee start date - current job
13. Training courses completed
14. Cumulative training expenditures
15. Salary history
16. Current salary
17. Educational background
18. Current supervisor
```

Risk management systems databases (17) contain statistical data about the past behavior and forecasts of likely future behavior of interest rates, currency exchange rates weather, commodity prices and key customers (credit risk systems). They also contain detailed information about the composition and mix of risk reduction products (derivatives, insurance, etc.) the enterprise has purchased. Some companies also use risk management systems to evaluate the desirability of extending or increasing credit lines to customers. The information from these systems is used to supplement the risk information developed by the system of the present invention.

External databases can be used for obtaining information that enables the definition and evaluation of a variety of things including elements of value, external factors, industry real options and event risks. In some cases, information from these databases can be used to supplement information obtained from the other databases and the Internet (5, 10, 12, 15, 17, 30, 35, 37 and 40). In the system of the present invention, the information extracted from external databases (25) can be in the forms listed in Table 12.

TABLE 12
Types of information

| | |
|---|---|
| 1) | numeric information such as that found in the SEC Edgar database and the |
| | databases of financial infomediaries such as FirstCall, IBES and Compustat, |
| 2) | text information such as that found in the Lexis Nexis database and |
| | databases containing past issues from specific publications, |
| 3) | risk management products such as derivatives, swaps and standardized |
| | insurance contracts that can be purchased on line, |
| 4) | geospatial data; |
| 5) | multimedia information such as video and audio clips, and |
| 6) | event risk data including information about the likelihood of earthquake |
| | and weather damage by geospatial location and information about the |
| | likelihood of property and casualty losses that can be determined in part by |
| | the industry the enterprise is a member of (i.e. coal mining, broadcasting, |
| | legal, etc.) |

The system of the present invention uses different “bot” types to process each distinct data type from external databases (25). The same “bot types” are also used for extracting each of the different types of data from the Internet (40).

Advanced financial systems may also use information from external databases (25) and the Internet (40) in completing their processing. Advanced financial systems include financial planning systems and activity based costing systems. Activity based costing systems may be used to supplement or displace the operation of the expense component analysis segment of the present invention. Financial planning systems generally use the same format used by basic financial systems in forecasting income statements, balance sheets and cash flow statements for future periods. Management uses the output from financial planning systems to highlight future financial difficulties with a lead time sufficient to permit effective corrective action and to identify problems in enterprise operations that may be reducing the profitability of the business below desired levels. These systems are most often developed by individuals within companies using two and three-dimensional spreadsheets such as Lotus 1-2-3®, Microsoft Excel® and Quattro Pro®. In some cases, financial planning systems are built within an executive information system (EIS) or decision support system (DSS). For one embodiment of the present invention, the advanced finance system database is similar to the financial planning system database detailed in U.S. Pat. No. 5,165,109 for “Method of and System for Generating Feasible, Profit Maximizing Requisition Sets”, by Jeff S. Eder, the disclosure of which is incorporated herein by reference.

While advanced financial planning systems have been around for some time, asset management systems are a relatively recent development. Their appearance is further proof of the increasing importance of “soft” assets. Asset management systems include: customer relationship management systems, partner relationship management systems, channel management systems, knowledge management systems, visitor relationship management systems, intellectual property management systems, investor management systems, vendor management systems, supply chain management systems, alliance management systems, process management systems, brand management systems, workforce management systems, human resource management systems, email management systems, IT management systems and/or quality management systems. Asset management systems are similar to operation management systems in that they generally have the ability to forecast future events as well as track historical occurrences. Many have also added analytical capabilities that allow them to identify trends and patterns in the data associated with the asset they are managing. Customer relationship management systems are the most well established asset management systems at this point and will be the focus of the discussion regarding asset management system data. In firms that sell customized products, the customer relationship management system is generally integrated with an estimating system that tracks the flow of estimates into quotations, orders and eventually bills of lading and invoices. In other firms that sell more standardized products, customer relationship management systems generally are used to track the sales process from lead generation to lead qualification to sales call to proposal to acceptance (or rejection) and delivery. All customer relationship management systems would be expected to track all of the customer's interactions with the enterprise after the first sale and store information similar to that shown below in Table 13.

TABLE 13
Customer Relationship Management
System - Information

```
  1. Customer/Potential customer name
  2. Customer number
  3. Address
  4. Phone number
  5. Source of lead
  6. Date of first purchase
  7. Date of last purchase
  8. Last sales call/contact
  9. Sales call history
10. Sales contact history
11. Sales history: product/qty/price
12. Quotations: product/qty/price
13. Custom product percentage
14. Payment history
15. Current A/R balance
16. Average days to pay
```

Project management systems (37) could be considered as asset management systems as they are generally used to manage the development of new assets. However, because of their importance and visibility they are listed separately. The systems used for managing project design and development are generally divided into two categories, computer automated design systems and project management systems (hereinafter, collectively referred to as project design systems). Architects, engineers and designers use computer aided design systems like AutoCAD, Solidworks, Mechcad, Ironcad, Orcad, Encad and Hyperplot to design and specify projects they are creating. Project management systems like Microsoft Project and Primavera are used track the use of project resources and the timing of project milestone completion. The data on the design and timing of the project from the databases of the computer aided design systems (as defined) is used as input to the system of the present invention to define the project or projects being analyzed.

The information from the project design systems is generally supplemented by data from the operating factors database and optionally a simulation program database. The operating factors database includes information concerning the cost, output impacts, size, weight, composition, risk mitigation and commodity consumption of each feature specified by the computer aided design system. Depending on the type of project, the feature information may be supplemented by information from real estate appraisal systems that estimate the value of including specific features within a building. Simulation programs such as Blast, COMBINE, DOE-2, SPICE, etc. can be used to supplement or replace the operating factors data by calculating overall consumption for the project and/or by forecasting project performance. The information regarding project design and operating performance is combined with commodity price information downloaded from web sites and/or databases on the internet (40) as required to support risk and return management for the project being analyzed. The information on commodity prices will include both current prices and future prices.

System processing of the information from the different databases (5, 10, 12, 15, 17, 25, 30, 35 and 37) and the Internet (40) described above starts in a block 201, FIG. 5A, which immediately passes processing to a software block 202. The software in block 202 prompts the user (20) via the system settings data window (701) to provide system setting information. The system setting information entered by the user (20) is transmitted via the network (45) back to the application server (120) where it is stored in the system settings table (140) in the application database (50) in a manner that is well known. The specific inputs the user (20) is asked to provide at this point in processing are shown in Table 15.

TABLE 15

| | |
|---|---|
| 1. | New calculation or structure revision? |
| 2. | Continuous, If yes, new calculation frequency? (hourly, daily, etc.) |
| 3. | Base account structure |
| 4. | Base currency |
| 5. | Metadata standard (xml, rdf or metadata coalition standard) |
| 6. | Organization ID, organization structure (enterprises), enterprise |
| | structure (segments of value) and data source (separate systems or value |
| | and risk management system)* |
| 7. | Location of account structure* |
| 8. | Location of value and risk management system database and metadata* |
| 9. | Location of basic financial system database and metadata* |
| 10. | Location of advanced finance system database and metadata* |
| 11. | Location of human resource information system database and metadata* |
| 12. | Location of operation management system database and metadata* |
| 13. | Location of asset management system databases and metadata* |
| 14. | Location of external databases and metadata* |
| 15. | Location of web site transaction log database and metadata* |
| 16 | Location of project management system database and metadata* |
| 17. | Location of risk management system database and metadata* |
| 18. | Location of database and metadata for equity information* |
| 19. | Location of database and metadata for debt information* |
| 20. | Location of database and metadata for tax rate information* |
| 21. | Minimum amount of cash and marketable securities required |
| | for operations* |
| 22. | Total cost of capital (weighted average cost of equity, debt |
| | and risk capital)* |
| 23. | Number of months a product is considered new after it is first |
| | produced* |
| 24. | Organization industry classification (SIC Code)* |
| 25. | Management report types (text, graphic, both)* |
| 26. | Maximum discount rate for new projects (optional)* |
| 27. | Detailed valuation using components of current operation |
| | value? (yes or no)* |
| 28. | Use of industry real options? (yes or no)* |
| 29. | Maximum number of sub-elements* |
| 30. | Automated implementation of baseline efficient frontier? (yes or no)* |
| 31. | Default Missing Data Procedure |
| 32. | Maximum time to wait for user input |
| 33. | Confidence interval for risk reduction programs |
| 34. | Location of database and metadata for currency conversion rate |
| | information |
| 35. | Geospatial data? If yes, identity of geocoding service. |
| 36. | The maximum number of generations to be processed without |
| | improving fitness |
| 37. | Feature level optimization? (yes or no) |
| 38. | Default clustering algorithm (selected from list) and maximum cluster |
| | number |
| 39. | Semantic mapping? (yes or no) |
| 40. | Standard security denominations |

*by organization for client organizations and/or financial service provider organization

The application of these system settings will be further explained as part of the detailed explanation of the system operation.

The software in block 202 uses the current system date to determine the time periods (months) data will be used from to complete the calculations. After the date range is calculated it is stored in the system settings table (140). In one embodiment the system (100) obtains and utilizes data from every source for the four year period before and the three year forecast period after the specified valuation date and/or the date of system calculation. The user (20) also has the option of specifying the data periods that will be used for completing system calculations.

After the storage of system setting data is complete, processing advances to a software block 203. The software in block 203 prompts the user (20) via the metadata and conversion rules window (702) to map metadata using the metadata standard specified by the user (20) from the basic financial system database (5), the operation management system database (10), the web site transaction log database (12), the human resource information system database (15), the risk management system database (17), the external database (25), the advanced financial system database (30), the asset management system database (35) and the project management system database (37) to the organization hierarchy stored in the system settings table (140) and to the pre-specified fields in the metadata mapping table (141). Pre-specified fields in the metadata mapping table include the revenue, expense and capital components and sub-components of current operation value for the enterprise and pre-specified fields for expected value drivers by element of value and external factor. Because the bulk of the information being extracted is financial information, the metadata mapping often takes the form of specifying the account number ranges that correspond to the different fields in the metadata mapping table (141). Table 16 shows the base account number structure that the account numbers in the other systems must align with. For example, using the structure shown below, the revenue component for the enterprise could be specified as enterprise 01, any department number, accounts 400 to 499 (the revenue account range) with any sub-account.

TABLE 16

| Account | | | | |
|---|---|---|---|---|
| Number | 01 - | 902 (any) - | 477- | 86 (any) |
| Section | Enterprise | Department | Account | Sub-account |
| Subgroup | Workstation | Marketing | Revenue | Singapore |
| Position | 4 | 3 | 2 | 1 |

As part of the metadata mapping process, any database fields that are not mapped to pre-specified fields are defined by the user (20) as component of value, elements of value or non-relevant attributes and “mapped” in the metadata mapping table (141) to the corresponding fields in each database in a manner identical to that described above for the pre-specified fields. After all fields have been mapped to the metadata mapping table (141), the software in block 203 prompts the user (20) via the metadata and conversion rules window (702) to provide conversion rules for each metadata field for each data source. Conversion rules will include information regarding currency conversions and conversion for units of measure that may be required to accurately and consistently analyze the data. The inputs from the user (20) regarding conversion rules are stored in the conversion rules table (142) in the application database (50). When conversion rules have been stored for all fields from every data source, then processing advances to a software block 204.

The software in block 204 checks the system settings table (140) in the application database (50) to determine if the current calculation is a new calculation or a structure change. The calculation (or run) may be new because the system is running for first time or it may be because the system is running continuously and it is now time for a new calculation to be completed. If the calculation is not a new calculation or a structure change then processing advances to a software block 212. Alternatively, if the calculation is new or a structure change, then processing advances to a software block 208.

The software in block 208 checks the bot date table (149) and deactivates any basic financial system data bots with creation dates before the current system date and retrieves information from the system settings table (140), metadata mapping table (141) and conversion rules table (142). The software in block 208 then initializes data bots for each field in the metadata mapping table (141) that mapped to the basic financial system database (5) in accordance with the frequency specified by user (20) in the system settings table (140). Bots are independent components of application software that have specific tasks to perform. In the case of data acquisition bots, their tasks are to extract and convert transaction and descriptive data from a specified source and then store it in a specified location. Each data bot initialized by software block 208 will store its data in the basic financial system table (143) and/or the derivatives table (175). Every data acquisition bot contains the information shown in Table 17.

TABLE 17

| | |
|---|---|
| 1. | Unique ID number (based on date, hour, |
| | minute, second of creation) |
| 2. | The data source location |
| 3. | Mapping information |
| 4. | Timing of extraction |
| 5. | Conversion rules (if any) |
| 6. | Storage Location (to allow for tracking of |
| | source and destination events) |
| 7. | Organization |
| 8. | Enterprise |
| 9. | Creation date (date, hour, minute, second) |

After the software in block 208 initializes all the bots for the basic financial system database, the bots extract and convert transaction and descriptive data from the basic financial system (5) in accordance with their preprogrammed instructions in accordance with the frequency specified by user (20) in the system settings table (140). As each bot extracts and converts data from the basic financial system database (5) by enterprise, processing advances to a software block 209 before the bot completes data storage. The software in block 209 checks the basic financial system metadata to see if all fields have been extracted. If the software in block 209 finds no unmapped data fields, then the extracted, converted data are stored in the basic financial system table (143) by enterprise. Alternatively, if there are fields that have not been extracted, then processing advances to a block 211. The software in block 211 prompts the user (20) via the metadata and conversion rules window (702) to provide metadata and conversion rules for each new field. The information regarding the new metadata and conversion rules is stored in the metadata mapping table (141) and conversion rules table (142) while the extracted, converted data are stored in the basic financial system table (143) by enterprise. It is worth noting at this point that the activation and operation of bots where all the fields have been mapped to the application database (50) continues. Only bots with unmapped fields “wait” for user input before completing data storage. The new metadata and conversion rule information will be used the next time bots are initialized in accordance with the frequency established by the user (20). In either event, system processing passes on to software block 212.

The software in block 212 checks the system settings table (140) in the application database (50) to determine if the current calculation is a new calculation or a structure change. If the calculation is not a new calculation or a structure change then processing advances to a software block 228. Alternatively, if the calculation is new or a structure change, then processing advances to a software block 221.

The software in block 221 checks the bot date table (149) and deactivates any operation management system data bots with creation dates before the current system date and retrieves information from the system settings table (140), metadata mapping table (141) and conversion rules table (142). The software in block 221 then initializes data bots for each field in the metadata mapping table (141) that mapped to the operation management system database (10) in accordance with the frequency specified by user (20) in the system settings table (140). Each data bot initialized by software block 221 will store its data in the operation system table (144) by enterprise.

After the software in block 221 initializes all the bots for the operation management system database, processing advances to a block 222. In block 222, the bots extract and convert transaction and descriptive data from the operation management system database (10) in accordance with their preprogrammed instructions in accordance with the frequency specified by user (20) in the system settings table (140). As each bot extracts and converts data from the operation management system database (10), processing advances to a software block 209 before the bot completes data storage. The software in block 209 checks the operation management system metadata to see if all fields have been extracted. If the software in block 209 finds no unmapped data fields, then the extracted, converted data are stored in the operation system table (144) by enterprise. Alternatively, if there are fields that have not been extracted, then processing advances to a block 211. The software in block 211 prompts the user (20) via the metadata and conversion rules window (702) to provide metadata and conversion rules for each new field. The information regarding the new metadata and conversion rules is stored in the metadata mapping table (141) and conversion rules table (142) while the extracted, converted data are stored in the operation system table (144) by enterprise. It is worth noting at this point that the activation and operation of bots where all the fields have been mapped to the application database (50) continues. Only bots with unmapped fields “wait” for user input before completing data storage. The new metadata and conversion rule information will be used the next time bots are initialized in accordance with the frequency established by the user (20). In either event, system processing then passes on to a software block 225.

The software in block 225 checks the bot date table (149) and deactivates any web site transaction log data bots with creation dates before the current system date and retrieves information from the system settings table (140), metadata mapping table (141) and conversion rules table (142). The software in block 225 then initializes data bots for each field in the metadata mapping table (141) that mapped to the web site transaction log database (12) by enterprise in accordance with the frequency specified by user (20) in the system settings table (140). Each data bot initialized by software block 225 will store its data in the web log data table (172) by enterprise.

After the software in block 225 initializes all the bots for the web site transaction log database, the bots extract and convert transaction and descriptive data in accordance with their preprogrammed instructions in accordance with the frequency specified by user (20) in the system settings table (140). As each bot extracts and converts data from the web site transaction log database (12), processing advances to a software block 209 before the bot completes data storage. The software in block 209 checks the web site transaction log metadata to see if all fields have been extracted. If the software in block 209 finds no unmapped data fields, then the extracted, converted data are stored in the web log data table (172) by enterprise. Alternatively, if there are fields that have not been extracted, then processing advances to a block 211. The software in block 211 prompts the user (20) via the metadata and conversion rules window (702) to provide metadata and conversion rules for each new field. The information regarding the new metadata and conversion rules is stored in the metadata mapping table (141) and conversion rules table (142) while the extracted, converted data are stored in the web log data table (172) by enterprise. It is worth noting at this point that the activation and operation of bots where all the fields have been mapped to the application database (50) continues. Only bots with unmapped fields “wait” for user input before completing data storage. The new metadata and conversion rule information will be used the next time bots are initialized in accordance with the frequency established by the user (20). In either event, system processing then passes on to a software block 226.

The software in block 226 checks the bot date table (149) and deactivates any human resource information system data bots with creation dates before the current system date and retrieves information from the system settings table (140), metadata mapping table (141) and conversion rules table (142). The software in block 226 then initializes data bots for each field in the metadata mapping table (141) that mapped to the human resource information system database (15) in accordance with the frequency specified by user (20) in the system settings table (140). Each data bot initialized by software block 226 will store its data in the human resource system table (145) by enterprise.

After the software in block 226 initializes all the bots for the human resource information system database, the bots extract and convert transaction and descriptive data in accordance with their preprogrammed instructions in accordance with the frequency specified by user (20) in the system settings table (140) by enterprise. As each bot extracts and converts data from the human resource information system database (15), processing advances to a software block 209 before the bot completes data storage. The software in block 209 checks the human resource information system metadata to see if all fields have been extracted. If the software in block 209 finds no unmapped data fields, then the extracted, converted data are stored in the human resource system table (145) by enterprise. Alternatively, if there are fields that haven't been extracted, then processing advances to a block 211. The software in block 211 prompts the user (20) via the metadata and conversion rules window (702) to provide metadata and conversion rules for each new field. The information regarding the new metadata and conversion rules is stored in the metadata mapping table (141) and conversion rules table (142) while the extracted, converted data are stored in the human resource system table (145) by enterprise. It is worth noting at this point that the activation and operation of bots where all the fields have been mapped to the application database (50) continues. Only bots with unmapped fields “wait” for user input before completing data storage. The new metadata and conversion rule information will be used the next time bots are initialized in accordance with the frequency established by the user (20). In either event, system processing then passes on to software block 228.

The software in block 228 checks the system settings table (140) in the application database (50) to determine if the current calculation is a new calculation or a structure change. If the calculation is not a new calculation or a structure change then processing advances to a software block 248. Alternatively, if the calculation is new or a structure change, then processing advances to a software block 241.

The software in block 241 checks the bot date table (149) and deactivates any external database data bots with creation dates before the current system date and retrieves information from the system settings table (140), metadata mapping table (141) and conversion rules table (142). The software in block 241 then initializes data bots for each field in the metadata mapping table (141) that mapped to the external database (25) in accordance with the frequency specified by user (20) in the system settings table (140). Each data bot initialized by software block 241 will store its data in the external database table (146) by enterprise.

After the software in block 241 initializes all the bots for the external database, processing advances to a block 242. In block 242, the bots extract, convert and assign transaction and descriptive data in accordance with their preprogrammed instructions. As each bot extracts, converts and assigns data from the external database (25), processing advances to a software block 209 before the bot completes data storage and assignments. The software in block 209 checks the external database metadata to see if the extracted data are assigned to specified fields. If the software in block 209 finds no unmapped data, then the extracted, converted data are stored in the external database table (146) by enterprise. Alternatively, if there are fields that do not have metadata assignments, then processing advances to a block 211. The software in block 211 prompts the user (20) via the metadata and conversion rules window (702) to provide metadata, conversion rules and assignments for each new field. The information regarding the new metadata and conversion rules is stored in the metadata mapping table (141) and conversion rules table (142) while the information regarding the new assignments is stored in the external factor definition table (169). While some external factors are pre-defined for analysis, the bulk of the external factors are not pre-assigned and are developed using available data that is assigned to an external factor at the time of extraction. The extracted, converted data with new assignments is then stored in the external database table (146) by enterprise. It is worth noting at this point that the activation and operation of bots where all the fields have been mapped to the application database (50) continues. Only bots with unmapped fields “wait” for user input before completing data storage. The new metadata, conversion rule and classification information will be used the next time bots are initialized in accordance with the frequency established by the user (20). In either event, system processing then passes on to a software block 245.

The software in block 245 checks the bot date table (149) and deactivates any advanced financial system data bots with creation dates before the current system date and retrieves information from the system settings table (140), metadata mapping table (141) and conversion rules table (142). The software in block 245 then initializes data bots for each field in the metadata mapping table (141) that mapped to the advanced financial system database (30) in accordance with the frequency specified by user (20) in the system settings table (140). Each data bot initialized by software block 245 will store its data in the advanced finance system database table (147) by enterprise.

After the software in block 245 initializes all the bots for the advanced finance system database, the bots extract and convert transaction and descriptive data in accordance with their preprogrammed instructions in accordance with the frequency specified by user (20) in the system settings table (140). As each bot extracts and converts data from the advanced financial system database (30) by enterprise, processing advances to a software block 209 before the bot completes data storage. The software in block 209 checks the advanced finance system database metadata to see if all fields have been extracted. If the software in block 209 finds no unmapped data fields, then the extracted, converted data are stored in the advanced finance system database table (147) by enterprise. Alternatively, if there are fields that haven't been extracted, then processing advances to a block 211. The software in block 211 prompts the user (20) via the metadata and conversion rules window (702) to provide metadata and conversion rules for each new field. The information regarding the new metadata and conversion rules is stored in the metadata mapping table (141) and conversion rules table (142) while the extracted, converted data are stored in the advanced finance system database table (147) by enterprise. It is worth noting at this point that the activation and operation of bots where all the fields have been mapped to the application database (50) continues. Only bots with unmapped fields “wait” for user input before completing data storage. The new metadata and conversion rule information will be used the next time bots are initialized in accordance with the frequency established by the user (20). In either event, system processing then passes on to software block 246.

The software in block 246 checks the bot date table (149) and deactivates any asset management system data bots with creation dates before the current system date and retrieves information from the system settings table (140), metadata mapping table (141) and conversion rules table (142). The software in block 246 then initializes data bots for each field in the metadata mapping table (141) that mapped to a asset management system database (35) in accordance with the frequency specified by user (20) in the system settings table (140). Extracting data from each asset management system ensures that the management of each soft asset is considered and prioritized within the overall financial models for the enterprise. Each data bot initialized by software block 246 will store its data in the asset system table (148) by enterprise.

After the software in block 246 initializes bots for all asset management system databases, the bots extract and convert transaction and descriptive data in accordance with their preprogrammed instructions in accordance with the frequency specified by user (20) in the system settings table (140). As each bot extracts and converts data from the asset management system databases (35), processing advances to a software block 209 before the bot completes data storage. The software in block 209 checks the metadata for the asset management system databases to see if all fields have been extracted. If the software in block 209 finds no unmapped data fields, then the extracted, converted data are stored in the asset system table (148) by enterprise. Alternatively, if there are fields that haven't been extracted, then processing advances to a block 211. The software in block 211 prompts the user (20) via the metadata and conversion rules window (702) to provide metadata and conversion rules for each new field. The information regarding the new metadata and conversion rules is stored in the metadata mapping table (141) and conversion rules table (142) while the extracted, converted data are stored in the asset system table (148) by enterprise. It is worth noting at this point that the activation and operation of bots where all the fields have been mapped to the application database (50) continues. Only bots with unmapped fields “wait” for user input before completing data storage. The new metadata and conversion rule information will be used the next time bots are initialized in accordance with the frequency established by the user (20). In either event, system processing then passes on to software block 248.

The software in block 248 checks the system settings table (140) in the application database (50) to determine if the current calculation is a new calculation or a structure change. If the calculation is not a new calculation or a structure change then processing advances to a software block 254. Alternatively, if the calculation is new or a structure change, then processing advances to a software block 251.

The software in block 251 checks the bot date table (149) and deactivates any risk management system data bots with creation dates before the current system date and retrieves information from the system settings table (140), metadata mapping table (141) and conversion rules table (142). The software in block 251 then initializes data bots for each field in the metadata mapping table (141) that mapped to a risk management system database (17) in accordance with the frequency specified by user (20) in the system settings table (140). Each data bot initialized by software block 251 will store its data in the risk system table (176) and/or the derivatives table (175) by enterprise.

After the software in block 251 initializes bots for all risk management system databases for each enterprise, the bots extract and convert transaction and descriptive data in accordance with their preprogrammed instructions in accordance with the frequency specified by user (20) in the system settings table (140) by enterprise. As each bot extracts and converts data from the risk management system databases (17), processing advances to a software block 209 before the bot completes data storage. The software in block 209 checks the metadata for the risk management system database (17) to see if all fields have been extracted. If the software in block 209 finds no unmapped data fields, then the extracted, converted data are stored in the risk system table (176) and/or the derivatives table (175) by enterprise. Alternatively, if there are fields that have not been extracted, then processing advances to a block 211. The software in block 211 prompts the user (20) via the metadata and conversion rules window (702) to provide metadata and conversion rules for each new field. The information regarding the new metadata and conversion rules is stored in the metadata mapping table (141) and conversion rules table (142) while the extracted, converted data are stored in the risk management system table (174) and/or the derivatives table (175) by enterprise. It is worth noting at this point that the activation and operation of bots where all the fields have been mapped to the application database (50) continues. Only bots with unmapped fields “wait” for user input before completing data storage. The new metadata and conversion rule information will be used the next time bots are initialized in accordance with the frequency established by the user (20). In either event, system processing then passes on to software block 252.

The software in block 252 checks the bot date table (149) and deactivates any supply chain system data bots with creation dates before the current system date and retrieves information from the system settings table (140), metadata mapping table (141) and conversion rules table (142). The software in block 252 then initializes data bots for each field in the metadata mapping table (141) that mapped to a project management system database (37) in accordance with the frequency specified by user (20) in the system settings table (140). Each data bot initialized by software block 252 will store its data in the supply chain system table (174) by enterprise.

After the software in block 252 initializes bots for all supply chain system databases, the bots extract and convert transaction and descriptive data in accordance with their preprogrammed instructions in accordance with the frequency specified by user (20) in the system settings table (140). As each bot extracts and converts data from the supply chain system databases (37), processing advances to a software block 209 before the bot completes data storage. The software in block 209 checks the metadata for the project management system database (37) to see if all fields have been extracted. If the software in block 209 finds no unmapped data fields, then the extracted, converted data are stored in the supply chain system table (174) by enterprise. Alternatively, if there are fields that have not been extracted, then processing advances to a block 211. The software in block 211 prompts the user (20) via the metadata and conversion rules window (702) to provide metadata and conversion rules for each new field. The information regarding the new metadata and conversion rules is stored in the metadata mapping table (141) and conversion rules table (142) while the extracted, converted data are stored in the supply chain system table (174) by enterprise. It is worth noting at this point that the activation and operation of bots where all the fields have been mapped to the application database (50) continues. Only bots with unmapped fields “wait” for user input before completing data storage. The new metadata and conversion rule information will be used the next time bots are initialized in accordance with the frequency established by the user (20). In either event, system processing then passes on to software block 254.

The software in block 254 checks the system settings table (140) in the application database (50) to determine if the current calculation is a new calculation or a structure change. If the calculation is not a new calculation or a structure change then processing advances to a software block 276. Alternatively, if the calculation is new or a structure change, then processing advances to a software block 255.

The software in block 255 checks the bot date table (149) and deactivates any financial service provider system data bots with creation dates before the current system date and retrieves information from the system settings table (140), metadata mapping table (141) and conversion rules table (142). The software in block 255 then initializes data bots for each field in the metadata mapping table (141) that mapped to the financial service provider system database (39) in accordance with the frequency specified by user (20) in the system settings table (140). Each data bot initialized by software block 255 will store its data in the financial service provider table (184) by enterprise.

After the software in block 255 initializes all the bots for the financial service provider system database, the bots extract and convert transaction and descriptive data in accordance with their preprogrammed instructions in accordance with the frequency specified by user (20) in the system settings table (140). As each bot extracts and converts data from the financial service provider system database (30) by enterprise, processing advances to a software block 209 before the bot completes data storage. The software in block 209 checks the financial service provider system database metadata to see if all fields have been extracted. If the software in block 209 finds no unmapped data fields, then the extracted, converted data are stored in the financial service provider system database table (184) by enterprise. Alternatively, if there are fields that haven't been extracted, then processing advances to a block 211. The software in block 211 prompts the user (20) via the metadata and conversion rules window (702) to provide metadata and conversion rules for each new field. The information regarding the new metadata and conversion rules is stored in the metadata mapping table (141) and conversion rules table (142) while the extracted, converted data are stored in the financial service provider system database table (184) by enterprise. It is worth noting at this point that the activation and operation of bots where all the fields have been mapped to the application database (50) continues. Only bots with unmapped fields “wait” for user input before completing data storage. The new metadata and conversion rule information will be used the next time bots are initialized in accordance with the frequency established by the user (20). In either event, system processing then passes on to software block 257.

The software in block 257 checks the bot date table (149) and deactivates any Internet text and linkage bots with creation dates before the current system date and retrieves information from the system settings table (140), the metadata mapping table (141) and the keyword table (150). The software in block 257 then initializes Internet text and linkage bots for each field in the metadata mapping table (141) that mapped to a keyword in accordance with the frequency specified by user (20) in the system settings table (140).

Bots are independent components of application software that have specific tasks to perform. In the case of text and linkage bots, their tasks are to locate, count, classify and extract keyword matches and linkages from the Internet and then store their findings as item variables in a specified location. The classification includes both the factor, element, enterprise or industry that the keyword is associated with and the context of the keyword mention. This dual classification allows the system of the present invention to identify both the number of times an enterprise element of value was mentioned and the context in which the enterprise element of value appeared. For example, the system might identify the fact that an enterprise brand was mentioned 367 times in the most recent month and that 63% of the mentions were associated with a favorable semantic map. Each Internet text and linkage bot initialized by software block 257 will store the extracted data and the location, count and classification data it discovers in the classified text table (151) by enterprise. Multimedia data can be processed using these same bots if software to translate and parse the multimedia content is included in each bot. Every Internet text and linkage bot contains the information shown in Table 18.

TABLE 18

| | |
|---|---|
| 1. | Unique ID number (based on date, hour, minute, |
| | second of creation) |
| 2. | Creation date (date, hour, minute, second) |
| 3. | Storage location |
| 4. | Mapping information |
| 5. | Home URL |
| 6. | Organization |
| 7. | Enterprise |
| 8. | Keyword |
| 9. | Element of value, factor, enterprise or industry |
| 10. | Semantic map |

After being initialized, the text and linkage bots locate and classify data from the Internet (40) in accordance with their programmed instructions with the frequency specified by user (20) in the system settings table (140). As each text bot locates and classifies data from the Internet (40) processing advances to a software block 258 before the bot completes data storage. The software in block 258 checks to see if all linkages keyword hits have been classified by element, factor or enterprise. If the software in block 258 does not find any unclassified “hits” or “links”, then the address, counts, dates and classified text are stored in the classified text table (151) by enterprise. Alternatively, if there are hits or links that haven't been classified, then processing advances to a block 259. The software in block 259 prompts the user (20) via the identification and classification rules window (703) to provide classification rules for each new hit or link. The information regarding the new classification rules is stored in the keyword table (150) while the newly classified text and linkages are stored in the classified text table (151) by enterprise. It is worth noting at this point that the activation and operation of bots where all fields map to the application database (50) continues. Only bots with unclassified fields will “wait” for user input before completing data storage. The new classification rules will be used the next time bots are initialized in accordance with the frequency established by the user (20). In either event, system processing then passes on to a software block 263.

The software in block 263 checks the bot date table (149) and deactivates any text bots with creation dates before the current system date and retrieves information from the system settings table (140), the metadata mapping table (141) and the keyword table (150). The software in block 263 then initializes text bots for each field in the metadata mapping table (141) that mapped to a keyword in accordance with the frequency specified by user (20) in the system settings table (140). The text bots use the same classification schema used for Internet text for classifying text found in external and internal databases. Every bot initialized by software block 263 will store the extracted location, count, date and classification of data it discovers as item variables in the classified text table (151) by enterprise. Every text bot contains the information shown in Table 19.

TABLE 19

| | |
|---|---|
| 1. | Unique ID number (based on date, hour, |
| | minute, second of creation) |
| 2. | Creation date (date, hour, minute, second) |
| 3. | Storage location |
| 4. | Mapping information |
| 5. | Organization |
| 6. | Enterprise |
| 7. | Data source |
| 8. | Keyword |
| 9. | Storage location |
| 10. | Element of value, factor, enterprise or industry |
| 11. | Semantic map |

After being initialized, the bots locate data from the external database (25) or the asset management system database (35) in accordance with its programmed instructions with the frequency specified by user (20) in the system settings table (140). As each bot locates and extracts text data, processing advances to a software block 258 before the bot completes data storage. The software in block 258 checks to see if all keyword hits are classified by element, factor, enterprise, industry and semantic map. If the software in block 258 does not find any unclassified “hits”, then the address, count and classified text are stored in the classified text table (151) by enterprise. Alternatively, if there are terms that have not been classified, then processing advances to a block 259. The software in block 259 prompts the user (20) via the identification and classification rules window (703) to provide classification rules for each new term. The information regarding the new classification rules is stored in the keyword table (150) while the newly classified text is stored in the classified text table (151) by enterprise. It is worth noting at this point that the activation and operation of bots with classified data (50) continues. Only bots with unclassified fields “wait” for user input before completing data storage. The new classification rules will be used the next time bots are initialized in accordance with the frequency established by the user (20). In either event, system processing then passes on to software block 264.

The software in block 264 checks the system settings table (140) to see if there is geospatial data in the application database (50) and to determine which on-line geocoding service (Centrus™ from QM Soft or MapMarker™ from MapInfo) is being used. If geospatial data are not being used, then processing advances to a block 269. Alternatively, if the software in block 264 determines that geospatial data are being used, processing advances to a software block 265.

The software in block 265 prompts the user (20) via the geospatial measure definitions window (710) to define the measures that will be used in evaluating the elements of value. After specifying the measures, the user (20) is prompted to select geospatial loci for each measure from the data already stored in the application database (50). The input from the user (20) is stored in the geospatial measures table (152) in the application database before processing advances to a software block 266.

The software in block 266 checks the bot date table (149) and deactivates any geospatial bots with creation dates before the current system date and retrieves information from the system settings table (140), the metadata mapping table (141) and the geospatial measures table (152). The software in block 266 then initializes geospatial bots for each field in the metadata mapping table (141) that mapped to geospatial data in the application database (50) in accordance with the frequency specified by user (20) in the system settings table (140) before advancing processing to a software block 280.

Bots are independent components of application software that have specific tasks to perform. In the case of geospatial bots, their tasks are to calculate item variables using a specified geocoding service, then store the measures in a specified location. Each geospatial bot initialized by software block 266 will store the item variable measures it calculates in the application database table where the geospatial data was found by enterprise. For example, calculated item variables related to customer locations would be stored in the asset management system table (148) for customer data. Tables that are likely to include geospatial data include: the basic financial system table (143), the operation system table (144), the human resource system table (145), the external database table (146), the advanced finance system table (147) and the asset system table (148). Every geospatial bot contains the information shown in Table 20.

TABLE 20

| | |
|---|---|
| 1. | Unique ID number (based on date, hour, minute, second of creation) |
| 2. | Creation date (date, hour, minute, second) |
| 3. | Mapping information |
| 4. | Storage location |
| 5. | Organization |
| 6. | Enterprise |
| 7. | Geospatial locus |
| 8. | Geospatial measure |
| 9. | Geocoding service |

After being activated, the geospatial bots locate data and calculate measurements (which are descriptive item variables) in accordance with their programmed instructions with the frequency specified by the user (20) in the system settings table (140). As each geospatial bot retrieves data and calculates the geospatial measures that have been specified, processing advances to a block 267 before the bot completes data storage. The software in block 267 checks to see if all geospatial data located by the bot have been measured. If the software in block 267 does not find any uncalculated measurement data, then the measurements are stored in the application database (50) by enterprise. Alternatively, if there are data elements where measures have not been calculated, then processing advances to a block 268. The software in block 268 prompts the user (20) via the geospatial measure definition window (710) to provide measurement rules for each new term. The information regarding the new measurement rules is stored in the geospatial measures table (152) while the newly calculated measurements are stored in the appropriate table in the application database (50) by enterprise. It is worth noting at this point that the activation and operation of bots that do not have unmeasured fields continues. Only the bots with uncalculated measurements “wait” for user input before completing data storage. The new measurement rules will be used the next time bots are initialized in accordance with the frequency established by the user (20). In either event, system processing then passes on to a software block 269.

The software in block 269 checks the system settings table (140) to see if semantic mapping is being used. If semantic mapping is not being used, then processing advances to a block 281. Alternatively, if the software in block 269 determines that semantic mapping is being used, processing advances to a software block 270.

The software in block 270 checks the bot date table (149) and deactivates any inference bots with creation dates before the current system date and retrieves information from the system settings table (140), the metadata mapping table (141), the keyword table (150) and the classified text table (151). The software in block 270 then initializes inference bots for each keyword in the metadata mapping table (141) that mapped to the classified text table (151) in the application database (50) in accordance with the frequency specified by user (20) in the system settings table (140).

Bots are independent components of application software that have specific tasks to perform. In the case of inference bots, their task is to use Bayesian inference algorithms to determine the characteristics that give meaning to the text associated with keywords and classified text previously stored in the application database (50). Every inference bot contains the information shown in Table 21.

TABLE 21

| | |
|---|---|
| 1. | Unique ID number (based on date, hour, minute, second of creation) |
| 2. | Creation date (date, hour, minute, second) |
| 3. | Mapping information |
| 4. | Storage location |
| 5. | Organization |
| 6. | Enterprise |
| 7. | Keyword |
| 8. | Classified text mapping information |

After being activated, the inference bots determine the characteristics that give the text meaning in accordance with their programmed instructions with the frequency specified by the user (20) in the system settings table (140). The information defining the characteristics that give the text meaning is stored in the semantic map table (180) in the application database (50) before processing advances to block 272.

The software in block 272 checks the semantic map table (180) to see if there are new semantic maps. If there are no new semantic maps, then processing advances to a block 281. Alternatively, if the software in block 272 determines that there are new semantic maps, then processing returns to software block 255 and the processing described previously for Internet, text and geospatial bots is repeated.

The software in block 281 checks: the basic financial system table (143), the operation system table (144), the human resource system table (145), the external database table (146), the advanced finance system table (147), the asset system table (148), the classified text table (151), the geospatial measures table (152), the supply chain system table (174) and the risk system table (176) to see if data are missing from any of the periods used for system calculation. The software in block 202 previously calculated the range of dates that will be used. If there are no data missing from any period being used, then processing advances to a software block 283. Alternatively, if there are missing data for any field for any period, then processing advances to a block 282.

The software in block 282, prompts the user (20) via the missing data window (704) to specify the method to be used for filling the blanks for each item that is missing data. Options the user (20) can choose from for filling the blanks include: the average value for the item over the entire time period, the average value for the item over a specified period, zero, the average of the preceding item and the following item values and direct user input for each missing item. If the user (20) does not provide input within a specified interval, then the default missing data procedure specified in the system settings table (140) is used. When all the blanks have been filled and stored for all of the missing data, system processing advances to a block 283.

The software in block 283 calculates attributes by item for each numeric item variable in the basic financial system table (143), the operation system table (144), the human resource system table (145), the external database table (146), the advanced finance system table (147), the asset system table (148), the supply chain system table (174) and the risk system table (176). The attributes calculated in this step include: summary data like cumulative total value; ratios like the period to period rate of change in value; trends like the rolling average value, comparisons to a baseline value like change from a prior years level and time lagged values like the time lagged value of each numeric item variable. The software in block 283 calculates similar attributes for the text and geospatial item variables created previously. The software in block 283 calculates attributes for each date item variable in the extracted text data and specified tables (143, 144, 145, 146, 147, 148, 174 and 176) including summary data like time since last occurrence and cumulative time since first occurrence; and trends like average frequency of occurrence and the rolling average frequency of occurrence. The numbers derived from the item variables are collectively referred to as “item performance indicators”. The software in block 283 also calculates pre-specified combinations of variables called composite variables for measuring the strength of the different elements of value. The item performance indicators are stored in the table where the item source data was obtained and the composite variables are stored in the composite variables table (153) before processing advances to a block 284.

The software in block 284 uses attribute derivation algorithms such as the AQ program to create combinations of the variables that were not pre-specified for combination. While the AQ program is used in one embodiment of the present invention, other attribute derivation algorithms, such as the LINUS algorithms, may be used to the same effect. The software creates these attributes using both item variables that were specified as “element” variables and item variables that were not. The resulting composite variables are stored in the composite variables table (153) before processing advances to a block 285.

The software in block 285 derives external factor indicators for each numeric data field defined in the external factor definition table (169). For example, external factors include: the ratio of enterprise earnings to expected earnings, the number and amount of jury awards, commodity prices, the inflation rate, growth in g.d.p., enterprise earnings volatility vs. industry average volatility, short and long term interest rates, increases in interest rates, insider trading direction and levels, industry concentration, consumer confidence and the unemployment rate that have an impact on the market price of the equity for an enterprise and/or an industry. The external factor indicators derived in this step include: summary data like cumulative totals, ratios like the period to period rate of change, trends like the rolling average value, comparisons to a baseline value like change from a prior years price and time lagged data like time lagged earnings forecasts. In a similar fashion the software in block 285 calculates external factors for each date field in the external factor definition table (169) including summary factors like time since last occurrence and cumulative time since first occurrence; and trends like average frequency of occurrence and the rolling average frequency of occurrence. The numbers derived from numeric and date fields are collectively referred to as “factor performance indicators”. The software in block 285 also calculates pre-specified combinations of variables called composite factors for measuring the strength of the different external factors. The external factors, factor performance indicators and the composite factors are stored in the factor variables table (182) before processing advances to a block 286.

The software in block 286 uses attribute derivation algorithms, such as the Linus algorithm, to create combinations of the factors that were not pre-specified for combination. While the Linus algorithm is used in one embodiment of the present invention, other attribute derivation algorithms, such as the AQ program, may be used to the same effect. The software creates these attributes using both external factors that were included in “composite factors” and external factors that were not. The resulting composite variables are stored in the factor variables table (182) before processing advances to a block 287.

The software in block 287 uses pattern-matching algorithms to assign pre-designated data fields for different elements of value to pre-defined groups with numerical values. This type of analysis is useful in classifying purchasing patterns and/or communications patterns as “heavy”, “light”, “moderate” or “sporadic”. This analysis is also be used to classify web site activity and advertising patterns in a similar fashion. The numeric values associated with the classifications are item performance indicators. They are stored in the application database (50) table where the item variables or factor variables they are derived from are located before processing advances to a block 288.

The software in block 288 retrieves data from the metadata mapping table (141) and system settings table (140) in order to create and then stores detailed definitions for the segments of value and the pre-defined components of value for the current operation in the segment definition table (156) by enterprise. As discussed previously, there are up to five segments of value per enterprise—current operation, real options, derivatives, excess financial assets and market sentiment. The current operation is further subdivided into: a revenue component of value that is not divided into sub-components, the expense value that is divided into five sub-components: the cost of raw materials, the cost of manufacture or delivery of service, the cost of selling, the cost of support and the cost of administration and the capital value that is divided into six sub-components: cash, non-cash financial assets, production equipment, other assets, financial liabilities and equity in one embodiment. Different subdivisions of the components of value can be used to the same effect. When data storage is complete, processing advances to a software block 291.

The software in block 291 checks the derivatives table (175) in the application database (50) to see if there are historical values for all the derivatives stored in the table. Because SFAS 133 is still not fully implemented, some companies may not have data regarding the value of their derivatives during a time period where data are being used. If there are values stored for all time periods being used, then processing advances to a software block 302 where the analysis of the extracted data is started. Alternatively, if there are periods when the value of one or more derivatives has not been stored, then processing advances to a software block 292. The software in block 292 retrieves data from the external database table (146), the external factors table and the derivatives table (175) in order to value each derivative using a risk neutral valuation method for the time period or time periods that are missing values. The algorithms used for this analysis can include Quasi Monte Carlo, equivalent Martingale or wavelets. When the calculations are completed, the resulting values are stored in the derivatives table (175) by enterprise and processing advances to a block 293.

The software in block 293 prompts the user (20) via the frame definition window (705) to specify frames for analysis. Frames are sub-sets of each enterprise that can be analyzed at the value driver level separately. For example, the user (20) may wish to examine value and risk by country, by division, by project, by action, by program or by manager. The software in block 293 saves the frame definitions the user (20) specifies in the frame definition table (181) by enterprise in the application database (50) before processing advances to a software block 294.

The software in block 294 retrieves the segment, element of value and factor variables from the: basic financial system (143), human resource system table (145), external database table (146), advanced finance system (147), asset system table (148), keyword table (150), classified text table (151), geospatial measures table (152), composite variables table (153), supply chain system table (174), derivatives table (175), risk system table (176), event risk table (178), financial forecasts table (179) and factor variables table (182) in order to assign frame designations to every element of value and factor variable that was stored in the application database (50) in the prior processing steps in this stage (200) of processing. After storing the revised segment, element of value and factor variables records in the same table they were retrieved from in the application database (50), the software in the block retrieves the definitions from the element of value definition table (155), segment definition table (156) and external factor definition table (169), updates them to reflect the new frame definitions and saves them in the appropriate table before processing advances to a software block 295.

The software in block 295 checks the: basic financial system (143), human resource system table (145), external database table (146), advanced finance system (147), asset system table (148), keyword table (150), classified text table (151), geospatial measures table (152), composite variables table (153), supply chain system table (174), derivatives table (175), risk system table (176), event risk table (178), financial forecasts table (179) and factor variables table (182) to see if there are frame assignments for all segment, element of value and factor variables. If there are frame assignments for all variables, then processing advances to a software block 302 where the analysis of the extracted data is started. Alternatively, if there are variables without frame assignments, then processing advances to a software block 296.

The software in block 296 retrieves variables from the basic financial system (143), human resource system table (145), external database table (146), advanced finance system (147), asset system table (148), keyword table (150), classified text table (151), geospatial measures table (152), composite variables table (153), supply chain system table (174), derivatives table (175), risk system table (176), event risk table (178), financial forecasts table (179) and factor variables table (182) that don't have frame assignments and then prompts the user (20) via the frame assignment window (705) to specify frame assignments for these variables. The software in block 296 saves the frame assignments the user (20) specifies as part of the data record for the variable in the table where the variable was retrieved from by enterprise in the application database (50) before processing advances to software block 302 to begin the value analysis of the extracted data.

### Value Analysis

The flow diagrams in FIG. 6A, FIG. 6B and FIG. 6C detail the processing that is completed by the portion of the application software (300) that continually values the segments of value by enterprise. This portion of the application software (300) also generates a matrix quantifying the impact of elements of value and external factors on the segments of value for each enterprise within each organization (see FIG. 10) by creating and activating analysis bots that:
1) Identify the factor variables, factor performance indicators and composite variables for each external factor that drive: three of the segments of value—current operation, derivatives and excess financial assets—as well as the components of current operation value (revenue, expense and changes in capital);
2) Identify the item variables, item performance indicators and composite variables for each element and sub-element of value that drive: three segments of value—current operation, derivatives and financial assets—as well as the components of current operation value (revenue, expense and changes in capital);
3) Create vectors that summarize the impact of the factor variables, factor performance indicators and composite variables for each external factor;
4) Create vectors that summarize the performance of the item variables, item performance indicators and composite variables for each element of value and sub-element of value in driving segment value;
5) Determine the expected life of each element of value and sub-element of value;
6) Determine the current operation value, excess financial asset value and derivative value, revenue component value, expense component value and capital component value of said current operations using the information prepared in the previous stages of processing;
7) Specify and optimize causal predictive models to determine the relationship between the vectors generated in steps 3 and 4 and the three segments of value, current operation, derivatives and financial assets, as well as the components of current operation value (revenue, expense and changes in capital);
8) Determine the appropriate discount rate on the basis of relative causal element of value strength, value the enterprise real options and contingent liabilities and determine the contribution of each element of value to real option valuation;
9) Determine the best causal indicator for enterprise stock price movement, calculate market sentiment and analyze the causes of market sentiment; and
10) Combine the results of all prior stages of processing to determine the value of each element of value, sub-element of value and factor for each enterprise and each organization.
   Each analysis bot generally normalizes the data being analyzed before processing begins. While the processing in one embodiment includes an analysis of all five segments of value for each organization, it is to be understood that the system of the present invention can complete calculations for any combination of the five segments. For example, when a company is privately held it does not have a market price and as a result the market sentiment segment of value is not analyzed.

Processing in this portion of the application begins in software block 302. The software in block 302 checks the system settings table (140) in the application database (50) to determine if the current calculation is a new calculation or a structure change. If the calculation is not a new calculation or a structure change, then processing advances to a software block 315. Alternatively, if the calculation is new or a structure change, then processing advances to a software block 303.

The software in block 303 retrieves data from the system settings table (140), the meta data mapping table (141), the asset system table (148), the element definition table (155) and the frame definition table (181) and then assigns item variables, item performance indicators and composite variables to each element of value identified in the system settings table (140) using a three-step process. First, item variables, item performance indicators and composite variables are assigned to elements of value based on the asset management system they correspond to (for example, all item variables from a brand management system and all item performance indicators and composite variables derived from brand management system item variables are assigned to the brand element of value). Second, pre-defined composite variables are assigned to the element of value they were assigned to measure in the metadata mapping table (141). Finally, item variables, item performance indicators and composite variables identified by the text and geospatial bots are assigned to elements of value on the basis of their element classifications. If any item variables, item performance indicators or composite variables are un-assigned at this point they are assigned to a going concern element of value. After the assignment of variables and indicators to elements of value is complete, the resulting assignments are saved to the element definition table (155) by enterprise and processing advances to a block 304.

The software in block 304 retrieves data from the meta data mapping table (141), the external factor definition table (169) and the frame definition table (181) and then assigns factor variables, factor performance indicators and composite factors to each external factor. Factor variables, factor performance indicators and composite factors identified by the text and geospatial bots are then assigned to factors on the basis of their factor classifications. The resulting assignments are saved to external factor definition table (169) by enterprise and processing advances to a block 305.

The software in block 305 checks the system settings table (140) in the application database (50) to determine if any of the enterprises in each organization being analyzed have market sentiment segments. If there are market sentiment segments for any enterprise, then processing advances to a block 306. Alternatively, if there are no market prices for equity for any enterprise, then processing advances to a software block 308.

The software in block 306 checks the bot date table (149) and deactivates any market value indicator bots with creation dates before the current system date. The software in block 306 then initializes market value indicator bots in accordance with the frequency specified by the user (20) in the system settings table (140). The bot retrieves the information from the system settings table (140), the metadata mapping table (141) and the external factor definition table (169) before saving the resulting information in the application database (50).

Bots are independent components of application software that have specific tasks to perform. In the case of market value indicator bots their primary task is to identify the best market value indicator (price, relative price, yield, first derivative of price change or second derivative of price change) for the time period being examined. The market value indicator bots select the best value indicator by grouping the S&P 500 using each of the five value indicators with a Kohonen neural network. The resulting clusters are then compared to the known groupings of the S&P 500. The market value indicator that produced the clusters that most closely match the know S&P 500 is selected as the market value indicator. Every market value indicator bot contains the information shown in Table 22.

TABLE 22

| | |
|---|---|
| 1. | Unique ID number (based on date, hour, minute, second of creation) |
| 2. | Creation date (date, hour, minute, second) |
| 3. | Mapping information |
| 4. | Storage location |
| 5. | Organization |
| 6. | Enterprise |

When bot in block 306 have identified and stored the best market value indicator in the external factor definition table (169), processing advances to a block 307.

The software in block 307 checks the bot date table (149) and deactivates any temporal clustering bots with creation dates before the current system date. The software in block 307 then initializes a bot in accordance with the frequency specified by the user (20) in the system settings table (140). The bot retrieves information from the system settings table (140), the metadata mapping table (141) and the external database table (146) and define regimes for the enterprise market value before saving the resulting cluster information in the application database (50).

Bots are independent components of application software that have specific tasks to perform. In the case of temporal clustering bots, their primary task is to segment the market price data by enterprise using the market value indicator selected by the bot in block 306 into distinct time regimes that share similar characteristics. The temporal clustering bot assigns a unique identification (id) number to each “regime” it identifies and stores the unique id numbers in the cluster id table (157). Every time period with data are assigned to one of the regimes. The cluster id for each regime is saved in the data record for each element variable and factor variable in the table where it resides by enterprise. If there are enterprises in each organization that don't have market sentiment calculations, then the time regimes from the primary enterprise specified by the user in the system settings table (140) are used in labeling the data for the other enterprises. After the regimes are identified, the element and factor variables for each enterprise are segmented into a number of regimes less than or equal to the maximum specified by the user (20) in the system settings table (140). The time periods are segmented for each enterprise with a market value using a competitive regression algorithm that identifies an overall, global model before splitting the data and creating new models for the data in each partition. If the error from the two models is greater than the error from the global model, then there is only one regime in the data. Alternatively, if the two models produce lower error than the global model, then a third model is created. If the error from three models is lower than from two models then a fourth model is added. The process continues until adding a new model does not improve accuracy. Other temporal clustering algorithms may be used to the same effect. Every temporal clustering bot contains the information shown in Table 23.

TABLE 23

| | |
|---|---|
| 1. | Unique ID number (based on date, hour, minute, second of creation) |
| 2. | Creation date (date, hour, minute, second) |
| 3. | Mapping information |
| 4. | Storage location |
| 5. | Maximum number of clusters |
| 6. | Organization |
| 7. | Enterprise |

When bots in block 307 have identified and stored regime assignments for all time periods with data by enterprise, processing advances to a software block 308.

The software in block 308 checks the bot date table (149) and deactivates any variable clustering bots with creation dates before the current system date. The software in block 308 then initializes bots for each element of value and external factor by enterprise. The bots: activate in accordance with the frequency specified by the user (20) in the system settings table (140), retrieve the information from the system settings table (140), the metadata mapping table (141), the element definition table (155) and external factor definition table (169) and define segments for the element variables and factor variables before saving the resulting cluster information in the application database (50).

Bots are independent components of application software that have specific tasks to perform. In the case of variable clustering bots, their primary task is to segment the element variables and factor variables into distinct clusters that share similar characteristics. The clustering bot assigns a unique id number to each “cluster” it identifies and stores the unique id numbers in the cluster id table (157). Every item variable for every element of value is assigned to one of the unique clusters. The cluster id for each variable is saved in the data record for each variable in the table where it resides. In a similar fashion, every factor variable for every external factor is assigned to a unique cluster. The cluster id for each variable is saved in the data record for the factor variable. The item variables and factor variables are segmented into a number of clusters less than or equal to the maximum specified by the user (20) in the system settings table (140). The data are segmented using the “default” clustering algorithm the user (20) specified in the system settings table (140). The system of the present invention provides the user (20) with the choice of several clustering algorithms including: an unsupervised “Kohonen” neural network, neural network, decision tree, support vector method, K-nearest neighbor, expectation maximization (EM) and the segmental K-means algorithm. For algorithms that normally require the number of clusters to be specified, the bot will iterate the number of clusters until it finds the cleanest segmentation for the data. Every variable clustering bot contains the information shown in Table 24.

TABLE 24

| | |
|---|---|
| 1. | Unique ID number (based on date, hour, minute, second of |
| | creation) |
| 2. | Creation date (date, hour, minute, second) |
| 3. | Mapping information |
| 4. | Storage location |
| 5. | Element of value, sub element of value or external factor |
| 6. | Clustering algorithm type |
| 7. | Organization |
| 8. | Enterprise |
| 9. | Maximum number of clusters |
| 10. | Variable 1 |
| . . . to | |
| 10 + n. | Variable n |

When bots in block 308 have identified and stored cluster assignments for the variables associated with each element of value, sub-element of value or external factor, processing advances to a software block 309.

The software in block 309 checks the bot date table (149) and deactivates any predictive model bots with creation dates before the current system date. The software in block 309 then retrieves the information from the system settings table (140), the metadata mapping table (141), the element definition table (155), the segment definition table (156) and the external factor definition table (169) as part of the process of initializing predictive model bots for each component of value.

Bots are independent components of application software that have specific tasks to perform. In the case of predictive model bots, their primary task is to determine the relationship between the element and factor variables and the derivative segment of value, the excess financial asset segment of value and the current operation segment of value by enterprise. The predictive model bots also determine the relationship between the element variables and factor variables components of current operation value and sub-components of current operation value by enterprise. Predictive model bots are initialized for each component of value, sub-component of value, derivative segment and excess financial asset segment by enterprise. They are also initialized for each cluster and regime of data in accordance with the cluster and regime assignments specified by the bots in blocks 307 and 308 by enterprise. A series of predictive model bots is initialized at this stage because it is impossible to know in advance which predictive model type will produce the “best” predictive model for the data from each commercial enterprise. The series for each model includes 12 predictive model bot types: neural network; CART; GARCH, projection pursuit regression; generalized additive model (GAM), redundant regression network; rough-set analysis, boosted Naïve Bayes Regression; MARS; linear regression; support vector method and stepwise regression. Additional predictive model types can be used to the same effect. The software in block 309 generates this series of predictive model bots for the enterprise as shown in Table 25.

TABLE 25
Predictive models by enterprise level

Enterprise:
Variables* relationship to enterprise cash flow
(revenue − expense + capital change)
Variables* relationship to enterprise revenue component of value
Variables* relationship to enterprise expense subcomponents of value
Variables* relationship to enterprise capital change
subcomponents of value
Variables* relationship to derivative segment of value
Variables* relationship to excess financial asset segment of value
Variables relationship to market sentiment segment of value
Element of value:
Sub-element of value variables relationship to element of value
*Variables = element and factor variables, item performance indicators.

Every predictive model bot contains the information shown in Table 26.

TABLE 26

| | |
|---|---|
| 1. | Unique ID number (based on date, hour, minute, |
| | second of creation) |
| 2. | Creation date (date, hour, minute, second) |
| 3. | Mapping information |
| 4. | Storage location |
| 5. | Organization |
| 6. | Enterprise |
| 7. | Global or Cluster (ID) and/or Regime (ID) |
| 8. | Segment (Derivative, Excess Financial Asset, Market Sentiment |
| | or Current Operation) |
| 9. | Element of value, sub-element of value or external factor |
| 10. | Predictive Model Type |

After predictive model bots are initialized, the bots activate in accordance with the frequency specified by the user (20) in the system settings table (140). Once activated, the bots retrieve data from the appropriate table in the application database (50) and randomly partition the element or factor variables into a training set and a test set. The software in block 309 uses “bootstrapping” where the different training data sets are created by re-sampling with replacement from the original training set so data records may occur more than once. After the predictive model bots complete their training and testing, processing advances to a block 310.

The software in block 310 determines if clustering improved the accuracy of the predictive models generated by the bots in software block 309 by enterprise. The software in block 310 uses a variable selection algorithm such as stepwise regression (other types of variable selection algorithms can be used) to combine the results from the predictive model bot analyses for each type of analysis—with and without clustering—to determine the best set of variables for each type of analysis. The type of analysis having the smallest amount of error as measured by applying the mean squared error algorithm to the test data is given preference in determining the best set of variables for use in later analysis. There are four possible outcomes from this analysis as shown in Table 27.

TABLE 27

| | |
|---|---|
| 1. | Best model has no clustering |
| 2. | Best model has temporal clustering, no variable clustering |
| 3. | Best model has variable clustering, no temporal clustering |
| 4. | Best model has temporal clustering and variable clustering |

If the software in block 310 determines that clustering improves the accuracy of the predictive models for an enterprise, then processing advances to a software block 313. Alternatively, if clustering does not improve the overall accuracy of the predictive models for an enterprise, then processing advances to a software block 311.

The software in block 311 uses a variable selection algorithm such as stepwise regression (other types of variable selection algorithms can be used) to combine the results from the predictive model bot analyses for each model to determine the best set of variables for each model. The models having the smallest amount of error as measured by applying the mean squared error algorithm to the test data is given preference in determining the best set of variables. As a result of this processing, the best set of variables contain: the item variables, factor variables, item performance indicators, factor performance indications, composite variables and composite factors that correlate most strongly with changes in the three segments being analyzed and the three components of value. The best set of variables will hereinafter be referred to as the “value drivers”. Eliminating low correlation factors from the initial configuration of the vector creation algorithms increases the efficiency of the next stage of system processing. Other error algorithms alone or in combination may be substituted for the mean squared error algorithm. After the best set of variables have been selected and stored in the element variables table (158) or factor variables table (182) for all models at all levels for each enterprise in each organization, the software in block 311 tests the independence of the value drivers at the enterprise, external factor, element of value and sub-element of value level before processing advances to a block 312.

The software in block 312 checks the bot date table (149) and deactivates any causal predictive model bots with creation dates before the current system date. The software in block 312 then retrieves the information from the system settings table (140), the metadata mapping table (141), the segment definition table (156), the element variables table (158) and the factor variables table (182) as part of the process of initializing causal predictive model bots for each element of value, sub-element of value and external factor in accordance with the frequency specified by the user (20) in the system settings table (140).

Bots are independent components of application software that have specific tasks to perform. In the case of causal predictive model bots, their primary task is to refine the element and factor variable selection to reflect only causal variables. (Note: these variables are summed together to value an element of value when they are interdependent). A series of causal predictive model bots are initialized at this stage because it is impossible to know in advance which causal predictive model will produce the “best” vector for the best fit variables from each model. The series for each model includes five causal predictive model bot types: Tetrad, MML, LaGrange, Bayesian and path analysis. The software in block 312 generates this series of causal predictive model bots for each set of variables stored in the element variables table (158) and factor variables table (182) in the previous stage in processing. Every causal predictive model bot activated in this block contains the information shown in Table 28.

TABLE 28

| | |
|---|---|
| 1. | Unique ID number (based on date, hour, minute, second of creation) |
| 2. | Creation date (date, hour, minute, second) |
| 3. | Mapping information |
| 4. | Storage location |
| 5. | Component or subcomponent of value |
| 6. | Element, sub-element of value or external factor |
| 7. | Variable set |
| 8. | Causal predictive model type |
| 9. | Organization |
| 10. | Enterprise |

After the causal predictive model bots are initialized by the software in block 312, the bots activate in accordance with the frequency specified by the user (20) in the system settings table (140). Once activated, they retrieve the relevant information for each model and sub-divide the variables into two sets, one for training and one for testing. After the causal predictive model bots complete their processing for each model, the software in block 312 uses a model selection algorithm to identify the model that best fits the data for each element of value, sub-element of value and external factor being analyzed. For the system of the present invention, a cross validation algorithm is used for model selection. The software in block 312 saves the best fit causal factors in the vector table (159) by enterprise in the application database (50) and processing advances to a block 318.

The software in block 318 tests the value drivers to see if there is interaction between elements, between elements of value and external factors or between external factors by enterprises. The software in this block identifies interaction by evaluating a chosen model based on stochastic-driven pairs of value-driver subsets. If the accuracy of such a model is higher that the accuracy of statistically combined models trained on attribute subsets, then the attributes from subsets are considered to be interacting and then they form an interacting set. If the software in block 318 does not detect any value driver interaction or missing variables for each enterprise, then system processing advances to a block 323. Alternatively, if missing data or value driver interactions across elements of value are detected by the software in block 318 for one or more enterprise, then processing advances to a software block 321.

If software in block 310 determines that clustering improves predictive model accuracy, then processing advances to block 313 as described previously. The software in block 313 uses a variable selection algorithm such as stepwise regression (other types of variable selection algorithms can be used) to combine the results from the predictive model bot analyses for each model, cluster and/or regime to determine the best set of variables for each model. The models having the smallest amount of error as measured by applying the mean squared error algorithm to the test data is given preference in determining the best set of variables. As a result of this processing, the best set of variables contains: the element variables and factor variables that correlate most strongly with changes in the components of value. The best set of variables will hereinafter be referred to as the “value drivers”. Eliminating low correlation factors from the initial configuration of the vector creation algorithms increases the efficiency of the next stage of system processing. Other error algorithms alone or in combination may be substituted for the mean squared error algorithm. After the best set of variables have been selected and stored in the element variables table (158) or the factor variables table (182) for all models at all levels by enterprise, the software in block 313 tests the independence of the value drivers at the enterprise, element, sub-element of value and external factor level before processing advances to a block 314.

The software in block 314 checks the bot date table (149) and deactivates any causal predictive model bots with creation dates before the current system date. The software in block 314 then retrieves the information from the system settings table (140), the metadata mapping table (141), the segment definition table (156), the element variables table (158) and the factor variables table (182) as part of the process of initializing causal predictive model bots for each element of value, sub-element of value and external factor at every level in accordance with the frequency specified by the user (20) in the system settings table (140).

Bots are independent components of application software that have specific tasks to perform. In the case of causal predictive model bots, their primary task is to refine the element and factor variable selection to reflect only causal variables. (Note: these variables are grouped together to represent a single element vector when they are dependent). In some cases it may be possible to skip the correlation step before selecting causal the item variables, factor variables, item performance indicators, factor performance indicators, composite variables and composite factors. A series of causal predictive model bots are initialized at this stage because it is impossible to know in advance which causal predictive model will produce the “best” vector for the best fit variables from each model. The series for each model includes four causal predictive model bot types: Tetrad, LaGrange, Bayesian and path analysis. The software in block 314 generates this series of causal predictive model bots for each set of variables stored in the element variables table (158) in the previous stage in processing. Every causal predictive model bot activated in this block contains the information shown in Table 29.

TABLE 29

| | |
|---|---|
| 1. | Unique ID number (based on date, hour, minute, second of creation) |
| 2. | Creation date (date, hour, minute, second) |
| 3. | Mapping information |
| 4. | Storage location |
| 5. | Component or subcomponent of value |
| 6. | Cluster (ID) and/or Regime (ID) |
| 7. | Element of value, sub-element of value or external factor |
| 8. | Variable set |
| 9. | Organization |
| 10. | Enterprise |
| 11. | Causal predictive model type |

After the causal predictive model bots are initialized by the software in block 314, the bots activate in accordance with the frequency specified by the user (20) in the system settings table (140). Once activated, they retrieve the relevant information for each model and sub-divide the variables into two sets, one for training and one for testing. The same set of training data is used by each of the different types of bots for each model. After the causal predictive model bots complete their processing for each model, the software in block 314 uses a model selection algorithm to identify the model that best fits the data for each element, sub-element of value or external factor being analyzed by model and/or regime by enterprise. For the system of the present invention, a cross validation algorithm is used for model selection. The software in block 314 saves the best fit causal factors in the vector table (159) by enterprise in the application database (50) and processing advances to block 318. The software in block 318 tests the value drivers to see if there are “missing” value drivers that are influencing the results as well as testing to see if there are interactions (dependencies) across elements. If the software in block 318 does not detect any missing data or value driver interactions across elements, then system processing advances to a block 323. Alternatively, if missing data or value driver interactions across elements of value are detected by the software in block 318, then processing advances to a software block 321.

The software in block 321 prompts the user (20) via the structure revision window (710) to adjust the specification(s) for the affected elements of value, sub-elements of value or external factors in order to minimize or eliminate the interaction. At this point the user (20) has the option of specifying that one or more elements of value, sub elements of value and/or external factors be combined for analysis purposes (element of value combinations and/or factor combinations) for each enterprise where there is interaction between elements of value and/or factors. The user (20) also has the option of specifying that the elements of value or external factors that are interacting will be valued by summing the impact of their value drivers. Finally, the user (20) can chose to re-assign a value driver to a new element of value to eliminate the inter-dependency. This is the preferred solution when the inter-dependent value driver is included in the going concern element of value. Elements of value and external factors that will be valued by summing their value drivers will not have vectors generated. After the input from the user (20) is saved in the system settings table (140), the element definition table (155) and the external factor definition table (169) system processing advances to a software block 323. The software in block 323 checks the system settings table (140), the element definition table (155) and/or the external factor definition table (169) to see if there any changes in structure. If there have been changes in the structure, then processing advances to a block 205 and the system processing described previously is repeated. Alternatively, if there are no changes in structure, then processing advances to a block 325.

The software in block 325 analyzes the dynamic relationship between the variables using the method described in cross referenced application Ser. No. 11/094,171 to determine the dynamic relationship that should be used for simulations and analysis. The results of the analysis are stored in the analysis definition table (183) before processing advances to a software block 326.

The software in block 326 checks the bot date table (149) and deactivates any industry rank bots with creation dates before the current system date. The software in block 326 then retrieves the information from the system settings table (140), the metadata mapping table (141), and the vector table (159) as part of the process of initializing industry rank bots for the enterprise and for the industry in accordance with the frequency specified by the user (20) in the system settings table (140).

Bots are independent components of application software that have specific tasks to perform. In the case of industry rank bots, their primary task is to determine the relative position of each enterprise being evaluated on element variables identified in the previous processing step. (Note: these variables are grouped together when they are interdependent). The industry rank bots use ranking algorithms such as Data Envelopment Analysis (hereinafter, DEA) to determine the relative industry ranking of the enterprise being examined. The software in block 326 generates industry rank bots for each enterprise being evaluated. Every industry rank bot activated in this block contains the information shown in Table 30.

TABLE 30

| | |
|---|---|
| 1. | Unique ID number (based on date, hour, minute, second of creation) |
| 2. | Creation date (date, hour, minute, second) |
| 3. | Mapping information |
| 4. | Storage location |
| 5. | Ranking algorithm |
| 6. | Organization |
| 7. | Enterprise |

After the industry rank bots are initialized by the software in block 326, the bots activate in accordance with the frequency specified by the user (20) in the system settings table (140). Once activated, they retrieve the item variables, item performance indicators, and composite variables from the application database (50) and sub-divides them into two sets, one for training and one for testing. After the industry rank bots develop and test their rankings, the software in block 326 saves the industry rankings in the vector table (159) by enterprise in the application database (50) and processing advances to a block 327. The industry rankings are item variables.

The software in block 327 checks the bot date table (149) and deactivates any vector generation bots with creation dates before the current system date. The software in block 327 then initializes bots for each element of value, sub-element of value and external factor for each enterprise in each organization. The bots activate in accordance with the frequency specified by the user (20) in the system settings table (140), retrieve the information from the system settings table (140), the metadata mapping table (141), the segment definition table (156) and the element variables table (158) as part of the process of initializing vector generation bots for each element of value and sub-element of value in accordance with the frequency specified by the user (20) in the system settings table (140).

Bots are independent components of application software that have specific tasks to perform. In the case of vector generation bots, their primary task is to produce formulas, (hereinafter, vectors) that summarize the relationship between the causal element variables or causal factor variables and changes in the component or sub-component of value being examined for each enterprise. The causal element variables may be grouped by element of value, sub-element of value, external factor, factor combination or element of value combination. As discussed previously, the vector generation step is skipped for elements of value and factors where the user has specified that value driver impacts will be mathematically summed to determine the value of the element of value or factor. The vector generation bots use induction algorithms to generate the vectors. Other vector generation algorithms can be used to the same effect. The software in block 327 generates a vector generation bot for each set of variables stored in the element variables table (158) and factor variables table (182). Every vector generation bot contains the information shown in Table 31.

TABLE 31

| | |
|---|---|
| 1. | Unique ID number (based on date, hour, minute, second of creation) |
| 2. | Creation date (date, hour, minute, second) |
| 3. | Mapping information |
| 4. | Storage location |
| 5. | Organization |
| 6. | Enterprise |
| 7. | Element of value, sub-element of value, element of value |
| | combination, factor or factor combination |
| 8. | Component or sub-component of value |
| 9. | Factor 1 |
| . . . to | |
| 9 + n. | Factor n |

When bots in block 327 have identified and stored vectors for all time periods with data for all the elements of value, sub-elements of value, element of value combination, factor combination or external factor where vectors are being calculated in the vector table (159) by enterprise, processing advances to a software block 329.

The software in block 329 checks the bot date table (149) and deactivates any financial factor bots with creation dates before the current system date. The software in block 329 then retrieves the information from the system settings table (140), the metadata mapping table (141), the element definition table (155), the element variables table (158), the external factor definition table (169), the derivatives table (175), the financial forecasts table (179) and the factor variables table (182) as part of the process of initializing causal external factor bots for the enterprise and the relevant industry in accordance with the frequency specified by the user (20) in the system settings table (140).

Bots are independent components of application software that have specific tasks to perform. In the case of financial factor bots, their primary task is to identify elements of value, value drivers and external factors that are causal factors for changes in the value of: derivatives, financial assets, enterprise equity and industry equity. The causal factors for enterprise equity and industry equity are those that drive changes in the value indicator identified by the value indicator bots. A series of financial factor bots are initialized at this stage because it is impossible to know in advance which causal factors will produce the “best” model for every derivative, financial asset, enterprise or industry. The series for each model includes five causal predictive model bot types: Tetrad, LaGrange, MML, Bayesian and path analysis. Other causal predictive models can be used to the same effect. The software in block 329 generates this series of causal predictive model bots for each set of variables stored in the element variables table (158) and factor variables table (182) in the previous stage in processing by enterprise. Every financial factor bot activated in this block contains the information shown in Table 32

TABLE 32

| | |
|---|---|
| 1. | Unique ID number (based on date, hour, minute, second |
| | of creation) |
| 2. | Creation date (date, hour, minute, second) |
| 3. | Mapping information |
| 4. | Storage location |
| 5. | Element, value driver or external factor |
| 6. | Organization |
| 7. | Enterprise |
| 8. | Type: derivatives, financial assets, enterprise equity |
| | or industry equity |
| 9. | Value indicator (price, relative price, first derivative, etc.) for |
| | enterprise and industry only |
| 10. | Causal predictive model type |

After the software in block 329 initializes the financial factor bots, the bots activate in accordance with the frequency specified by the user (20) in the system settings table (140). Once activated, they retrieve the relevant information and sub-divide the data into two sets, one for training and one for testing. The same set of training data is used by each of the different types of bots for each model. After the financial factor bots complete their processing for each segment of value, enterprise and industry, the software in block 329 uses a model selection algorithm to identify the model that best fits the data for each. For the system of the present invention, a cross validation algorithm is used for model selection. The software in block 329 saves the best fit causal factors in the factor variables table (182) by enterprise and the best fit causal elements of value and value drivers in the element variables table (158) by enterprise and processing advances to a block 330. The software in block 330 tests to see if there are “missing” causal factors, elements of value or value drivers that are influencing the results by enterprise. If the software in block 330 does not detect any missing factors, elements of value or value drivers, then system processing advances to a block 331. Alternatively, if missing factors, elements of value or value drivers are detected by the software in block 330, then processing returns to software block 321 and the processing described in the preceding section is repeated.

The software in block 331 checks the bot date table (149) and deactivates any option bots with creation dates before the current system date. The software in block 331 then retrieves the information from the system settings table (140), the metadata mapping table (141), the basic financial system database (143), the external database table (146), the advanced finance system table (147) and the vector table (159) as part of the process of initializing option bots for the enterprise.

Bots are independent components of application software that have specific tasks to perform. In the case of option bots, their primary tasks are to calculate the discount rate to be used for valuing the real options and contingent liabilities and to value the real options and contingent liabilities for the enterprise. If the user (20) has chosen to include industry options, then option bots will be initialized for industry options as well. The discount rate for enterprise real options is calculated by adding risk factors for each causal element of value to a base discount rate. A two step process determines the risk factor for each causal element. The first step in the process divides the maximum real option discount rate (specified by the user in system settings) by the number of causal elements. The second step in the process determines if the enterprise is highly rated on the causal elements of value using ranking algorithms like DEA and determines an appropriate risk factor. If the enterprise is highly ranked on the soft asset, then the discount rate is increased by a relatively small amount for that causal element. Alternatively, if the enterprise has a low ranking on a causal element, then the discount rate is increased by a relatively large amount for that causal element of value as shown below in Table 33. For options that are joint options enabled by the two or more enterprises within each organization, the same general procedure will be used, however, the relative strength of the different enterprises may be substituted for relative causal element of value strength in determining the appropriate discount rate.

TABLE 33
Maximum discount rate = 50%, Causal elements = 5
Maximum risk factor/soft asset = 50%/5 = 10%

| Industry Rank on Soft Asset | | % of Maximum |
|---|---|---|
| 1 | | 0% |
| 2 | | 25% |
| 3 | | 50% |
| 4 | | 75% |
| 5 or higher | | 100% |
| Causal element: | Relative Rank | Risk Factor |
| Brand | 1 | 0% |
| Channel | 3 | 5% |
| Manufacturing Process | 4 | 7.5% |
| Strategic Alliances | 5 | 10% |
| Vendors | 2 | 2.5% |
| Subtotal | | 25% |
| Base Rate | | 12% |
| Discount Rate | | 37% |

The discount rate for industry options is calculated using a traditional total cost of capital approach that includes the cost of risk capital in a manner that is well known. After the appropriate discount rates are determined, the value of each real option and contingent liability is calculated using the specified algorithms in a manner that is well known. The real option can be valued using a number of algorithms including Black Scholes, binomial, neural network or dynamic programming algorithms. The industry option bots use the industry rankings from prior processing block to determine an allocation percentage for industry options. The more dominant the enterprise, as indicated by the industry rank for the element indicators, the greater the allocation of industry real options. Every option bot contains the information shown in Table 34.

TABLE 34

| | |
|---|---|
| 1. | Unique ID number (based on date, hour, minute, second of creation) |
| 2. | Creation date (date, hour, minute, second) |
| 3. | Mapping information |
| 4. | Storage location |
| 5. | Organization |
| 6. | Industry or Enterprise |
| 7. | Real option type (Industry or Enterprise) |
| 8. | Real option algorithm (Black Scholes, Binomial, Quadranomial, |
| | Dynamic Program, etc.) |

After the option bots are initialized, they activate in accordance with the frequency specified by the user (20) in the system settings table (140). After being activated, the bots retrieve information in order to complete the option valuations. When they are used, industry option bots go on to allocate a percentage of the calculated value of industry options to the enterprise on the basis of causal element of value strength. After the value of the real option, contingent liability or allocated industry option is calculated the resulting values are then saved in the real option value table (162) in the application database (50) by enterprise before processing advances to a block 332.

The software in block 332 checks the bot date table (149) and deactivates any cash flow bots with creation dates before the current system date. The software in the block then retrieves the information from the system settings table (140), the metadata mapping table (141), the advanced finance system table (147) and the segment definition table (156) as part of the process of initializing cash flow bots for each enterprise in accordance with the frequency specified by the user (20) in the system settings table (140).

Bots are independent components of application software that have specific tasks to perform. In the case of cash flow bots, their primary tasks are to calculate the cash flow for each enterprise for every time period where data are available and to forecast a steady state cash flow for each enterprise in each organization. Cash flow is calculated using the forecast revenue, expense, capital change and depreciation data retrieved from the advanced finance system table (147) with a well-known formula where cash flow equals period revenue minus period expense plus the period change in capital plus non-cash depreciation/amortization for the period. The steady state cash flow for each enterprise is calculated for the enterprise using forecasting methods identical to those disclosed previously in U.S. Pat. No. 5,615,109 to forecast revenue, expenses, capital changes and depreciation separately before calculating the cash flow. Every cash flow bot contains the information shown in Table 35.

TABLE 35
1. Unique ID number (based on date, hour, minute, second of creation)
2. Creation date (date, hour, minute, second)
3. Mapping information
4. Storage location
5. Organization
6. Enterprise

After the cash flow bots are initialized, the bots activate in accordance with the frequency specified by the user (20) in the system settings table (140). After being activated the bots, retrieve the forecast data for each enterprise from the advanced finance system table (147) and then calculate a steady state cash flow forecast by enterprise. The resulting values by period for each enterprise are then stored in the cash flow table (161) in the application database (50) before processing advances to a block 333.

The software in block 333 checks the system settings table (140) in the application database (50) to determine if the current calculation is a new calculation or a structure change. If the calculation is not a new calculation or a structure change, then processing advances to a software block 341. Alternatively, if the calculation is new or a structure change, then processing advances to a software block 343.

The software in block 341 uses the cash flow by period data from the cash flow table (161) and the calculated requirement for working capital to calculate the value of excess financial assets for every time period by enterprise and stores the results of the calculation in the financial forecasts table (179) in the application database before processing advances to a block 342.

The software in block 342 checks the bot date table (149) and deactivates any financial value bots with creation dates before the current system date. The software in block 342 then retrieves the information from the system settings table (140), the metadata mapping table (141), the element definition table (155), the element variables table (158), the external factor definition table (169), the derivatives table (175) the financial forecasts table (179) and the factor variables table (182) as part of the process of initializing financial value bots for the derivatives and excess financial assets in accordance with the frequency specified by the user (20) in the system settings table (140).

Bots are independent components of application software that have specific tasks to perform. In the case of financial value bots, their primary task is to determine the relative contribution of element data and factor data identified in previous stages of processing on the value of derivatives and excess financial assets by enterprise. The system of the present invention uses 12 different types of predictive models to determine relative contribution: neural network; CART; projection pursuit regression; generalized additive model (GAM); GARCH; MMDR; redundant regression network; boosted Naïve Bayes Regression; the support vector method; MARS; linear regression; and stepwise regression. The model having the smallest amount of error as measured by applying the mean squared error algorithm to the test data is the best fit model. The “relative contribution algorithm” used for completing the analysis varies with the model that was selected as the “best-fit” as described previously. Every financial value bot activated in this block contains the information shown in Table 36.

TABLE 36
1. Unique ID number (based on date, hour, minute, second of creation)
2. Creation date (date, hour, minute, second)
3. Mapping information
4. Storage location
5. Organization
6. Enterprise
7. Derivative or Excess Financial Asset
8. Element Data or Factor Data
9. Predictive model type

After the software in block 342 initializes the financial value bots, the bots activate in accordance with the frequency specified by the user (20) in the system settings table (140). Once activated, they retrieve the relevant information and sub-divide the data into two sets, one for training and one for testing. The same set of training data is used by each of the different types of bots for each model. After the financial bots complete their processing, the software in block 332 saves the calculated value contributions by element of value or external factor for derivatives in the derivatives table (175) by enterprise. The calculated value contributions by element of value or external factor for excess financial assets are then saved in the financial forecasts table (179) by enterprise in the application database (50) and processing advances to a block 343.

The software in block 343 checks the bot date table (149) and deactivates any element life bots with creation dates before the current system date. The software in block 343 then retrieves the information from the system settings table (140), the metadata mapping table (141) and the element definition table (155) as part of the process of initializing element life bots for each element of value and sub-element of value for each enterprise in each organization being analyzed.

Bots are independent components of application software that have specific tasks to perform. In the case of element life bots, their primary task is to determine the expected life of each element of value and sub-element of value. There are three methods for evaluating the expected life of the elements and sub-elements of value. Elements of value that are defined by a population of members or items (such as: channel partners, customers, employees and vendors) will have their lives estimated by analyzing and forecasting the lives of the members of the population. The forecasting of member lives will be determined by the “best” fit solution from competing life estimation methods including the Iowa type survivor curves, Weibull distribution survivor curves, Gompertz-Makeham survivor curves, polynomial equations using the methodology for selecting from competing forecasts disclosed in U.S. Pat. No. 5,615,109. Elements of value (such as some parts of Intellectual Property i.e. patents and insurance contracts) that have legally defined lives will have their lives calculated using the time period between the current date and the expiration date of the element of value or sub-element. Finally, elements of value and sub-element of value (such as brand names, information technology and processes) that may not have defined lives and/or that may not consist of a collection of members will have their lives estimated as a function of the enterprise Competitive Advantage Period (CAP). In the latter case, the estimate will be completed using the element vector trends and the stability of relative element of value strength. More specifically, lives for these element of value types are estimated by
1) subtracting time from the CAP for element of value volatility that exceeds cap volatility; and/or
2) subtracting time for relative element of value strength that is below the leading position and/or relative element of value strength that is declining;
   The resulting values are stored in the element definition table (155) for each element and sub-element of value by enterprise. Every element life bot contains the information shown in Table 37.

TABLE 37
1. Unique ID number (based on date, hour, minute, second of creation)
2. Creation date (date, hour, minute, second)
3. Mapping information
4. Storage location
5. Organization
6. Enterprise
7. Element or sub-element of value
8. Life estimation method (item analysis, date calculation or relative to CAP)

After the element life bots are initialized, they are activated in accordance with the frequency specified by the user (20) in the system settings table (140). After being activated, the bots retrieve information for each element and sub-element of value from the element definition table (155) in order to complete the estimate of element of value life. The resulting values are then saved in the element definition table (155) by enterprise in the application database (50) before processing advances to a block 345.

The software in block 345 checks the system settings table (140) in the application database (50) to determine if the current calculation is a new calculation or a structure change. If the calculation is not a new calculation or a structure change, then processing advances to a software block 402. Alternatively, if the calculation is new or a structure change, then processing advances to a software block 348.

The software in block 348 checks the bot date table (149) and deactivates any component capitalization bots with creation dates before the current system date. The software in block 348 then retrieves the information from the system settings table (140), the metadata mapping table (141) and the segment definition table (156) as part of the process of initializing component capitalization bots for each enterprise in each organization.

Bots are independent components of application software that have specific tasks to perform. In the case of component capitalization bots, their task is to determine the capitalized value of the components and subcomponents of value—forecast revenue, forecast expense or forecast changes in capital for each enterprise in each organization in accordance with the formula shown in Table 38.

TABLE 38
Value = F_{f1}/(1 + K) + F_{f2}/(1 + K)² + F_{f3}/(1+ K)³ + F_{f4}/(1+ K)⁴ + (F_{f4} × (1 + g))/
(1 + K)⁵) + (F_{f4}× (1 + g)²)/(1 + K)⁶) . . . + (F_{f4} × (1 + g)^{N})/(1 + K)^{N+4})
Where:
F_{fx} = Forecast revenue, expense or capital requirements for year x after valuation date (from advanced finance system)
N = Number of years in CAP (from prior calculation)
K = Total average cost of capital − % per year (from prior calculation)
g = Forecast growth rate during CAP − % per year (from advanced financial system)

After the calculation of capitalized value of every component and sub-component of value is complete, the results are stored in the segment definition table (156) by enterprise in the application database (50). Every component capitalization bot contains the information shown in Table 39.

TABLE 39
1. Unique ID number (based on date, hour, minute, second of creation)
2. Creation date (date, hour, minute, second)
3. Mapping information
4. Storage location
5. Organization
6. Enterprise
7. Component of value (revenue, expense or capital change)
8. Sub component of value

After the component capitalization bots are initialized, they activate in accordance with the frequency specified by the user (20) in the system settings table (140). After being activated, the bots retrieve information for each component and sub-component of value from the advanced finance system table (147) and the segment definition table (156) in order to calculate the capitalized value of each component for each enterprise in each organization. The resulting values are then saved in the segment definition table (156) in the application database (50) by enterprise before processing advances to a block 349.

The software in block 349 checks the bot date table (149) and deactivates any current operation bots with creation dates before the current system date. The software in block 349 then retrieves the information from the system settings table (140), the metadata mapping table (141), the element definition table (155), the segment definition table (156), the vector table (159), the external factor definition table (169), the financial forecasts table (179) and the factor variables table (182) as part of the process of initializing valuation bots for each element of value, sub-element of value, combination of elements, value driver and/or external factor for the current operation.

Bots are independent components of application software that have specific tasks to perform. In the case of current operation bots, their task is to calculate the contribution of every element of value, sub-element of value, element of value combination, value driver, external factor and factor combination to the current operation segment of enterprise value. For calculating the current operation portion of element value, the bots use the procedure outlined in Table 5. The first step in completing the calculation in accordance with the procedure outlined in Table 5, is determining the relative contribution of each element, sub-element, combination of elements of value or value driver by using a series of predictive models to find the best fit relationship between:
1. The element of value vectors, element of value combination vectors and external factor vectors, factor combination vectors and value drivers and the enterprise components of value they correspond to; and
2. The sub-element of value vectors and the element of value they correspond to.
   The system of the present invention uses 12 different types of predictive models to identify the best fit relationship: neural network; CART; projection pursuit regression; generalized additive model (GAM); GARCH; MMDR; redundant regression network; boosted Naïve Bayes Regression; the support vector method; MARS; linear regression; and stepwise regression. The model having the smallest amount of error as measured by applying the mean squared error algorithm to the test data is the best fit model. The “relative contribution algorithm” used for completing the analysis varies with the model that was selected as the “best-fit”. For example, if the “best-fit” model is a neural net model, then the portion of revenue attributable to each input vector is determined by the formula shown in Table 40.

TABLE 40
$( {\sum }_{k = 1}^{k = m} {\sum }_{j = 1}^{j = n} {I}_{jk} \times {O}_{k} / {\sum }_{j = 1}^{j = n} {I}_{lk} ) / {\sum }_{k = 1}^{k = m} {\sum }_{j = 1}^{j = n} {I}_{jk} \times {O}_{k}$
Where
Iⱼₖ = Absolute value of the input weight from input node j to hidden node k
Oₖ = Absolute value of output weight from hidden node k
M = number of hidden nodes
N = number of input nodes

After the relative contribution of each element of value, sub-element of value, external factor, element of value combination, factor combination and value driver to the components of current operation value is determined, the results of this analysis are combined with the previously calculated information regarding element of value life and capitalized component value to complete the valuation of each: element of value, sub-element of value, external factor, element of value combination, factor combination and value driver using the approach shown in Table 41.

TABLE 41

| Component Values: | Percentage | Element Life/CAP | Net Value |
|---|---|---|---|
| Revenue value = $120M | 20% | 80% | Value = $19.2M |
| Expense value = ($80M) | 10% | 80% | Value = ($6.4)M |
| Capital value = ($5M) | 5% | 80% | Value = ($0.2)M |
| Total value = $35M | | | |
| Net value for this element: | | | Value = $12.6M |

The resulting values are stored in: the element definition table (155) for each element of value, sub-element of value, element of value combination and value driver by enterprise. For external factor and factor combination value calculations, the external factor percentage is multiplied by the capitalized component value to determine the external factor value. The resulting values for external factors are saved in the external factor definition table (169) by enterprise.

Every current operation bot contains the information shown in Table 42.

TABLE 42
1. Unique ID number (based on date, hour, minute, second of creation)
2. Creation date (date, hour, minute, second)
3. Mapping information
4. Storage location
5. Organization
6. Enterprise
7. Element of value, sub-element of value, factor, element of value
combination, factor combination or value driver
8. Component of value (revenue, expense or capital change)

After the current operation bots are initialized by the software in block 349 they activate in accordance with the frequency specified by the user (20) in the system settings table (140). After being activated, the bots retrieve information and complete the valuation for the segment being analyzed. As described previously, the resulting values are then saved in the element definition table (155) or the external factor definition table (169) in the application database (50) by enterprise before processing advances to a block 350.

The software in block 350 checks the bot date table (149) and deactivates any residual bots with creation dates before the current system date. The software in block 350 then retrieves the information from the system settings table (140), the metadata mapping table (141), the element definition table (155) and the external factor definition table (169) as part of the process of initializing residual bots for the each enterprise in each organization.

Bots are independent components of application software that have specific tasks to perform. In the case of residual bots, their task is to retrieve data from the element definition table (155) the segment definition table (156) and the external factor definition table (169) to calculate the residual going concern value for each enterprise in accordance with the formula shown in Table 43.

TABLE 43
Residual Going Concern Value = Total Current − Operation Value −
Σ Required Financial Asset Values − Σ Elements of value −
Σ External Factors

Every residual bot contains the information shown in Table 44.

TABLE 44
1. Unique ID number (based on date, hour, minute, second of creation)
2. Creation date (date, hour, minute, second)
3. Mapping information
4. Storage location
5. Organization
6. Enterprise

After the residual bots are initialized they activate in accordance with the frequency specified by the user (20) in the system settings table (140). After being activated, the bots retrieve information in order to complete the residual calculation for each enterprise. After the calculation is complete, the resulting values are then saved in the element definition table (155) by enterprise in the application database (50) before processing advances to a software block 351.

The software in block 351 determines the contribution of each element of value to the value of the real option segment of value for each enterprise. For enterprise options, the value of each element of value is determined by comparing the value of the enterprise options to the value that would have been calculated if the element of value had an average level of strength. Elements of value that are relatively strong, reduce the discount rate and increase the value of the option. In a similar fashion, elements of value that are below average in strength increase the discount rate and decrease the value of the option. The value impact can be determined by subtracting the calculated value of the option from the value of the option with the average element. The resulting values are saved in the element definition table (155) by enterprise before processing advances to block 352.

The software in block 352 checks the bot date table (149) and deactivates any sentiment calculation bots with creation dates before the current system date. The software in block 352 then retrieves the information from the system settings table (140), the metadata mapping table (141), the external database table (146), the element definition table (155), the segment definition table (156), the real option value table (162) and the derivatives table (175) as part of the process of initializing sentiment calculation bots for each organization.

Bots are independent components of application software that have specific tasks to perform. In the case of sentiment calculation bots, their task is to retrieve data and then calculate the sentiment for each enterprise in accordance with the formula shown in Table 45.

TABLE 45
Sentiment = Market Value for Enterprise − Current Operation Value −
Σ Real Option Values − Value of Excess Financial Assets −
Σ Derivative Values

Enterprises that are not public corporations will, of course, not have a market value so no calculation will be completed for these enterprises. The sentiment for each organization will be calculated by subtracting the total for each of the five segments of value for all enterprises in each organization from the total market value for all enterprises in each organization. Every sentiment calculation bot contains the information shown in Table 46.

TABLE 46
1. Unique ID number (based on date, hour, minute, second of creation)
2. Creation date (date, hour, minute, second)
3. Mapping information
4. Storage location
5. Organization
6. Enterprise
7. Type: Organization or Enterprise

After the sentiment calculation bots are initialized, they activate in accordance with the frequency specified by the user (20) in the system settings table (140). After being activated, the bots retrieve information from the system settings table (140), the external database table (146), the element definition table (155), the segment definition table (156), the real option value table (162), the derivatives table (175) and the financial forecasts table (179) in order to complete the sentiment calculation for each enterprise and each organization. After the calculation is complete, the resulting values are then saved in the enterprise sentiment table (166) in the application database (50) before processing advances to a block 353.

The software in block 353 checks the bot date table (149) and deactivates any sentiment analysis bots with creation dates before the current system date. The software in block 352 then retrieves the information from the system settings table (140), the metadata mapping table (141), the external database table (146), the industry ranking table (154), the element definition table (155), the segment definition table (156), the real option value table (162), the vector table (159), the enterprise sentiment table (166) and the external factor definition table (169) as part of the process of initializing sentiment analysis bots for the enterprise.

Bots are independent components of application software that have specific tasks to perform. In the case of sentiment analysis bots, their primary task is to determine the composition of the calculated sentiment for each enterprise in each organization and each organization as a whole. One part of this analysis is completed by comparing the portion of overall market value that is driven by the different elements of value as determined by the bots in software block 329 and the calculated valuation impact of each element of value on the segments of value as shown below in Table 47.

TABLE 47
Total Enterprise Market Value = $100 Billion, 10% driven by Brand factors
Implied Brand Value = $100 Billion × 10% = $10 Billion
Brand Element Current Operation Value = $6 Billion
Increase/(Decrease) in Enterprise Real Option Values*
Due to Brand = $1.5 Billion
Increase/(Decrease) in Derivative Values due to Brands = $0.0
Increase/(Decrease) in excess Financial Asset Values
due to Brands = $0.25 Billion
Brand Sentiment = $10 − $6 − $1.5 − $0.0 − $0.25 = $2.25 Billion
*includes allocated industry options when used in the calculation

The sentiment analysis bots also determine the impact of external factors on sentiment. Every sentiment analysis bot contains the information shown in Table 48.

TABLE 48
1. Unique ID number (based on date, hour, minute, second of creation)
2. Creation date (date, hour, minute, second)
3. Mapping information
4. Storage location
5. External factor or element of value
6. Organization
7. Enterprise

After the sentiment analysis bots are initialized, they activate in accordance with the frequency specified by the user (20) in the system settings table (140). After being activated, the bots retrieve information from the system settings table (140), the metadata mapping table (141), the industry ranking table (154), the element definition table (155), the segment definition table (156), the real option value table (162), the enterprise sentiment table (166), the external factor definition table (169), the derivatives table (175) and the financial forecasts table (179) in order to analyze sentiment. The resulting breakdown of sentiment is then saved in the enterprise sentiment table (169) by enterprise in the application database (50). Sentiment at each organization level is calculated by adding together the sentiment calculations for all the enterprises in each organization. The results of this calculation are also saved in the enterprise sentiment table (169) in the application database (50) before processing advances to a software block 402 where the risk analysis for each organization is started.

### Risk Analysis

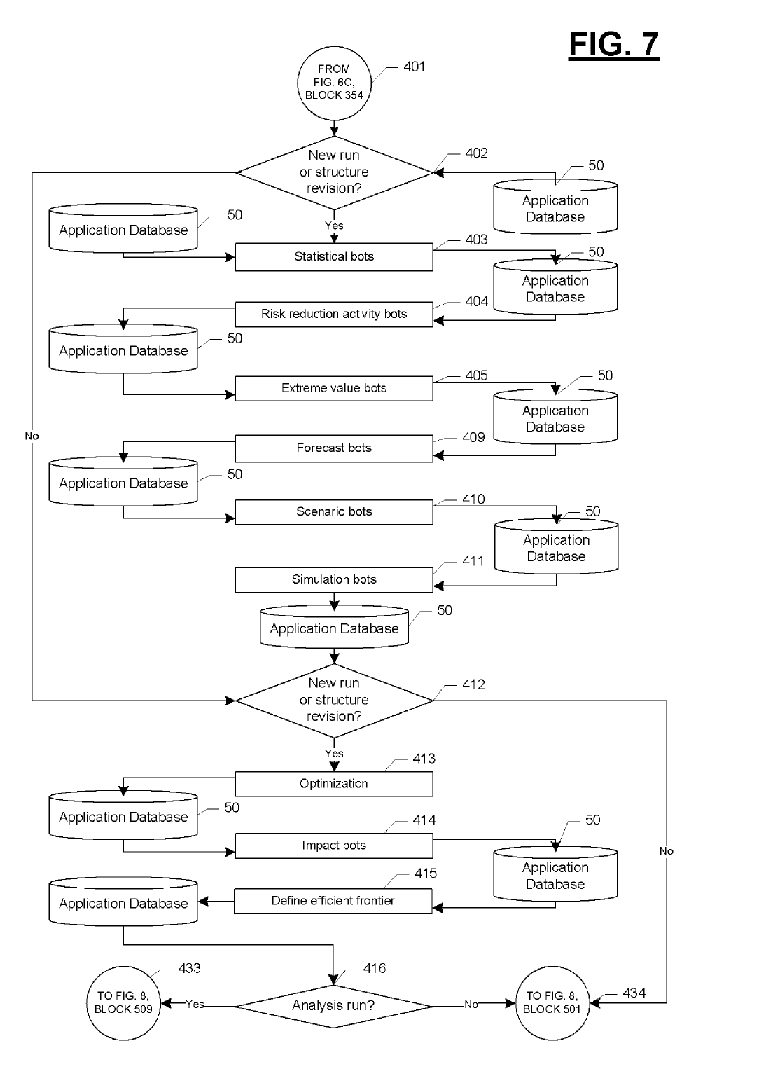

The flow diagram in FIG. 7 details the processing that is completed by the portion of the application software (400) that analyzes and develops the matrix of risk (FIG. 11) for each enterprise in each organization. The matrix of risk includes two types of risk—the risk associated with variability in the elements of value and factors driving enterprise value and the risk associated with events like hurricanes and competitor actions.

System processing in this portion of the application software (400) begins in a block 402. The software in block 402 checks the system settings table (140) in the application database (50) to determine if the current calculation is a new calculation or a structure change. If the calculation is not a new calculation or a structure change, then processing advances to a software block 412. Alternatively, if the calculation is new or a structure change, then processing advances to a software block 403.

The software in block 403 checks the bot date table (149) and deactivates any statistical bots with creation dates before the current system date. The software in block 403 then retrieves the information from the system settings table (140), the external database table (146), the element definition table (155), the element variables table (158) and the factor variables table (182) as part of the process of initializing statistical bots for each causal value driver and external factor.

Bots are independent components of application software that have specific tasks to perform. In the case of statistical bots, their primary tasks are to calculate and store statistics such as mean, median, standard deviation, slope, average period change, maximum period change, variance and covariance for each causal value driver and external factor for all value drivers and external factors. Covariance with the market as a whole is also calculated for each value driver and external factor. Every statistical bot contains the information shown in Table 49.

TABLE 49
1. Unique ID number (based on date, hour, minute, second of creation)
2. Creation date (date, hour, minute, second)
3. Mapping information
4. Storage location
5. Organization
6. Enterprise
7. Element or factor variable

When bots in block 403 have identified and stored statistics for each causal value driver and external factor in the statistics table (170) by enterprise, processing advances to a software block 404.

The software in block 404 checks the bot date table (149) and deactivates any risk reduction activity bots with creation dates before the current system date. The software in block 404 then retrieves the information from the system settings table (140), the external database table (146), the element definition table (155), the element variables table (158), the factor variables table (182) and the statistics table (170) as part of the process of initializing risk reduction activity bots for each causal value driver and external factor.

Bots are independent components of application software that have specific tasks to perform. In the case of risk reduction activity bots, their primary tasks are to identify actions that can be taken by the enterprise to reduce risk. For example, if one customer presents a significant risk to the enterprise, then the risk reduction bot might identify a reduction in the credit line for that customer to reduce the risk. Every risk reduction activity bot contains the information shown in Table 50.

TABLE 50
1. Unique ID number (based on date, hour, minute, second of creation)
2. Creation date (date, hour, minute, second)
3. Mapping information
4. Storage location
5. Organization
6. Enterprise
7. Value driver or external factor

When bots in block 404 have identified and stored risk reduction activities in the risk reduction activity table (165) by enterprise, processing advances to a software block 405.

The software in block 405 checks the bot date table (149) and deactivates any extreme value bots with creation dates before the current system date. The software in block 405 then retrieves the information from the system settings table (140), the external database table (146), the element definition table (155), the element variables table (158) and the factor variables table (182) as part of the process of initializing extreme value bots in accordance with the frequency specified by the user (20) in the system settings table (140).

Bots are independent components of application software that have specific tasks to perform. In the case of extreme value bots, their primary task is to identify the extreme values for each causal value driver and external factor by enterprise. The extreme value bots use the Blocks method and the peak over threshold method to identify extreme values. Other extreme value algorithms can be used to the same effect. Every extreme value bot activated in this block contains the information shown in Table 51.

TABLE 51

1. Unique ID number (based on date, hour, minute, second of creation)
2. Creation date (date, hour, minute, second)
3. Mapping information
4. Storage location
5. Organization
6. Enterprise
7. Method: blocks or peak over threshold
8. Value driver or external factor

After the extreme value bots are initialized, they activate in accordance with the frequency specified by the user (20) in the system settings table (140). Once activated, they retrieve the relevant information and determine the extreme value range for each value driver or external factor. The bot saves the extreme values for each causal value driver and external factor in the statistics table (170) by enterprise in the application database (50) and processing advances to a block 409.

The software in block 409 checks the bot date table (149) and deactivates any forecast bots with creation dates before the current system date. The software in block 405 then retrieves the information from the system settings table (140), the external database table (146), the advanced finance system table (147), the element definition table (155), the element variables table (158), the financial forecasts table (179) and the factor variables table (182) as part of the process of initializing forecast bots in accordance with the frequency specified by the user (20) in the system settings table (140).

Bots are independent components of application software that have specific tasks to perform. In the case of forecast bots, their primary task is to compare the forecasts stored for external factors and financial asset values with the information available from futures exchanges. Every forecast bot activated in this block contains the information shown in Table 52.

TABLE 52

1. Unique ID number (based on date, hour, minute, second of creation)
2. Creation date (date, hour, minute, second)
3. Mapping information
4. Storage location
5. Organization
6. Enterprise
7. External factor or financial asset
8. Forecast time period

After the forecast bots are initialized, they activate in accordance with the frequency specified by the user (20) in the system settings table (140). Once activated, they retrieve the relevant information and determine if any forecasts need to be changed to bring them in line with the market data on future values. The bot saves the updated forecasts in the appropriate tables in the application database (50) by enterprise and processing advances to a block 410.

The software in block 410 checks the bot date table (149) and deactivates any scenario bots with creation dates before the current system date. The software in block 410 then retrieves the information from the system settings table (140), the operation system table (144), the external database table (146), the advanced finance system table (147), the element definition table (155), the external factor definition table (169) and the statistics table (170) as part of the process of initializing scenario bots in accordance with the frequency specified by the user (20) in the system settings table (140).

Bots are independent components of application software that have specific tasks to perform. In the case of scenario bots, their primary task is to identify likely scenarios for the evolution of the causal value drivers and external factors by enterprise. The scenario bots use information from the advanced finance system, external databases and the forecasts completed in the prior stage to obtain forecasts for specific value drivers and factors before using the covariance information stored in the statistics table (170) to develop forecasts for the other causal value drivers and factors under normal conditions. They also use the extreme value information calculated by the previous bots and stored in the statistics table (170) to calculate extreme scenarios. Every scenario bot activated in this block contains the information shown in Table 53.

TABLE 53

1. Unique ID number (based on date, hour, minute, second of creation)
2. Creation date (date, hour, minute, second)
3. Mapping information
4. Storage location
5. Type: normal or extreme
6. Organization
7. Enterprise

After the scenario bots are initialized, they activate in accordance with the frequency specified by the user (20) in the system settings table (140). Once activated, they retrieve the relevant information and develop a variety of scenarios as described previously. After the scenario bots complete their calculations, they save the resulting scenarios in the scenarios table (171) by enterprise in the application database (50) and processing advances to a block 411.

The software in block 411 checks the bot date table (149) and deactivates any simulation bots with creation dates before the current system date. The software in block 410 then retrieves the information from the system settings table (140), the operation system table (144), the advanced finance system table (147), the element definition table (155), the external database table (156), the external factor definition table (169), the statistics table (170), the scenarios table (171) and the generic risk table (178) as part of the process of initializing simulation bots in accordance with the frequency specified by the user (20) in the system settings table (140).

Bots are independent components of application software that have specific tasks to perform. In the case of simulation bots, their primary task is to run three different types of simulations for the enterprise. The simulation bots run simulations of organizational financial performance and valuation using: the two types of scenarios generated by the scenario bots—normal and extreme, they also run an unconstrained genetic algorithm simulation that evolves to the most negative value. In addition to examining the economic factors that were identified in the previous analysis, the bots simulate the impact of event risks like fire, earthquakes, floods and other weather-related phenomena that are largely un-correlated with the economic scenarios. Event risks are as the name implies events that may have adverse financial impacts. They generally have a range of costs associated with each occurrence. For example, every time someone slips and falls in the factor it costs $2,367 for medical bills and lost time. The information on frequency and cost associated with these events is typically found in risk management systems. However, as discussed previously, external databases (25) may also contain information that is useful in evaluating the likelihood and potential damage associated with these risks. Event risks can also be used to project the risk associated with competitor actions, government legislation and market changes. Every simulation bot activated in this block contains the information shown in Table 54.

TABLE 54
1. Unique ID number (based on date, hour, minute, second of creation)
2. Creation date (date, hour, minute, second)
3. Mapping information
4. Storage location
5. Type: normal, extreme or genetic algorithm
6. Risk factors: economic variability or event
7. Segment of value: current operation, real option, investments, derivatives and/or market sentiment
8. Organization
9. Enterprise

After the simulation bots are initialized, they activate in accordance with the frequency specified by the user (20) in the system settings table (140). Once activated, they retrieve the relevant information and simulate the financial performance and value impact of the different scenarios on each segment of value by enterprise. After the simulation bots complete their calculations, the resulting risk forecasts are saved in the simulations table (168) and the xml summary table (177) by enterprise in the application database (50) and processing advances to a block 412.

The software in block 412 checks the system settings table (140) in the application database (50) to determine if the current calculation is a new calculation or a structure change. If the calculation is not a new calculation or a structure change, then processing advances to a software block 502. Alternatively, if the calculation is new or a structure change, then processing advances to a software block 413.

The software in block 413 continually runs an analysis to define the optimal risk reduction strategy for the normal and extreme scenarios for each enterprise in each organization. It starts this process by retrieving data from the system settings table (140), the operation system table (144), the external database table (146), the advanced finance system table (147), the element definition table (155), the external factor definition table (169), the statistics table (170), the scenario table (171), the risk transfer products table (163) and the risk reduction activity table (165) by enterprise. The software in the block determines the optimal mix of risk reduction products (derivative purchase, insurance purchase, etc.) and risk reduction activities (reducing credit limits for certain customers, shifting production from high risk to lower risk countries, etc.) for the company under each scenario given the confidence interval established by the user (20) in the system settings table (140). A multi criteria optimization is also run at this stage to determine the best mix for reducing risk under combined normal and extreme scenarios. A variety of optimization algorithms can be used at this point to achieve the best result. In any event, the resulting product and activity mix for each set of scenarios and the combined analysis is saved in the optimal mix table (175) and the xml summary table (177) in the application database (50) by enterprise and the revised simulations are saved in the simulations table (168) by enterprise before processing passes to a software block 412. The shadow prices from optimizations with linear programs are stored in the risk transfer products table (163) and the xml summary table (177) by enterprise for use in identifying new risk reduction products that the company may wish to purchase and/or new risk reduction activities the company may wish to develop. After the results of this optimization are stored in the application database (50) by enterprise, processing advances to a software block 414.

The software in block 414 checks the bot date table (149) and deactivates any impact bots with creation dates before the current system date. The software in block 413 then retrieves the information from the system settings table (140), the operation system table (144), the external database table (146), the advanced finance system table (147), the element definition table (155), the simulations table (168), the external factor definition table (169), the statistics table (170), the scenario table (171) and the optimal mix table (175) as part of the process of initializing value impact bots in accordance with the frequency specified by the user (20) in the system settings table (140).

Bots are independent components of application software that have specific tasks to perform. In the case of impact bots, their primary task is to determine the value impact of each risk reduction product and activity—those included in the optimal mix and those that are not—on the different scenarios by enterprise. Every impact bot contains the information shown in Table 55.

TABLE 55

1. Unique ID number (based on date, hour, minute, second of creation)
2. Creation date (date, hour, minute, second)
3. Mapping information
4. Storage location
5. Organization
6. Enterprise
7. Risk reduction product or activity

After the software in block 414 initializes the value impact bots, they activate in accordance with the frequency specified by the user (20) in the system settings table (140). After being activated, the bots retrieve information in order to revise the simulations of enterprise performance and determine the risk reduction impact of each product on each simulation. The resulting forecast of value impacts are then saved in the risk transfer products table (163) or the risk reduction activity table (165) by enterprise as appropriate in the application database (50) before processing advances to a block 415.

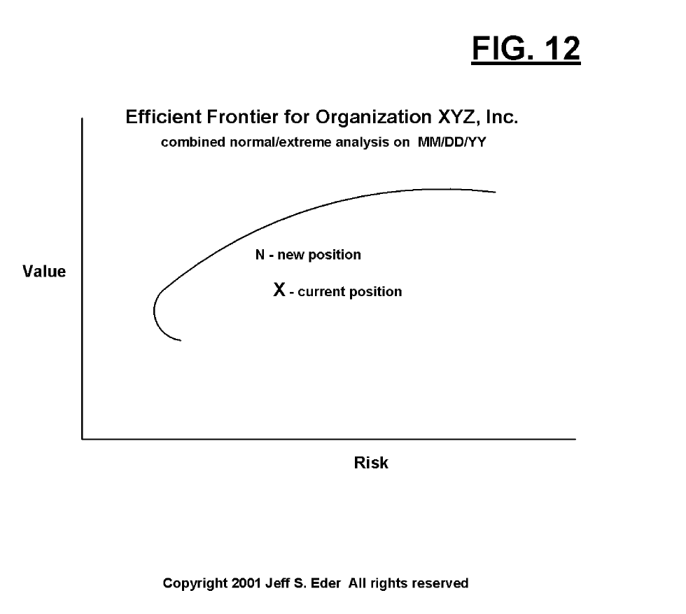

The software in block 415 continually identifies the changes in operation required to achieve maximum enterprise value for each of the minimum risk strategies (normal, extreme and combined scenarios) defined in the previous section. The software in the block starts this process by retrieving data from the system settings table (140), the operation system table (144), the external database table (146), the advanced finance system table (147), the element definition table (155), the risk reduction activity table (165), the external factor definition table (169), the statistics table (170), the scenario table (171), the risk transfer products table (163), the financial forecasts table (179), the factor variables table (182) and the analysis definition table (183) in order to define and initialize a probabilistic simulation model for each scenario. One embodiment of the probabilistic simulation model is a Markov Chain Monte Carlo model, however, other simulation models can be used with similar results. The model for each risk scenario is optimized using an optimization algorithm to identify the maximum enterprise value given the scenario risk profile. After the point of maximum value and minimum risk is identified for each scenario, the enterprise risk levels are increased and reduced in small increments and the optimization process is repeated until the efficient frontier for each scenario has been defined. The baseline efficient frontier is based on the scenario that combined normal and extreme risk scenarios, however the results of all 3 sets of calculations (normal, extreme and combined) are saved in the report table (164) in sufficient detail to generate a chart like the one shown in FIG. 12 before processing advances to a block 416. These changes in operation required to achieve the baseline efficient frontier value and risk are optionally communicated to organization systems in an automated fashion for implementation.

The software in block 416 checks the analysis definition table (183) in the application database (50) to determine if the current calculation a structure change analysis. If the calculation is not a structure change analysis, then processing advances to a software block 502. Alternatively, if the calculation is a structure change analysis, then processing advances to a software block 510.

### Analysis & Reporting

The flow diagram in FIG. 8 details the processing that is completed by the portion of the application software (500) that generates the matrices of value and risk for each organization, generates a summary of the value, risk and liquidity for each organization, analyzes changes in organization structure and operation and optionally displays and prints management reports detailing the value matrix, risk matrix and the efficient frontier. Processing in this portion of the application starts in software block 502.

The software in block 502 retrieves information from the system settings table (140), the advanced finance system table the cash flow table (161) and the financial forecasts table (179) that is required to calculate the minimum amount of working capital that will be available during the forecast time period. The system settings table (140) contains the minimum amount of working capital that the user (20) indicated was required for enterprise operation while the cash flow table (161) contains a forecast of the cash flow of the enterprise for each period during the forecast time period (generally the next 36 months). A summary of the available cash and cash deficits by currency, by month, for the next 36 months is stored in a summary xml format in the xml summary table (177) by enterprise during this stage of processing. After the amount of available cash for each enterprise and each organization is calculated and stored in the risk reduction activity table (165), processing advances to a software block 503.

The software in block 503 retrieves information from the element definition table (155), segment definition table (156), element variables table (158), real option value table (162), risk reduction activity table (165), enterprise sentiment table (166), external factor definition table (169), derivatives table (175), xml summary table (177), financial forecasts table (179) and factor variables table (182) in order to generate the matrix of value (FIG. 10) and the matrix of risk (FIG. 11) by enterprise for each organization. The matrices are stored in the report table (164) and a summary version of the data is added to the xml summary table (177). The software in this block also creates and displays a summary Value Map™ Report for each organization via the report display and selection window (706). After the user (20) indicates that his or her review of the summary report is complete, processing advances to a block 505.

The software in block 505 prompts the user (20) via the analysis definition window (709) to specify aspects of organization performance that should be analyzed. The user (20) is given the option of: re-defining the structure for analysis purposes, examining the impact of changes in segments of value, components of value, elements of value and/or external factors on organization value and risk and/or optimizing a subset of each organization such as a segment of value, a component of value or a frame. For example, the user (20) may wish to:
1. redefine the efficient frontier without considering the impact of market sentiment on organization value—this analysis would be completed by temporarily re-defining the structure and completing a new analysis;
2. redefine the efficient frontier after adding in the matrix of value and risk for another enterprise that may be purchased—this analysis would be completed by temporarily re-defining the structure and completing a new analysis;
3. forecast the likely impact of a project on organization value and risk—this analysis would be completed by mapping the expected results of the project to organization segments of value, components of value, elements of value and/or external factors, recalculating value, liquidity and risk and then determining if each organization would be closer to or further from the efficient frontier if the project were implemented—this analysis could also be used to optimized the feature set included in one or more projects;
4. forecast the likely impact of a process on organization value and risk—this analysis would be completed by mapping the expected results of the process to organization segments of value, components of value, elements of value and/or external factors, recalculating value, liquidity and risk and then determining if each organization would be closer to or further from the efficient frontier if the process were implemented—this analysis could also be used to optimized the feature set included in one or more processes;
5. forecast the impact of changing economic conditions on each organizations ability to repay its debt—this analysis would be completed by mapping the expected changes to organization, recalculating value, liquidity and risk and then determining if each organization will in a better position to repay its debt;
6. use the method described in cross referenced application Ser. No. 11/094,171 to identify the expected sustainable longevity of the organization employees and estimate the resulting pension liability, this information can be used on a stand alone basis or combined with other information to forecast future organization value and/or risk,
7. use the method described in cross referenced application Ser. No. 10/012,375 to identify an optimal project configuration,
8. use the method described in cross referenced application Ser. No. 10/025,794 to identify an optimal process configuration,
9. use the method described in cross referenced application Ser. No. 10/166,758 to identify an optimal set of changes for managing any subset of the organization performance (including purchasing activity), or
10. maximize revenue from all enterprises in each organization—this analysis would be completed by defining a new model, the impact on each organization could be determined by using the output from the optimization to complete an analysis similar to the one described in item 3.
   The software in block 505 saves the analysis definitions the user (20) specifies in the analysis definition table (183) in the application database (50) before processing advances to a software block 506. The user (20) also uses this window to indicate that the information on organization financial performance can be used to develop a customized risk transfer program, customized risk transfer products, a comprehensive risk management program and/or securities. The information regarding product development is also saved in the analysis definition table (183) in the application database (50) before processing advances to software block 506.

The software in block 506 checks the analysis definition table (183) in the application database (50) to determine if the user (20) has specified a structure change analysis. If the calculation is a structure change analysis, then processing returns to block 205 and the processing described previously is repeated. Alternatively, if the calculation is not a structure change analysis, then processing advances to a software block 508.

The software in block 508 retrieves information from the xml summary table (177) and the analysis definition table (183) in order to determine what type of analysis will be completed and define a model for analysis. As mentioned previously, there are two types of analysis that may be completed by the software in this block—analyzing the impact of forecast changes and optimizing a subset of each organization. Analyzing the impact of changes to future values of external factors, segments of value, components of value, value drivers and/or elements of value requires recalculating value and risk for the affected portions of organization value and/or risk by enterprise and comparing the new totals for each organization to the value, risk and efficient frontier information stored in the xml summary table (177). The results of this comparison, including the information required to generate a graph like the one shown in FIG. 12 are then stored in the analysis definition table (183) before processing advances to software block 510. Alternatively, if the analysis involves optimizing a subset of each organization then the software in block 508 defines and initializes a probabilistic simulation model for the subset of each organization that is being analyzed. One embodiment of the probabilistic simulation models are Markov Chain Monte Carlo models, however, other simulation models such as genetic algorithms can be used with similar results. The model is defined using the information retrieved from the xml summary table (177) and the analysis definition table (183) and then iterated in order to ensure the convergence of the frequency distribution of the output variables. After the calculation has been completed, the software in block 508 saves the resulting information in the analysis definition table (183) before processing advances to a software block 510.

The software in block 510 checks the analysis definition table to see if the user (20) has indicated that the information on organization financial performance developed by the system of the present invention can be used for product development. If it will be used for product development, then processing advances to a software block 602. If the information won't be used for developing products, then process advances to a software block 513.

The software in block 513 displays the results of any analyses with the report display and selection window (706) to the user (20). The user (20) optionally selects reports for display and/or printing. The format of the reports is either graphical, numeric or both depending on the type of report the user (20) specified in the system settings table (140). A typical format for a graphical report displaying the efficient frontier is shown in FIG. 12. If the user (20) selects any reports for printing, then the information regarding the selected reports is saved in the reports table (164). After the user (20) has finished selecting reports, the selected reports are displayed to the user (20). After the user (20) indicates that the review of the reports has been completed, processing advances to a software block 514.

The software in block 514 checks the reports tables (164) to determine if any reports have been designated for printing. If reports have been designated for printing, then processing advances to a block 515. It should be noted that in addition to standard reports like the matrix of value, the matrix of risk, Value Map™ reports and the graphical depictions of the efficient frontier shown in FIG. 12. The system of the present invention can generate reports that rank the elements, external factors and/or the risks in order of their importance to overall value and risk. The system can also produce “metrics” reports by tracing the historical measures for value drivers over time. The software in block 515 sends the designated reports to the printer (118). After the reports have been sent to the printer (118), processing advances to a software block 517. Alternatively, if no reports were designated for printing, then processing advances directly from block 514 to block 517.

The software in block 517 checks the system settings table (140) to determine if the system is operating in a continuous run mode. If the system is operating in a continuous run mode, then processing returns to block 205 and the processing described previously is repeated in accordance with the frequency specified by the user (20) in the system settings table (140). Alternatively, if the system is not running in continuous mode, then the processing advances to a block 518 where the system stops.

### Development & Sale

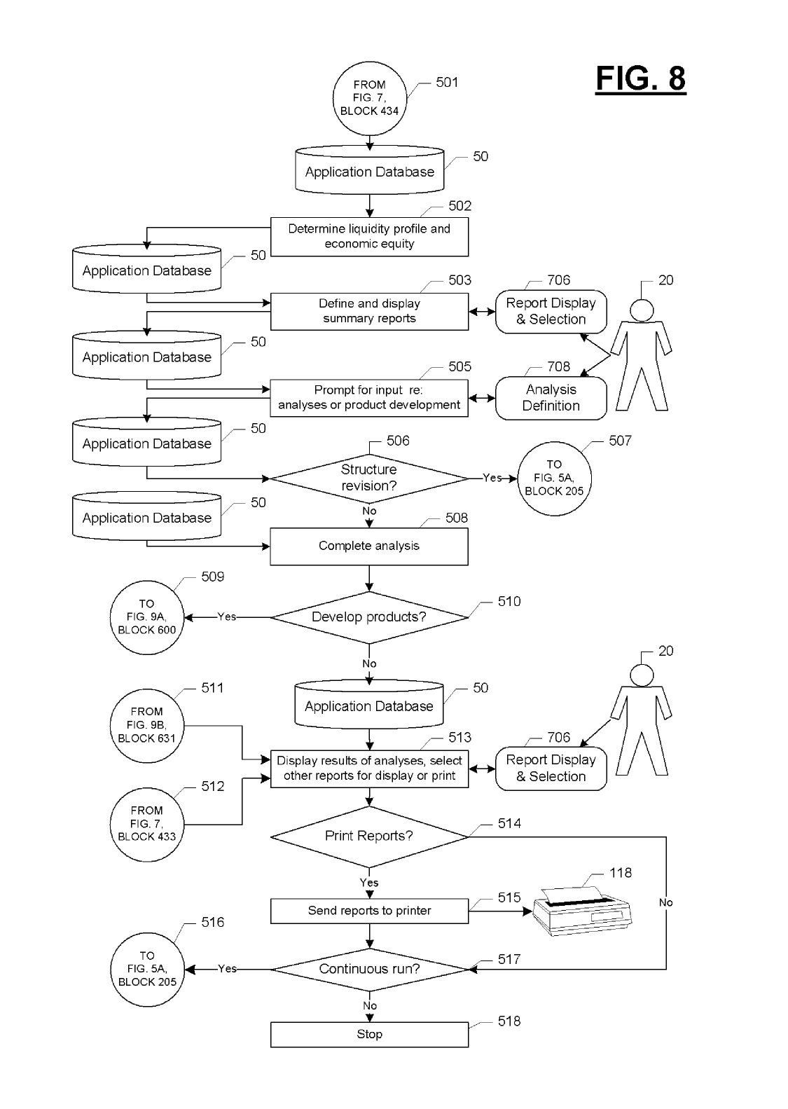

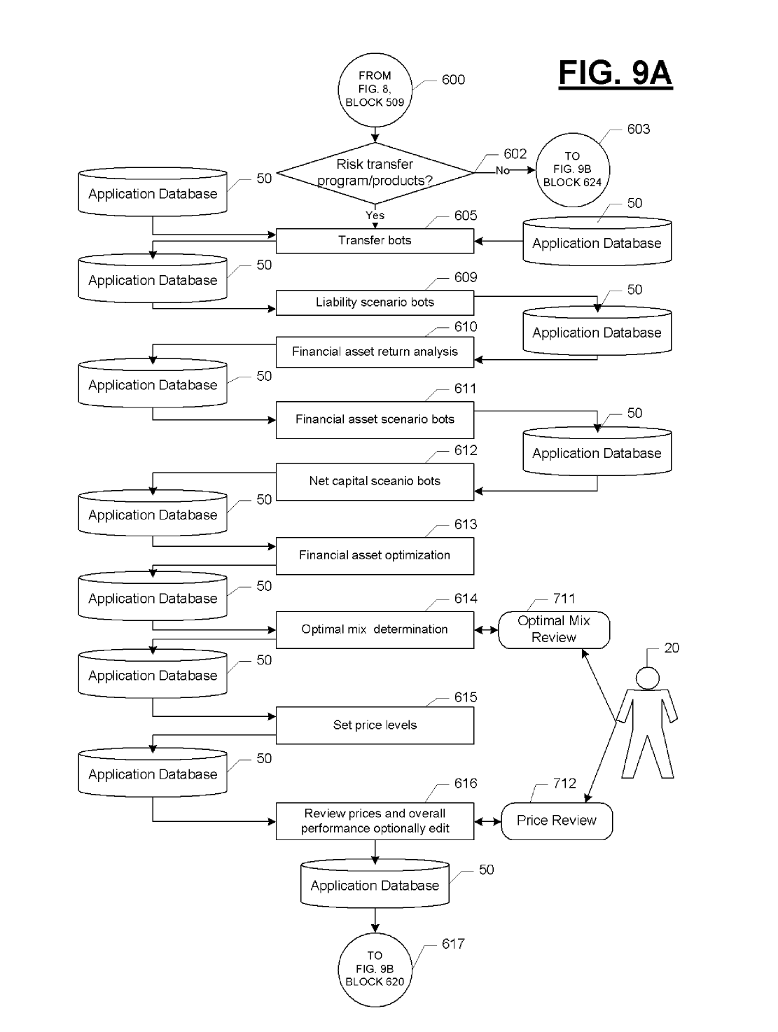

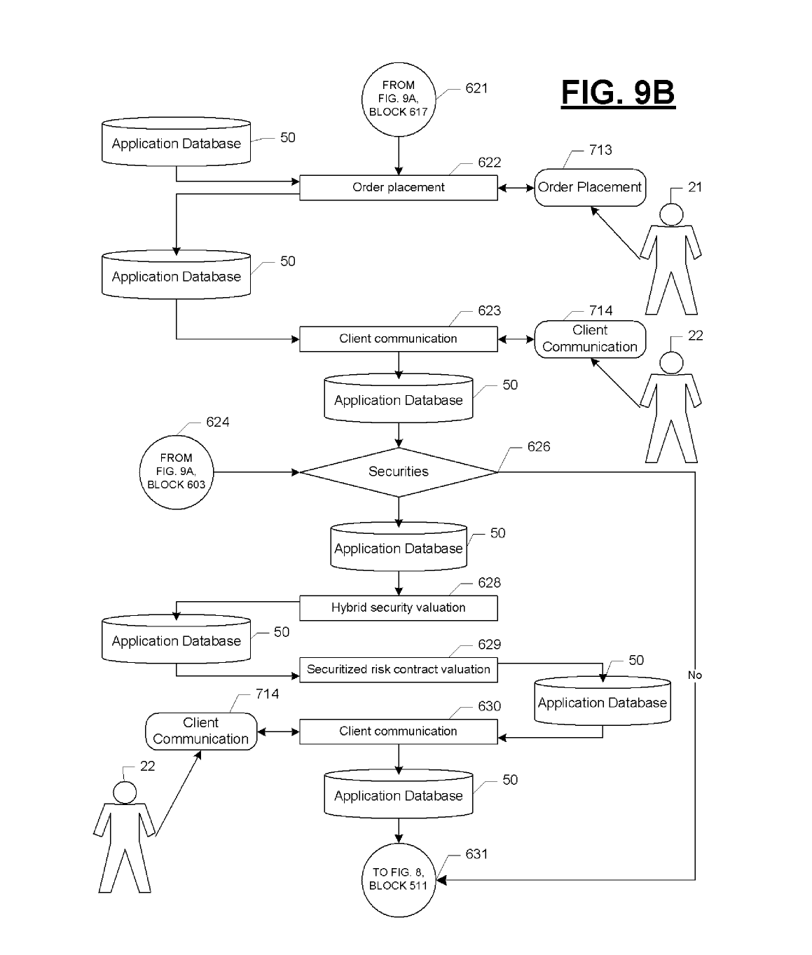

The flow diagram in FIG. 9A and FIG. 9B details the processing that is completed by the portion of the application software (600) that uses the previously developed organization information to complete the automated development and sale of risk transfer products, securitized risk contracts and/or hybrid securities.

Client risk transfer can be completed using a variety of customized and standard products including swaps, swap streams and/or risk transfer products (insurance, derivatives, etc.). Swap streams are long term swaps of fixed percentages of specific risks. These innovative products are uniquely enabled by system of the present invention as the system can use the steady stream of information it receives from client organizations to update the terms of the swap stream transaction to account for changes in forecast. The risk transfer products developed by the system of the present invention can be customized to the exact requirements of each client organization.

System processing in this portion of the application software (600) begins in a block 602. The software in block 602 check the analysis definition table (183) to see what kind of products are going to be developed using the information developed by the system of the present invention. If the information is not going to be used to develop customized risk transfer products and/or a customized risk transfer program, then processing advances to a software block 626. Alternatively, if customized risk transfer products and/or a customized risk transfer program are going to be developed, then processing advances to a software block 605.

The software in block 605 checks the bot date table (149) in the application database (50) and deactivates any transfer bots with creation dates before the current system date. The software in block 605 then retrieves the information from the system settings table (140), the scenarios table (145), the external database table (146), the risk transfer products table (163), the risk reduction activity table (165) and the xml summary table (177) in order to initialize transfer bots for each organization being analyzed.

Bots are independent components of application software that have specific tasks to perform. In the case of transfer bots, their primary task is to identify swaps, swap streams, existing products and new products that can to satisfy the risk transfer needs of the organizations being analyzed. Transfer bots also identify any changes required to existing swap streams and enter these changes as new swaps. For example, if a client company has a significant risk from oil prices dropping (a heating oil company, for example) and another client company faces a significant risk when oil prices rise (a trucking company, for example), then the transfer bot will identify the offsetting risk factors by noting they share a common external factor composite variable or vector as a value driver (and consequently as a driver of risk) and, if both companies have authorized the operator to make trades, set a price relative to the external factor index that evenly splits the forecast risk before recording a swap at that price. The identified vector or composite variable may also be used to establish a published index for the associated risk. The published index would in turn enable the trading of securitized risk contracts based on the associated risk. Swaps that need approval are also recorded, however they are not executed until one or both parties provide their required approval. If a risk transfer can be completed by both an existing risk transfer product and a swap, then preference is given to the swap. Every transfer bot contains the information shown in Table 56.

```
TABLE 56
  1. Unique ID number (based on date, hour, minute, second of creation)
  2. Creation date (date, hour, minute, second)
  3. Mapping information
  4. Storage location
  5. Risk factor
  6. Type: fixed quantity swap, swap stream, existing product or new product
  7. Amount(s)
  8. Date(s)
  9. Organization 1 (for fixed quantity swaps and swap streams only)
  . . . to
  9 + n. Organization n (for fixed quantity swaps and swap streams only)
10. Financial service provider
```

After the transfer bot identifies the fixed quantity swaps, swap streams, existing products and new products that will satisfy the needs of each organization for risk transfer, the results are saved to the risk transfer products (163). Information on new products is saved in the risk transfer products table (163) without a price. The price for new products will be established later in system processing. After data storage is complete, processing advances to a software block 609.

The software in block 609 checks the bot date table (149) and deactivates any liability scenario bots with creation dates before the current system date. The software in block 609 then retrieves the information from the system settings table (140), the external the scenarios table (145), the external database table (146), the risk transfer products table (163), the risk reduction activity table (165), the scenarios table (171), the xml summary table (177) and the financial service provider table (184) in order to initialize new liability scenario bots.

Bots are independent components of application software that have specific tasks to perform. In the case of liability scenario bots, their primary tasks are to create a series of scenarios estimating the net premium, where net premium equals total premiums minus total payouts, associated the risks transferred via swaps and/or risk transfer products from all organization. As with the prior analysis at the organization level, there are two types of scenarios developed at this stage of processing, normal scenarios and extreme scenarios. The scenarios are developed by combining the information and statistics retrieved from the application database (50). As part of the scenario development, the break even price for new products is developed and the premium for new products is set to equal the break even price for purposes of this analysis. Every liability scenario bot activated in this block contains the information shown in Table 57.

TABLE 57

1. Unique ID number (based on date, hour, minute, second of creation)
2. Creation date (date, hour, minute, second)
3. Mapping information
4. Storage location
5. Type: Extreme or Normal
6. Products: fixed quantity swap, swap stream, existing product and/
or new product
7. Organization transferring risk
8. Financial service provider

After the liability scenario bots are initialized, they generate a series of net premium scenarios that are appropriate for the type of analysis being completed—extreme or normal for each product and the financial service provider as a whole. The bot saves the scenarios in the scenarios table (171) in the application database (50) and processing advances to a block 610.

The software in block 610 continually completes analyses similar to those completed by the systems in cross-referenced application Ser. No. 10/747,471 filed Nov. 28, 2001, and U.S. Pat. No. 5,615,109 for “Method of and System for Generating Feasible, Profit Maximizing Requisition Sets” for equity investments the company may have made. More specifically, the software in this block uses the publicly available information stored in the external database table (146) to complete the analyses shown in Table 58 for each equity investment company listed in the financial asset position table (154) and described in data obtained from the external database (25).

```
TABLE 58
1. Identify the best indicator for equity price analysis;
2. Identify external factors causing changes in the equity market price;
3. Forecast the value of the current operation for the equity investment company based on past
  performance;
4. Forecast the value of the derivative position for the equity investment company based on past
  performance and future external factor forecasts;
5. Forecast the value of the equity based on the forecast current operation value, forecast derivative
  position, forecast of external factors; and
6. Forecast the income (dividends) provided by the equity as a function of the causal factors identified in 1
  and prior performance
```

The results of these calculations are saved in the simulations table (168) in the application database (50). The software in this block uses the publicly available information stored in the external database table (146) to complete the analyses shown in Table 59 for each income generating investments (i.e. bonds or real estate) listed in the financial asset position table (154) and described in data obtained from the external database (25).

```
TABLE 59
1. Identify the external factors and investment performance factors causing changes in the market price of
  the investment
2. Forecast the income provided by the investment as a function of the causal factors identified in 1 and
  prior performance
```

The results of the forecast are saved in the simulations table (168) in the application database (50). The software in block 610 then analyzes the covariance between the causal factors for each of the financial assets to determine the covariance between these financial assets under both normal and extreme conditions. The results of these analyses are also stored in the simulations table (168) before processing advances to a block 611.

The software in block 611 checks the bot date table (149) and deactivates any financial asset scenario bots with creation dates before the current system date (please note: financial assets correspond to the investment and derivative segments of value defined previously). The software in block 611 then retrieves the information from the external database table (146), the simulations table (168), the scenarios table (171) and the xml summary table (177) in order to initialize the financial asset scenario bots.

Bots are independent components of application software that have specific tasks to perform. In the case of financial asset scenario bots, their primary task is to identify likely scenarios for the evolution of the causal market value factors for financial assets. The financial asset scenario bots use information from the external databases to obtain forecasts for individual causal factors before using the covariance information stored in the simulations table (168) to develop scenarios for the other causal factors under normal and extreme conditions. When the causal factors for financial assets are the same as causal factors for liabilities, the previously generated liability scenarios are used. Every scenario bot activated in this block contains the information shown in Table 60.

TABLE 60

1. Unique ID number (based on date, hour, minute, second of creation)
2. Creation date (date, hour, minute, second)
3. Mapping information
4. Storage location
5. Type: Normal or Extreme
6. Organizations transferring risk
7. Financial service provider

After the financial asset scenario bots are initialized, they retrieve the required information and develop a variety of normal and extreme scenarios as described previously. After the scenario bots complete their calculations they save the resulting scenarios in the scenario table (171) in the application database (50) and processing advances to a block 612.

The software in block 612 checks the bot date table (149) and deactivates any net capital scenario bots with creation dates before the current system date. The software in block 612 then retrieves the information from the scenarios table (171) in order to initialize net capital scenarios bots.

Bots are independent components of application software that have specific tasks to perform. In the case of net capital scenario bots, their primary task is to run four different types of simulations for the financial service provider. The net capital scenario bots run simulations of the financial service provider financial performance using the two types of scenarios generated by the financial asset and liability scenario bots—normal and extreme. The net capital scenario bots also run an unconstrained genetic algorithm simulation that evolves to the most negative scenario and simulations specified by regulatory agencies. Every net capital scenario bot activated in this block contains the information shown in Table 61.

TABLE 61

1. Unique ID number (based on date, hour, minute, second of creation)
2. Creation date (date, hour, minute, second)
3. Mapping information
4. Storage location
5. Type: normal, extreme, genetic algorithm or compliance
6. Organizations transferring risk
7. Financial service provider

After the net capital scenario bots are initialized, they retrieve the required information and simulate the financial performance of the financial service provider under the different scenarios. After the net capital scenarios complete their calculations, the resulting forecasts are saved in the scenarios table (171) in the application database (50) and processing advances to a block 613.

The software in block 613 checks the bot date table (149) and deactivates any financial asset optimization bots with creation dates before the current system date. The software in block 613 then retrieves the information from the external database table (146), the risk transfer products table (163), the risk reduction activity table (165), the simulations table (168) and the scenarios table (171) in order to initialize financial asset optimization bots.

Bots are independent components of application software that have specific tasks to perform. In the case of financial asset optimization bots, their primary task is to determine the optimal mix of financial assets and risk reduction activities (purchase reinsurance and/or other contingent capital purchases, etc.) for the financial service provider under each scenario using a genetic algorithm optimization algorithm that is constrained by any limitations imposed by regulatory requirements. A multi criteria optimization is also run at this stage to determine the best mix for maximizing value and risk under both normal and extreme scenarios. A penalty function for financial asset liability duration mismatch is optionally added to minimize the difference between financial asset and liability lives. Other optimization algorithms can be used at this point to achieve the same result. Every financial asset optimization bot activated in this block contains the information shown in Table 62.

TABLE 62

1. Unique ID number (based on date, hour, minute, second of creation)
2. Creation date (date, hour, minute, second)
3. Mapping information
4. Storage location
5. Type: normal, extreme or combined
6. Organizations transferring risk
7. Financial service provider

After the financial asset optimization bots complete their analyses, the resulting financial asset and contingent capital mix for each set of scenarios and the combined analysis is saved in the financial service provider table (184) in the application database (50) and the revised simulations are saved in the simulations table (168) before processing passes to a software block 614.

The software in block 614 prepares and displays the optimal mix of risk transfer, financial asset purchases, financial asset sales and contingent capital purchases for the normal, extreme and combined scenario analysis using the optimal mix display window (711). The optimal mix for the normal and extreme scenarios are determined by calculating the weighted average sum of the different scenarios where the weighting is determined by the relative likelihood of the scenario. The display identifies the optimal mix from the combined analysis as the recommended solution for financial service provider value maximization, risk minimization or combinations thereof. At this point, the user (20) is given the option of:

1) Editing (adding or deleting products and activities) from the recommended solution;

2) Selecting the optimal mix from the normal scenarios;

3) Selecting and then editing the optimal mix from the normal scenarios;

4) Selecting the optimal mix from the extreme scenarios;

5) Selecting and then editing the optimal mix from the extreme scenarios; or

6) Leaving the default choice in place.

After the user (20) has finished the review and the optional edit of the selected mix, any changes are saved in the financial service provider table (184) in the application database (50). The new optimal mix is compared to the existing financial asset position stored in the financial service provider table (184) and orders are generated to purchase financial assets, sell financial assets and/or purchase contingent capital in order to bring the current financial asset position in line with the newly identified optimal mix. These orders are also saved in the financial service provider table (184). They will be transmitted later to suppliers, brokers or exchanges via the network (45). Processing then advances to a software block 615

The software in block 615 checks the bot date table (149) and deactivates any price bots with creation dates before the current system date. The software in block 613 then retrieves the information from the system settings table (140), the external database table (146), the risk transfer products table (163), the risk reduction activity table (165), the simulations table (168) and the scenarios table (171) in order to initialize price bots.

Bots are independent components of application software that have specific tasks to perform. In the case of price bots, their primary task is to determine new prices for the fixed quantity swaps, swap streams, new insurance products and existing insurance products offered by the operator of the financial service provider. Pricing for fixed quantity swaps and swap streams are calculated by adding a standard amounts to each transaction based on the nominal value of the transaction. The nominal amount added will cover operating costs including any costs for re-insuring the credit risk exposure that is inherent in any swap transaction. The pricing analysis for insurance products is more involved. The system of the present invention supports the supply of insurance to cover any and all external factor variability, element variability and event risk that was not covered by fixed quantity swaps and/or swap streams. For existing products the bots examine the past history and projected risk for each type of insurance offered by the financial service provider. Prices for normal scenario insurance are set to provide the operator with the target return on capital the user (20) specified in the system settings table (140). The extreme scenario information is used to set a price for an extreme coverage option and to set ceilings on the normal coverage. The analysis for new products is similar to the existing products save for the fact that the combined scenario is used as the basis for price determination. As discussed previously, the financial service provider supports the supply of portfolio insurance for each client company in addition to the element, external factor and event risk insurance products. The portfolio insurance analysis examines all the risks for each client company and determines the overall probability of loss for the client company from all identified risks. The analysis is completed both before and after any swap transactions are included. Prices for portfolio insurance by client under both normal and extreme scenarios are set to provide the operator with the target return on capital the user (20) specified in the system settings table (140). Every price bot activated in this block contains the information shown in Table 63.

TABLE 63

1. Unique ID number (based on date, hour, minute, second of creation)
2. Creation date (date, hour, minute, second)
3. Mapping information
4. Storage location
5. Product: swap, swap stream, new insurance, existing insurance,
portfolio, derivative
6. Scenario: normal, extreme or combined
7. Organizations transferring risk
8. Financial service provider

After the price bots complete their analyses, the resulting prices are saved in the risk transfer products table (163) in the application database (50). The financial impact of the new prices on the existing simulations is then calculated and the results of the new calculations are saved in the simulations table (168) before processing passes to a software block 616.

The software in block 616 displays the overall financial performance of the financial service provider and the newly calculated prices for the risk transfer products, swaps and swap streams that are being offered to the client companies by scenario using the price review display window (712). At this point, the user (20) is given the option of:
1) Editing the recommended prices for any and all of the risk transfers—swaps, swap streams, existing products (insurance and/or derivatives) and/or new products;
2) Accepting the recommended prices; or
3) Removing some of swaps and/or risk transfer products from the list.

After the user (20) completes the review, all price changes and the prices for any new risk transfer products are saved in the risk transfer products table (163) before processing advances to a block 622.

The software in block 622 retrieves the orders saved in the financial service provider table (184) by the software in block 614. The orders are transmitted using the placement window (713) via a network (45) to financial intermediaries (21) such as brokers and/or exchanges. When the order confirmations are received through the placement window (713), the financial service provider table (184) is updated with the new information and processing advances to a block 623. The software in block 623 uses the client communication window (714) to display the information regarding the swaps, swap streams, risk transfer products and pricing that will be used to transfer the risks by organization. The client (22) connects to the client communication window (714) via a network (45) and approves any transactions that require approval. The software in block 623 displays swap risks that weren't transferred to client companies, accepts orders, accepts confirmations and updates the information in the risk transfer products table (163), the risk reduction activity table (165) and the financial service provider table (184).

The software in block 622 also accepts input via the client communication window (714) regarding any losses that are experience by organizations. The software in 622 verifies the loss is for an insured swap or risk, updates the risk transfer products table (163), the risk reduction activity table (165) and the financial service provider table (184) before arranging for payment of the claim in a manner that is well known. After these tasks are completed, processing advances to a software block 626.

The software in block 626 checks the analysis definition table (183) to see if any securities are going to be developed. If securities are not going to be developed, then processing advances to a software block 513. Alternatively, if securities are going to be developed, then processing advances to a software block 628.

The software in block 628 checks the bot date table (149) and deactivates any hybrid security valuation bots with creation dates before the current system date. The software in block 628 then retrieves information from the system settings table (140), the external database table (146), the risk transfer products table (163), the risk reduction activity table (165), the simulations table (168), the scenarios table (171) and the xml summary table (177) as required to initialize hybrid security valuation bots in accordance with the frequency specified by the operator (20) in the system settings table (140).

Bots are independent components of application software that have specific tasks to perform. In the case of hybrid security valuation bots, their primary task is to value pre-defined hybrid securities. The valuation for hybrid securities involves combining the current market value of the base security with the calculated market value of the derivative, insurance contract or other product that will be combined with the base security to form the hybrid security. Every hybrid security valuation bot activated in this block contains the information shown in Table 64.

TABLE 64

1. Unique ID number (based on date, hour, minute, second of creation)
2. Creation date (date, hour, minute, second)
3. Mapping information
4. Storage location
5. Hybrid Security Definition

After the security valuation bots are initialized, they activate in accordance with the frequency specified by the operator (20) in the system settings table (140). Once activated, they retrieve the required information and value the security. After the security valuation bots complete their calculations, the resulting values are saved in the risk products table (163) before processing advances to software block 629.

The software in block 629 checks the bot date table (149) and deactivates any securitized risk contract valuation bots with creation dates before the current system date. The software in block 629 then retrieves information from the system settings table (140), the external database table (146), the risk transfer products table (163), the risk reduction activity table (165), the simulations table (168), the scenarios table (171) and the xml summary table (177) as required to initialize securitized risk contract valuation bots in accordance with the frequency specified by the operator (20) in the system settings table (140).

Bots are independent components of application software that have specific tasks to perform. In the case of securitized risk contract valuation bots, their primary task is to value pre-defined securitized risk contracts. The valuation of the pre-defined securitized risk contracts involves combining the previously calculated risk evolution scenarios with the previously calculated market value of risk information to determine the overall cost of covering the client risk in the specified contract under each scenario. The price for the contracts will be the weighted average combination of the normal and extreme prices plus a margin for reasonable profit. If the operator (20) has specified a weighting in the systems setting table (140), then that weighting will be used in determining the average price. However, if the operator (20) has not specified a weighting, then the calculated probability of the extreme scenario will be used in determining the average price. Every securitized risk contract bot activated in this block contains the information shown in Table 65.

TABLE 65

1. Unique ID number (based on date, hour, minute, second of creation)
2. Creation date (date, hour, minute, second)
3. Mapping information
4. Storage location
5. Securitized Risk Contract Definition

After the securitized risk contract valuation bots are initialized, they activate in accordance with the frequency specified by the operator (20) in the system settings table (140). Once activated, they retrieve the required information and calculate the price that companies wishing to transfer their risk via these contracts for the specified time period will be charged. After the securitized risk contract valuation bots complete their calculations, the resulting values are saved in the risk products table (163) before processing advances to a software block 630.

The software in block 630 uses the client communication window (713) to display the information regarding the securitized risk contracts and hybrid securities that are available for sale. Investors (22) connect to the client communication window (713) via a network (45) and have the ability to select one or more products for purchase. The software in block 630 also accepts input via the client communication window (713) regarding any customized security the investor (22) is seeking and/or changes in prices for offered products. The software in 630 places all the information received from the investor (22) in the order table (173). The software then checks each new order to determine if the order was placed for a defined security or a custom security. If the custom product request is for a hybrid security, then the software in block identifies the combination of standard security and risk transfer product that best matches the investor's specifications. It then values the combination using the procedure outlined for the hybrid security valuation. If the custom request is for a securitized risk contract, then the procedures outlined for the securitized risk contract development are repeated as required to identify the risk (or risks) that most closely match the investor's specifications. In either case, the new definitions and valuations are saved in the risk transfer products table (163) before transmission to the investor via the client communication window (713). Orders for custom and standard securities are processed automatically in a manner that is well known with the information on completed orders being stored in the order table (173). The method outlined above can also used to develop one or more of the new customized risk transfer products that may be identified during the development of a customized risk transfer program for an organization.

Thus, the reader will see that the system and method described above transforms extracted transaction data, corporate information and information from the Internet into a matrix of value and risk for a multi-enterprise organization. The system and method described above goes on to use the detailed valuation and risk analysis information to identify an optimal risk reduction strategy before going on to define the efficient frontier for corporate financial performance, develop a customized risk transfer program, customized risk transfer products and hybrid securities. The level of detail, breadth and speed of the integrated analysis of value and risk allows users of the system to manage their financial performance in a fashion that is superior to the method currently available to users of: dynamic financial analysis, single asset risk management systems, e.r.p. systems and business intelligence solutions.

While the above description contains many specificities, these should not be construed as limitations on the scope of the invention, but rather as an exemplification of one preferred embodiment thereof. Accordingly, the scope of the invention should be determined not by the embodiment illustrated, but by the appended claims and their legal equivalents.

1. A non-transitory computer-program product comprising a computer-usable media having computer-readable program code embodied therein, the computer-readable program code configured to be executed to implement an extended enterprise management method, comprising:
prepare a plurality of data representative of an enterprise and its one or more employees for processing,
completing a series of multivariate analyses utilizing said data in order to transform said data into a linear or nonlinear model of each of one or more segments of value contained in a pension plan for the employees and a forecast of a sustainability for each employee,
determining one or more element of value contributions to a value of each segment of value using said segment of value models,
determining one or more external factor contributions to the value of each segment of value using said segment of value models,
determining a contribution from each of the one or more employees to a liability for the pension plan using the forecast sustainability of each employee, and
outputting a report that identifies said contributions
where the one or more segments of value are selected from the group consisting of derivative, investment and market sentiment and where the pension plan value optionally comprises one or more real options.

2. The computer program product of claim 1, wherein the method further comprises using the segment of value models to complete activities selected from the group consisting of calculating a value for each of one or more elements of value using the element of value contributions output from said models, identifying a set of changes that will optimize a pension plan market value and simulating the pension plan market value for a scenario.

3. The computer program product of claim 2, wherein identifying the set of changes that will optimize the market value further comprises identifying one or more changes to one or more value drivers for each of the elements of value that will optimize of one or more aspects of financial performance where said aspects of financial performance are selected from the group consisting of revenue, expense, capital change, real option value, derivative value, market sentiment value, and investment.

4. The computer program product of claim 1, wherein the one or more elements of value physically exist and are selected from the group consisting of alliances, channels, customers, employees, intellectual property, partnerships, processes, production equipment, vendors, and combinations thereof.

5. The computer program product of claim 1, wherein a series of multivariate analyses are selected from the group consisting of identifying one or more previously unknown item performance indicators, discovering one or more previously unknown value drivers, identifying one or more previously unknown relationships between one or more value drivers, identifying one or more previously unknown relationships between one or more elements of value, quantifying one or more inter-relationships between value drivers, quantifying one or more impacts between elements of value, developing one or more composite variables, developing one or more vectors, developing one or more causal element impact summaries, identifying a best fit combination of predictive model algorithm and element impact summaries for modeling enterprise market value and each of the components of value, determining a net element of value impact for each segment of value, determining a relative strength of a plurality of elements of value between two or more enterprises, developing one or more real option discount rates, calculating one or more real option values and calculating an enterprise market sentiment value by element of value.

6. The computer program product of claim 1, wherein the method further comprises:
identifying one of more value drivers for each of the elements of value that contribute to the value of the one or more of the segments of value and one or more factor drivers for each of the external factors that contribute to the value of the one or more of the segments of value,
identifying two or more scenarios for a future value of said value drivers and factor drivers, and
quantifying a plurality of risks by element of value and external factor by using said scenarios and the relationship between the elements of value, external factors and value of each segment of value identified during the development of the segment of value models to forecast a future pension value under each scenario by element of value, external factor and segment of value.

7. The computer program product of claim 6, wherein the relationship between the elements of value, external factors and the value of the one or more segments of value comprises a power law relationship.

8. The computer program product of claim 1, wherein completing the series of multivariate analyses utilizing the data in order to transform said data into the linear or nonlinear model of each of the one or more segments of value comprises learning from the data where said learning comprises:
using a plurality of predictive models and causal models to select a portion of the prepared data to use in modeling a contribution of each of the one or more elements of value;
using a plurality of predictive models and causal models to select a portion of the prepared data to use in modeling an impact each of the one or more external factors;
learning which algorithm from a plurality of linear and nonlinear predictive model algorithms to include in the model for each of the one or more segments of value in order to model a relative contribution or impact of each of the one or more elements of value and each of the one or more external factors to a value of the component of value when using the selected data;
learning which model from a plurality of causal models is a best fit for modeling the contribution of the elements of value and the external factors to the value of each of the segments of value when using the selected data;
learning if a clustering of the selected data improves an accuracy of the segment of value models;
learning a relative contribution of each of the elements of value to the value of each of the segments of value,
learning a relative contribution of each of the elements of value to an enterprise value,
learning a relative contribution of each of the external factors to the value of each of the segments of value,
learning if the enterprise value comprises a market sentiment value, and
optionally developing one or more real option models where developing said models comprises calculating a discount rate for each real option using data related to the elements of value that contribute to the enterprise value;
where the prepared data comprises a plurality of variables and a plurality of performance indicators, where the plurality of causal models are selected from the group consisting of Tetrad, LaGrange, Bayesian and path analysis and where the plurality of predictive models are selected from the group consisting of classification and regression tree; projection pursuit regression; generalized additive model (GAM), redundant regression network; neural network, multivariate adaptive regression splines; linear regression; and stepwise regression.

9. An extended management system, comprising a computer with a processor having circuitry to execute instructions; a storage device available to said processor with sequences of instructions stored therein, which when executed cause the processor to:
prepare a plurality of data representative of a commercial enterprise for processing,
transform said data into a linear or nonlinear model of each of one or more segments of an enterprise value using automated learning,
determine one or more element of value contributions to a value of each segment of the enterprise value using said segment of value models,
determine one or more external factor contributions to the value of each segment of the enterprise value using said segment of value models, and
output a report that identifies said contributions
where the one or more segments of enterprise value are selected from the group consisting of derivative, investments, current operation and market sentiment and where the enterprise value optionally comprises a real option segment of value.

10. The system of claim 9, wherein the processor: further completes one or more activities selected from the group consisting of using the element of value contributions to the one or more segments of value to calculate a value for each of the one or more elements of value, identifying a set of changes that will optimize the enterprise value and simulating the enterprise value for a scenario.

11. The system of claim 10, wherein identifying the set of changes that will optimize the market value further comprises means for identifying one or more changes to one or more value drivers for each of the elements of value that will optimize of one or more aspects of financial performance where said aspects of financial performance are selected from the group consisting of revenue, expense, capital change, real option value, derivative value, market sentiment value and investment.

12. The system of claim 9, wherein the one or more elements of value physically exist and are selected from the group consisting of alliances, channels, customers, employees, intellectual property, partnerships, processes, production equipment, vendors, and combinations thereof and wherein the data representative of the commercial enterprise are obtained from one or more systems selected from the group consisting of advanced financial systems, basic financial systems, alliance management systems, brand management systems, customer relationship management systems, channel management systems, estimating systems, intellectual property management systems, process management systems, supply chain management systems, vendor management systems, operation management systems, sales management systems, human resource systems, accounts receivable systems, accounts payable systems, capital asset systems, inventory systems, invoicing systems, payroll systems, purchasing systems, web site systems, the Internet and external databases.

13. The system of claim 9, wherein transforming the data into the linear or nonlinear segment of value models using automated learning comprises:
using a plurality of predictive models and causal models to select a portion of the prepared data to use in modeling a contribution of each of the one or more elements of value;
using a plurality of predictive models and causal models to select a portion of the prepared data to use in modeling an impact each of the one or more external factors;
learning which algorithm from a plurality of linear and nonlinear predictive model algorithms to include in the model for each of the one or more segments of value in order to model a relative contribution of each of the one or more elements of value and each of the one or more external factors to a value of the segment of value when using the selected data;
learning which model from a plurality of causal models is a best fit for modeling the contribution of the elements of value and the external factors to the value of each of the segments of value when using the selected data;
learning if a clustering of the selected data improves an accuracy of the segment of value models;
learning a relative contribution of each of the elements of value to the value of each of the segments of value,
learning a relative contribution of each of the elements of value to an enterprise value,
learning a relative contribution of each of the external factors to the value of each of the segments of value,
learning if the enterprise value comprises a market sentiment value,
optionally developing one or more real option models where developing said models comprises calculating a discount rate for each real option using data related to the elements of value that contribute to the enterprise value;
where the prepared data comprises a plurality of variables and a plurality of performance indicators, where the plurality of causal models are selected from the group consisting of Tetrad, LaGrange, Bayesian and path analysis and where the plurality of predictive models are selected from the group consisting of classification and regression tree; projection pursuit regression; generalized additive model (GAM), redundant regression network; neural network, multivariate adaptive regression splines; linear regression; and stepwise regression.

14. An extended management system, comprising:
a plurality of computers connected via a network, each computer with a processor having circuitry to execute instructions; a storage device available to each of said processors with sequences of instructions stored therein, which when executed cause the processors to:
prepare a plurality of data representative of an enterprise and its one or more employees for processing,
complete a series of multivariate analyses utilizing said data in order to transform said data into a linear or nonlinear model of each of one or more segments of value contained in a pension plan for the enterprise employees and a forecast of a sustainability for each enterprise employee,
determine one or more element of value contributions to a value of each segment of value using said segment of value models,
determine one or more external factor contributions to the value of each segment of value using said segment of value models,
determine a contribution from each of the one or more enterprise employees to a liability for the pension plan using the forecast sustainability of each enterprise employee, and
output a report that identifies said contributions
where the one or more segments of value are selected from the group consisting of derivative, investments and, market sentiment and where the pension plan value optionally comprises one or more real options.

15. The system of claim 14, wherein the one or more elements of value physically exist and are selected from the group consisting of alliances, channels, customers, employees, intellectual property, partnerships, processes, production equipment, vendors, and combinations thereof.

16. The system of claim 14, wherein a series of multivariate analyses are selected from the group consisting of identifying one or more previously unknown item performance indicators, discovering one or more previously unknown value drivers, identifying one or more previously unknown relationships between one or more value drivers, identifying one or more previously unknown relationships between one or more elements of value, quantifying one or more inter-relationships between value drivers, quantifying one or more impacts between elements of value, developing one or more composite variables, developing one or more vectors, developing one or more causal element impact summaries, identifying a best fit combination of predictive model algorithm and element impact summaries for modeling enterprise market value and each of the components of value, determining a net element of value impact for each segment of value, determining a relative strength of a plurality of elements of value between two or more enterprises, developing one or more real option discount rates, calculating one or more real option values and calculating a market sentiment value by element of value.

17. The system of claim 14, wherein the method further comprises:
identifying one of more value drivers for each of the elements of value that contribute to the value of the one or more of the segments of value and one or more factor drivers for each of the external factors that contribute to the value of the one or more of the segments of value,
identifying two or more scenarios for a future value of said value drivers and factor drivers, and
quantifying a plurality of risks by element of value and external factor by using said scenarios and the relationship between the elements of value, external factors and value of each segment of value identified during the development of the segment of value models to forecast a future pension value under each scenario by element of value, external factor and segment of value.

18. The system of claim 17, wherein the relationship between the elements of value, external factors and the value of the one or more segments of value comprises a power law relationship.

19. The system of claim 14, wherein the method further comprises using the segment of value models to complete activities selected from the group consisting of calculating a value for each of one or more elements of value using the element of value contributions output from said models, identifying a set of changes that will optimize a pension plan market value and simulating the pension plan market value for a scenario.

20. The system of claim 14, wherein completing the series of multivariate analyses utilizing the data in order to transform said data into the linear or nonlinear model of each of the one or more segments of value comprises automated learning where said learning comprises:
using a plurality of predictive models and causal models to select a portion of the prepared data to use in modeling a contribution of each of the one or more elements of value;
using a plurality of predictive models and causal models to select a portion of the prepared data to use in modeling an impact each of the one or more external factors;
learning which algorithm from a plurality of linear and nonlinear predictive model algorithms to include in the model for each of the one or more segments of value in order to model a relative contribution of each of the one or more elements of value and each of the one or more external factors to a value of the component of value when using the selected data;
learning which model from a plurality of causal models is a best fit for modeling the contribution of the elements of value and the external factors to the value of each of the segments of value when using the selected data;
learning if a clustering of the selected data improves an accuracy of the segment of value models;
learning a relative contribution of each of the elements of value to the value of each of the segments of value,
learning a relative contribution of each of the elements of value to an enterprise value,
learning a relative contribution of each of the external factors to the value of each of the segments of value,
learning if the enterprise value comprises a market sentiment value, and
developing one or more real option models where developing said models comprises calculating a discount rate for each real option using data related to the elements of value that contribute to the enterprise value;
where the prepared data comprises a plurality of variables and a plurality of performance indicators, where the plurality of causal models are selected from the group consisting of Tetrad, LaGrange, Bayesian and path analysis and where the plurality of predictive models are selected from the group consisting of classification and regression tree; projection pursuit regression; generalized additive model (GAM), redundant regression network; neural network, multivariate adaptive regression splines; linear regression; and stepwise regression.
